(19) United States
(12) Patent Application Publication
(10) Pub. No.: US 2026/0160116 A1
(43) Pub. Date: Jun. 11, 2026

(54) System for Installing Structural Components within Existing Walls Utilizing Ventilating Structural Components

(71) Applicant: Henry H. Bilge, Fort Lee, NJ (US)

(72) Inventor: Henry H. Bilge, Fort Lee, NJ (US)

(21) Appl. No.: 19/238,674

(22) Filed: Jun. 16, 2025

Related U.S. Application Data
(63) Continuation-in-part of application No. 18/777,398, filed on Jul. 18, 2024.
Application No. 18/777,398 is a continuation-in-part of application No. 18/439,703, filed on Feb. 12, 2024.
Application No. 18/439,703 is a continuation-in-part of application No. 18/418,950, filed on Jan. 22, 2024, now abandoned.
(60) Provisional application No. 63/620,454, filed on Jan. 12, 2024.

(51) Int. Cl. E06B 3/06; E06B 1/70

(52) U.S. Cl. CPC E06B 3/06; E06B 1/702

(57) ABSTRACT

Disclosed is a system that utilizes at least one structural frame element within an existing aperture as a universal mounting framework for securing windows, doors and other structural elements that are installed within an existing aperture of a wall. The structural frame elements are preferably made from thermally isolating materials and are fastened within the aperture using means that do not severely damage the weather membrane. The structural frame elements may have been built in finishing trim around the installed structural components. The structural components may be further secured within the structural frame elements using holding elements and projecting members, which may be removable or unitary to the structural frame elements. Some of the surfaces of the structural frame elements that are exposed to the external environment contain a pitch that promotes drainage.

### CROSS-REFERENCE TO RELATED APPLICATIONS

This application claims the benefit of a U.S. Non-Provisional patent application Ser. No. 18/777,398 , filed on Jul. 18, 2024, which claims the benefit of a U.S. Non-Provisional patent application Ser. No. 18/439,703 , filed on Feb. 12, 2024, which claims the benefit of a U.S. Non-Provisional patent application Ser. No. 18/418,950 filed on Jan. 22, 2024, which claims the benefit of a U.S. Provisional Patent Application No. 63/620,454 filed on Jan. 12, 2024, the complete contents of which are incorporated herein by reference.

### BACKGROUND OF THE INVENTION

Modern commercial and residential construction heavily relies on air-conditioned interior spaces to the extent that contractors no longer install windows that open. Instead, the focus is on the installation of oversized windows that do not open but provide panoramic views and admit plenty of sunlight. Windows that lack the ability to open are favored in high rise construction as a safety measure to prevent falls of people and pets and to protect pedestrians below from objects falling from above.

However, there are some downsides to not being able to open a window. Windows that cannot be opened may limit your ability to control the indoor temperature naturally. Opening windows allows for natural airflow, helping regulate temperature and reduce reliance on heating or cooling systems.

Additionally, the inability to open windows can diminish the connection to the outdoors. Fresh air sounds of nature, and the ability to feel a breeze can enhance the overall living experience. Without the option to open windows, odors within a space may be more difficult to eliminate. Proper ventilation helps in dissipating smells and maintaining a fresher indoor environment. Lack of ventilation can contribute to moisture buildup, leading to issues such as mold growth and dampness. Adequate ventilation is essential for preventing these problems.

For the foregoing reasons, an alternative solution is needed to ensure that inhabitants of modern structures are not deprived of access to fresh air and air circulation. Additionally, the present state of high rise and building construction does not have any standard means of mounting windows within prepared window apertures. Every window manufacturer, architect or building contractor retrofits windows on a case-by-case basis, which may or may not result in a proper and durable fit every time. Therefore, a frame component that enables ventilation without sacrificing insulation, and at the same time providing a standard means for affixing windows to facades would be a much-needed improvement to the present state of the art.

Water drainage is a major concern, especially when erecting structures comprised of interior skeleton that supports exterior wall cladding and windows. Every effort is made to minimize gaps between exterior panels. It is widely known that windows and doors deployed within apertures of an existing wall present a weak point structurally and with regard to drainage solutions. Solutions that exist today focus on preventing penetration of water. However, water will inevitably invade seams between window frames and walls, or window frames and frame sills.

### SUMMARY OF THE INVENTION

The present disclosure presents a device that facilitates exchange of air and wicking of moisture between an interior space and an external environment through a structural frame element of a fall. The disclosed structural frame element is made of a top wall, a bottom wall, side walls, a front wall and a back wall. The bottom wall, side walls, front wall and the back form an interior cavity. The structural frame element is configured to have a plurality of exterior openings, preferably in the front or bottom walls, and interior openings, preferably in the back wall or in the rear portions of the top and bottom walls. The external openings and internal openings are in air communication with each other, meaning they are connected through the same cavity. The external openings opening into the cavity from the outside environment, and the internal openings opening into the cavity from the interior space of the structure.

In one embodiment is preferably that the structural frame member is made with at least two rib structures that are positioned internally. The rib structures may extend from the inner surface of the bottom wall or top wall and are spaced apart and adjacent to each other. There is a gap between each two adjacent rib structure. The rib structures have openings that lets air or water to freely circulate within the cavity. The rib structures may additionally be coated or covered with sound absorbing coatings, corrugations or other structural features.

There is preferably a removable covering that is configured to intermittently block or permit the flow of air or moisture through the cavity. The covering may be deployed adjacent to the internal openings or external openings and actuated using a manual lever or at least one dc motor.

In another embodiment, the internal cavity may be filled with coils which serve as means of slowing down air passing through the cavity. The purpose of slowing the airflow down is so that the air may warm up or cool down to a temperature that is closer to the interior temperature of the space being serviced by the structural frame member.

In another embodiment, the internal coils may be connected to a power source to be heated or cooled as required.

Another embodiment of the disclosed device may feature at least one fan that is configured to direct the flow of air or water to or from the exterior openings. The fan may be controlled by an actuator or through a thermostat that is installed on the back wall or on the rear portions of the top and bottom walls. The thermostat may be mounted on any other structure within the interior space and be able to wirelessly or through a wired connection control the operation of a fan or the removable covering.

The fan, the dc motor and/or coils may be controlled by solar panels deployed along the top wall.

The aforementioned structural frame member may be mounted as a frame for windows doors or as part of a wall.

The structural frame member may be in the form of a holding wall, which may be machined or stamped. The first side of the holding wall is configured to be mounted onto an existing wall and the second side of the holding wall is configured to secure a structural component. The holding wall may contain a projecting member and a removable holding member, which secure a structural component between them. The holding wall may be fastened to an existing wall with a holding pin, and additionally, or alternatively with a fastener. The inner end of the holding wall that faces the interior space may contain a barb member which is configured to secure a decorative frame member, such as a molding, or which may secure an additional structural component, such as a beam or jamb.

The disclosed combination of structural frame elements, complemented by securing means such as holding elements, projecting elements and lateral lips are configured to serve as means for securing a structural component, such as windows, doors, or openings covers, within an existing aperture. Presently these structural components do not have a uniform securement adaptor and are installed using shims that ensure proper centering of the component within the aperture, but which also serve to create gaps that must then be caulked, and which then demand continuous maintenance and upkeep to remain properly weather proof. The structural system described in this application permits a universal installation of structural components within existing apertures without shims, resulting in better gap management and neater finish.

The disclosed holding elements of sill, head and side elements may support an auxiliary structural element, such as a window screen, an exterior insect mesh or a secondary windowpane. The auxiliary groove will hold such auxiliary structural element in a secure, but removable configuration. The auxiliary groove is preferably disposed within the connecting wall between the retaining wall, which extends away and at an angle, preferably a right angle, from the top wall. The connecting wall separates the retaining wall from the front wall. The retaining wall serves as one of the retaining parts that hold a structural element in place.

The auxiliary groove exists within the sill element, head element and side elements. As with all retaining parts which are co-axial across the sill, head and side elements, the auxiliary groove is also coaxial. At each of the first side element and second side elements, an auxiliary corner transitions between the auxiliary groove of the sill or head elements with the auxiliary groove of the side elements. The auxiliary corner holds the corners of the frame element of the auxiliary structural element.

The auxiliary groove preferably holds the auxiliary structural element in a removable configuration, where the auxiliary structural element may be removed and reinserted after all components have been installed. As such, the auxiliary groove of the head element, as well as the corners of the second side elements is preferably deeper than the auxiliary groove of the sill and first side elements. Therefore, to deploy or remove an auxiliary structural element the auxiliary structural element is lifted and driven deeper into the auxiliary groove of the head and second sill elements until the bottom edge of the auxiliary frame element clears the auxiliary groove of the sill and first side elements, and is then removed outwardly to remove, or pushed towards the frame to deploy the auxiliary structural element.

In another embodiment, the auxiliary structural element may be used to hold a first exterior panel. The exterior panel will contain a groove, or a protruding that would be jammed into the auxiliary and thus be locked into place on the frame. The first exterior panel would then cover the entire surface of the connecting or sloping wall and the front wall, with the forward edge of the exterior panel, covering the bottom wall adjacent to the front wall, or the bottom wall that projects beyond the existing wall, or paneling installed on the existing wall. The purpose of the exterior panel would be to provide additional protection to the sill element and to create a desired color and finish to the façade of a building.

Similarly, on the inside of the aperture, a second exterior panel may be secured within at least one of the grooves along the top wall of the head, sill or side elements. The second exterior panel can be used to provide a color and finish wrapping to the top and wall, and the back wall of the sill, head and side elements. It should be noted that the auxiliary groove and the retaining grooves may support the first and second exterior panels, while also supporting the auxiliary structural element for the auxiliary groove and a holding element for the retaining groove.

There may be at least one opening in one of the retaining grooves permitting the passage of the fastener and fastener's hat to pass through the top wall, to fasten the bottom wall to an existing wall.

In another embodiment, the forward potion portion of the sill or head elements may be deployed cantilevered into an existing aperture. The cantilevered deployment would permit deployment of structural elements, such as windows, outside of the existing wall, or at the same level with exterior insulation and wall cladding to achieve a flush, even surface along the façade of a building.

### BRIEF DESCRIPTION OF DRAWINGS

FIG. 1 is a sideview cutaway diagram of the disclosed frame element.

FIG. 2 is sideview cutaway diagram of another embodiment of the frame element having a dc motor.

FIG. 3. Is sideview cutaway diagram of a frame element having fan and coils.

FIG. 4 is a top view of another embodiment of the present invention demonstrating the operation of the disclosed frame component as a window mounting member.

FIG. 5 is a top view of another embodiment of the structural frame component serving as a window mounting member.

FIG. 6 is a demonstration of coils that may be inserted into the cavity of the structural frame component.

FIG. 7 is a demonstration of a full system of structural frame members as used to mount structural components and ventilate interior spaces.

FIG. 8 is a demonstration of a full system of structural frame members, but without ventilation.

FIG. 9 is a demonstration of utilizing holding bars to secure a structural component.

FIG. 10 is a diagram of the method enabled by the structural elements disclosed in the present invention.

FIG. 11 demonstrating another embodiment of the disclosed structural frame element.

FIG. 12 is a scale diagram of the structural frame element deployed within a window aperture.

FIG. 12B is a general diagram of the structural frame that may be deployed within a structural aperture.

FIG. 13A is a diagram of the basic wall.

FIGS. 13-25 demonstrate various embodiments of the holding wall.

FIG. 25A is an embodiment of a holding wall producing by stamping.

FIGS. 26-30 are diagrams of alternative embodiments of structural frame member featuring unitary projecting member and/or extendable lateral lip slidingly retained within the front wall of the structural frame member.

FIG. 27A is a diagram of structural frame members installed side by side with a structural component secured between them.

FIGS. 31-33 are diagrams demonstrating various embodiments of structural frame members with and without various accessories.

FIGS. 33A and 33B demonstrate the various embodiment of the holding elements for securing structural member within the disclosed frame members.

FIG. 34 is a method diagram of the method enabled by the disclosed system.

FIG. 35 is another embodiment of the securement system.

FIG. 35A is still another embodiment of the securement system.

FIG. 36 is another embodiment of the sill element, with interior cavity and water drainage holes, as well ventilation openings clearly visible.

FIG. 37 is an exploded diagram of the securement system shown in FIG. 35.

FIGS. 38A, 38B, 38C and 38D demonstrate the detailed view of the first and second side elements.

FIG. 39 is an embodiment of a fully assembled securement system, also displaying shroud elements.

FIG. 40 is a diagram of an alternative embodiment of the sill element.

FIG. 41 is another diagram of the alternative embodiment shown in FIG. 40 demonstrating a second type of shroud.

FIG. 42 is another embodiment of a fully assembled securement system.

FIG. 43 demonstrates additional functionality of the securement system shown in FIG. 35.

FIGS. 44 and 44A demonstrate still another embodiment of the disclosed member of the securement system, showing cover first side elements from front and back perspective views.

FIG. 44B is another embodiment of the sill element of the disclosed securement system.

FIGS. 45a, 45b, and 45c demonstrates the holding element with the securement portion being of variable length.

FIGS. 45-47 are diagrams describing the method of using the securement system.

FIG. 48 is an exploded diagram of another embodiment of the disclosed securement system.

FIGS. 49 and 50 are side cutaway diagrams of another embodiment of the sill element.

FIGS. 51 and 52 are cutaway side diagrams of another embodiment of the sill element that is configured to provide a supported or braced cantilever to support installation of structural elements beyond the width of the existing wall.

FIG. 53 is an elevational side diagram of an alternative embodiment of the head element.

FIG. 54 is a perspective view of an alternative embodiment of the second side element.

FIG. 55 is a perspective view of an alternative embodiment of the first side element.

FIG. 56 is a diagram of a structural girt configured to be installed adjacent to the bottom wall of the securement elements of the disclosed securement system.

FIG. 57 are several diagrams of various holding elements that may be used to secure a structural element within the disclosed securement system on the inside of an existing wall opening.

FIGS. 58, 59 and 60 demonstrate an embodiment of the present invention having a cantilever feature in the frontal portion and having first and second exterior plates.

FIG. 61 demonstrates the fully assembled embodiment of the elements shown in FIGS. 58-60 .

FIG. 62 demonstrates a slotted H component providing internal bracing for the sill element.

FIGS. 62A-62C demonstrate various views of the disclosed slotted H component.

FIG. 63 diagrams the controllable flow of air and water within the cavity of the sill element.

### DETAILED DESCRIPTION OF THE INVENTION

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

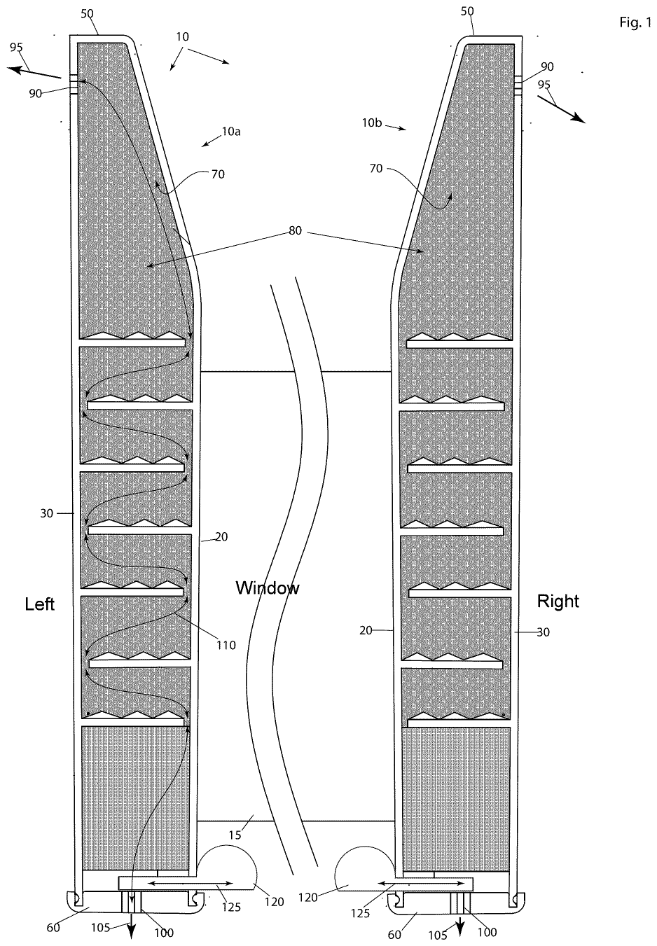

Shown in FIG. 1 is a structural frame element 10, which may be comprised of a single element of the frame such a sill, head or jamb of a window or door frame or may be more than one element of a frame. As shown in FIG. 1, are right and left jambs 10a and 10b respectively, or may form a head and sill components, or a component of an existing wall or a building or a partition or barrier of a berth or cabin of a ship or panels of water vehicles. Boats, and other watercraft that are stored over prolonged periods of time tend to suffer from buildup of humidity and staleness within internal compartments, which sometimes results in buildup of mold and mildew, and generally requires regular and routine ventilation to avoid long term damage. Paneling or framework that may be open for ventilation can substantially alleviate this concern. With respect to vehicles, ventilating panels may be used to reduce the risk of leaving children within locked vehicles. A separate system may be used to detect the presence of an occupant and may enable ventilation through paneling. Unlike ventilation through windows, ventilation through paneling will maintain security of internal compartments and prevent moisture penetration.

It should be noted that the disclosed frame element 10 may be used as horizonal members of a frame, such as sill or head members, or a horizontal or vertical member of a wall structure. Each structural frame element is made of the top wall 20, a bottom wall 30, side walls 40, a front wall 50 and a back wall 60. The bottom wall 30, the sidewalls 70 (shown is the location where the sidewalls 70 would enclose the cavity 80), the front wall 50 and the back wall 60 structured together enclosing a cavity 80. Also shown is one to plurality of exterior openings 90 opening into the cavity 80 from the outside environment 95, and one to plurality of interior openings 100 opening into the cavity 80. Both exterior openings 90 and interior openings 100 may be a single opening or a plurality of slots in any shape or size, such as elongated slots. Cavity 80 is structured to provide an air or water/moisture flow in between the exterior openings 90 and the interior openings 100, thus establishing an air communication 110 that is configured to channel air or water through the cavity 80 in the direction toward the outside environment 95 or in the direction towards the interior space 105.

Air communication 110 can be interrupted or resumed with the assistance of removable covering shown in FIG. 1 as levers 120 which are configured to move in the direction 125 to either open or close the interior openings 100. The removable covering can alternatively be mounted to cover the exterior openings 90 or along the length of the cavity 80. It must be noted that while the frame elements 10a and 10b are placed vertically in FIG. 1 and represent left and right jamb frame components of a window 15, the frame elements 10 may be placed horizontally or diagonally and serve as frame components for a door or as part of a wall system where a wall may contain a block of panels or cinder blocks, with intersection of frame components 10 to provide ventilation between the outside environment 95 and the interior spaces 105.

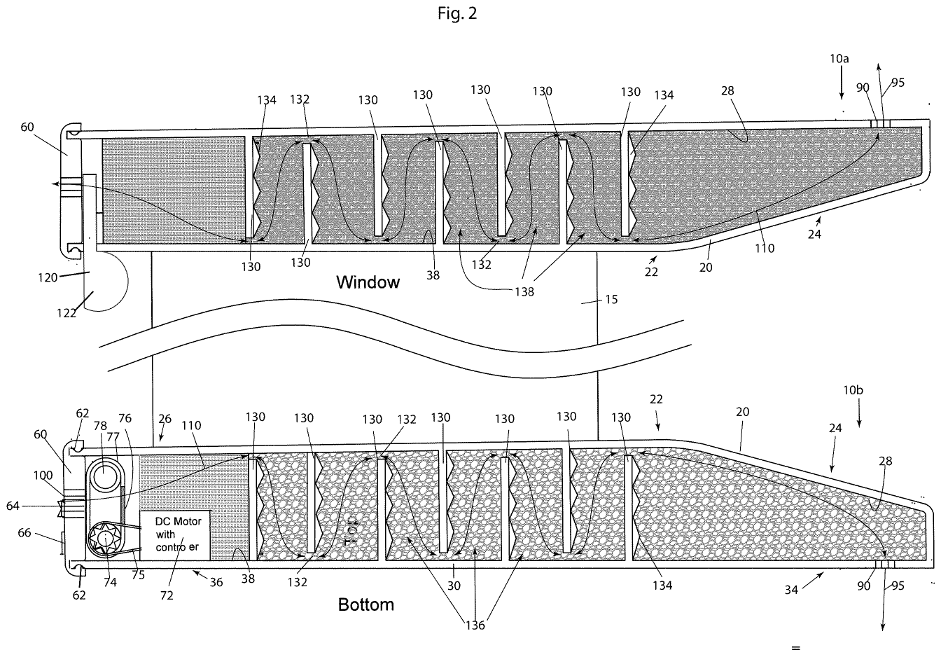

Another embodiment of structural frame elements 10 is shown in FIG. 2. It is preferred that the exterior openings 90 are disposed within said front 50 wall or a forward section 34 of said bottom wall 30. Additionally, the forward section 24 of the top wall 20 may be sloping such that water drainage is achieved in the bottom frame 10b and additional light is enabled into to the window 15. Similarly, it is preferrable that the interior openings 100 are disposed within the back wall 60 or a rear section 36 of the bottom wall 30 or the rear section 26 of the top wall 20.

Additionally shown in FIG. 2, within the cavity 80 there are at least two rib structures 130. Each of the rib structures 130 extending from the inner surface 28 of the top wall 20 or the inner surface 38 of the bottom wall 30. There is generally a plurality of the rib structures 130, and these are arranged with at least two rib structures 130 being in an adjacent and spaced apart orientation from each other, with the space in between two adjacent rib structures forming a gap 136. Additionally, each of the rib structures 130 have an opening 132. The rib structures 130 are generally disposed across the height and width of the cavity 80 and extend at an angle, preferably a right angle, or an angle that is greater or lesser than perpendicular, from the inner surface 28 of the top wall 20 to the inner surface 38 of the bottom wall 30. The opening 132 may be created by terminating a rib structure 130 before it reaches the opposite wall (20 or 30) as shown in FIG. 2. Or by making an opening anywhere along the length of each rib structure 130. While only one opening 132 is shown, it is understood that each rib structure 130 may contain a plurality of the openings through the rib structure 130 and these openings 132 may be axially corresponding, meaning on the same level or plane with a similar opening on an adjacent rib structure 130, or not coaxial with openings 132 of adjacent rib structures 130.

The purpose of the openings 132 is to provide uninterrupted air communication 110, which is represented by the flow of air or moisture through the cavity 80 between the interior openings 100 and exterior openings 90. The flow of air originates from the interior openings 90 or exterior openings 100 and flows through the openings 132 within each rib structure 130, and through the gaps 138 between adjacent rib structures 130 until the opposite openings, either interior or exterior (100 or 90) whatever the case may be.

Still referring to FIG. 2, shown are two embodiments of removable covering. In the top frame element 10a the removable covering is a manually operated lever or rod 120 having a hand activated actuator 122 for moving the lever in the direction (125). In the bottom frame element 10b, the removable covering is configured using a motor, shown is a dc motor 72, that is connected to a drive gear 74 with a belt drive 75. A moving belt 77 is the removable automated covering. The dc motor 72 causes the drive gear 74 to displace the open section 76 to move aware from the interior openings 100 to close the cavity 80 to air communication 110 or to open the air communication 110 by placing the open section 76 of the moving belt 77 opposite the interior openings 100. While the removable covering in 10a and 10b is shown to be covering the interior openings 100, it can alternatively be placed against the exterior openings 90 or anywhere along the length of the cavity 80. The removable cover 120 or 76 is therefore configured to close or open air or moisture flow between the plurality of exterior openings 90 and the plurality of interior openings 100.

The front and back surfaces of the rib structures 130 may be coated in a sound absorbing layer, material, or structural surface 134, such as soft materials or materials having noise deadening qualities and/or shapes, such as corrugations or egg-crate shape as shown in FIG. 2. Thus, the rib structures 130 may serve to interfere with noise leakage into the interior space 105 from the outside 95 and vice versa. Some or all of the rib structures 130 within the cavity 80 may contain noise absorbing surface 134.

Also shown in the embodiment in FIG. 2. Is a removable back wall 60, which is mounted using snap lips 62 over the top and bottom walls 20 and 30. Additionally, in the case of a motor driven removable covering 77, the motor may be operated using the actuator 64 or in a more automated setting with a thermostat activated switch 66. The removable back wall 60 may be completely removable or partially removable, for example, by having one edge attached to the body of the frame element through a hinge. The thermostat switch 66 may be deployed on the structural frame element 10 or in any other location and control the operation of electrical components within the structural frame element wirelessly or through a wired connection.

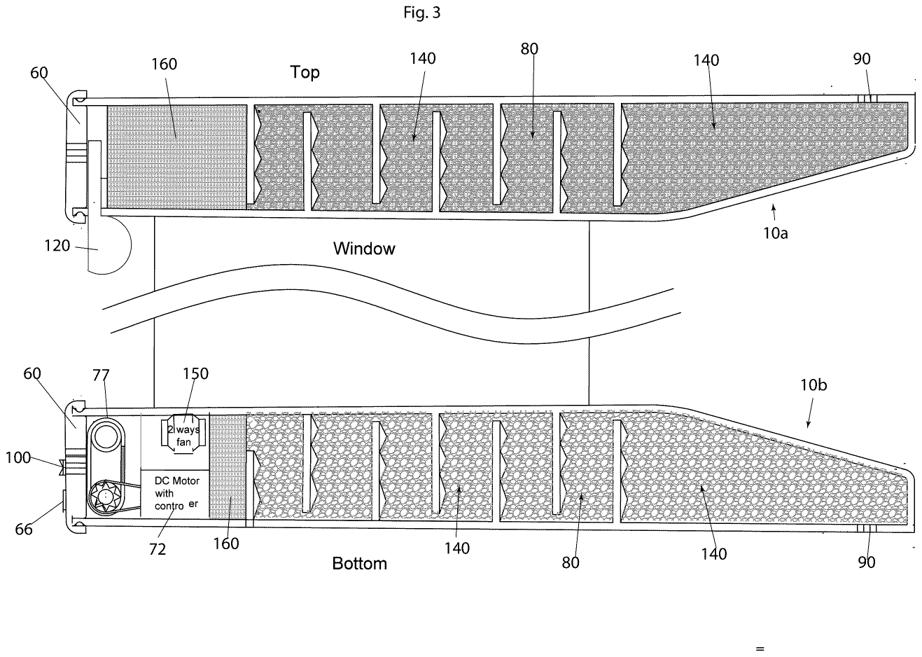

In another embodiment shown in FIG. 3, the cavity 80 further comprises a plurality of interior coils 140. The coils may be real electrical conducting coils and connected to a power source or be a plurality of geometrically shaped objects which fill the entirety of the empty space of the cavity 80 that is not filled by another object. The purpose of the ‘filler’ coils 140 is to slow the air current traveling through the cavity 80. During the slowdown, the filler coils 140 function as air temperature exchange mechanism during which the air from the exterior openings 90 that is trapped inside the cavity 80 will be warmed or cooled to some extent by the air entering from the interior openings 100. Alternatively, coils 140 may be connected to a power source and may warm or cool the interior space based on the setting of a thermostat 66. The interior coils may be connected to the power grid of the structure where the frame elements 10a and 10b are installed. Alternatively, a battery may be installed within the cavity 80. In another alternative, the top wall 20 may support solar panels.

Also shown in FIG. 3 is at least one fan 150 and a removable filter 160. The fan or fans 150 may be a drum fan or a blade fan. There may be one or several fans connected inline along the width of cavity 80 or there may be several fans 150 deployed throughout cavity 80. Fan 150 may be directed to channel air flow towards or away from the exterior openings 90 or the interior openings 100. A removable filter 160 as well as the components of the cavity may be accessed through the removable panel that serves as the back wall 60.

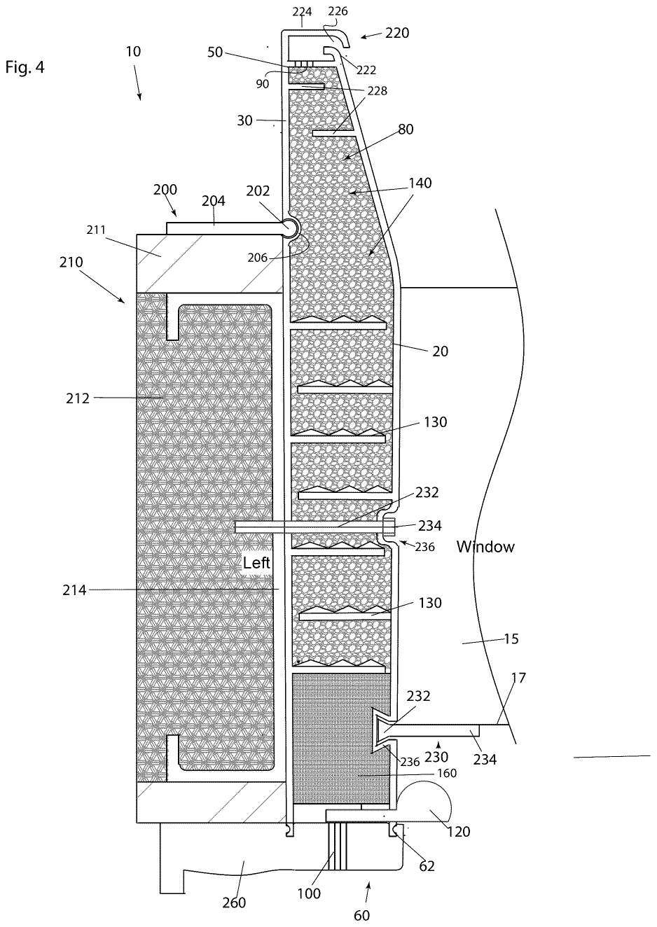

FIG. 4 demonstrates another alternative embodiment of the support frame element 10. Shown are the back front wall 50, the back wall 60, the top wall 20 and the bottom wall 30. The cavity 80 in enclosed by sidewalls (70). Shown is the first attachment fastener 200, having a holding part 202 and an insert part 204. The holding part 202 held within a groove or socket 206 of the bottom wall 30. The insert part 204 secured within an existing wall 210. Preferably the insert part 204 is attached in between an sheeting surface 211, such as sheetrock, plywood, insulation or a masonry layer. While one first attachment fastener 200 is shown, there are preferably a plurality of first attachment fasteners 200. Additionally, the groove or socket 206 may be provided a plurality of additional points to accommodate the various widths and wall compositions of the wall 210.

Shown in FIG. 4 is an embodiment having additional overlapping lips 220 that serve to block the exterior openings 90. In the embodiment shown in FIG. 4, the overlapping lips are comprised of a lower lip 222 and an upper lip 226 that overlap each other, forming a channel 226. The channel 226 permits for air circulation, while the overlap of the lips 222 and 224 prevents excess moisture from reaching the exterior openings 90.

In the embodiment in FIG. 4 shown is the at least one locking slot 236. The locking slot 236 is utilized to removably secure, or couple with the holding element 230. The holding element 230 is comprised of the holding part 232, which is locked within the locking slot 236, and an insert part 234 which secures the rear edge 17 of the structural element 15, which is preferably a window, but may also be a door different block types or other structural elements.

Additionally shown in FIG. 4 is an alternative embodiment of the back wall 60, which is removably mounted onto the back of the bottom wall 30 and top wall 20. The removable mounting is accomplished via snap coupling 62, but may be done with a latch, fastener or hinged attachment. The backwall 60 is in the form of a decorative molding 260, such that the structural frame element 10 shown in FIG. 4 not only services a structural system for securing a window 15 within a wall 210, but also as a holding element for the decorative molding 260, which may still be movable, or which may be opened to gain access to the removable filter 160. Additionally, the structural frame component 10 may be secured to the wall 210 using at least one, and preferably a plurality of, the second fastener 232, which is preferably inserted through both top and bottom walls 20 and 30 into an existing stud or cinder block 214. A groove or slot 236 may exist within the top wall 20 to conceal the head 234 of the second fastener 232.

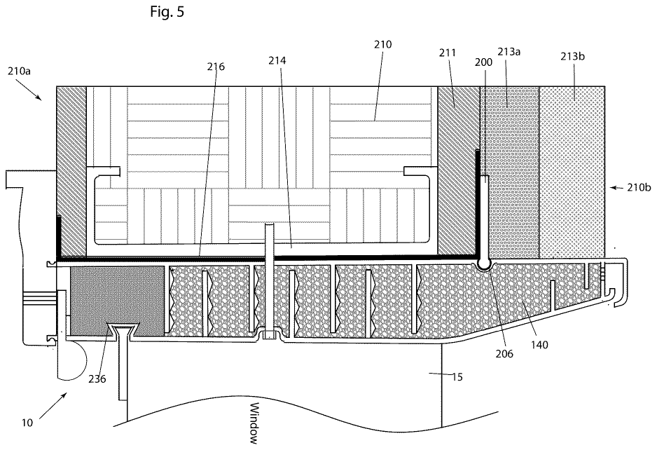

It should be noted that FIG. 5 is a cutaway diagram locking from top down to a cross section of a wall 210. Thus, the structural frame element 10 is deployed lengthwise from the back of the wall 210a to the front of the wall 210b. It should be noted that the disclosed structural frame element 10 and a second structural frame element (11) that is in a parallel and spaced apart orientation with the structural frame element, may form a head and sill of an aperture (18) or side frame elements. The width of the structural frame element 10 would then be equal to the height of the window 15 or the window aperture of the wall 210. FIG. 5 demonstrates the at least one fastener element 200 secured between the wall layers 211 and 213a. Layer 211 may be insulation, while layer 213a is tape on top of insulation, with layer 213b being the cross section of an exterior cladding panel of a building façade. Additional fastener element 200 may be deployed adjacent to, as well as below and above the fastener element shown. The fastener element is shown inserted above the waterproof membrane 216 of the existing stud or cinder block layer 214.

The locking slot 236 is shown in a dovetail shape such that the holding element 230 should be security held and not give way when the window 15 is installed, or after installation, as the result of wind pressures and age. Alternatively, the locking slot 236, and the holding slot 206, may be substantially parallelogrammical, triangular, circular or made in a plurality of other shapes.

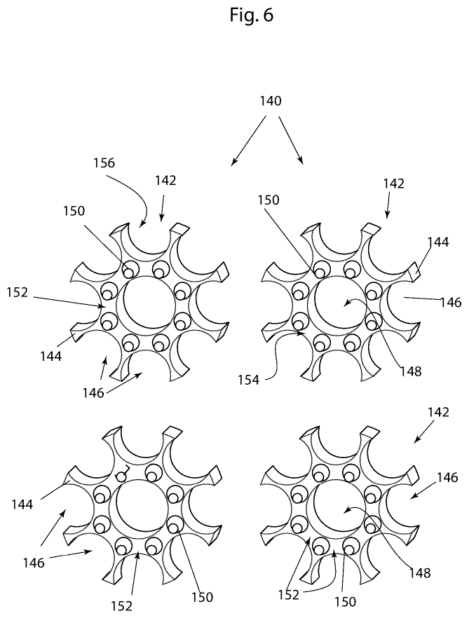

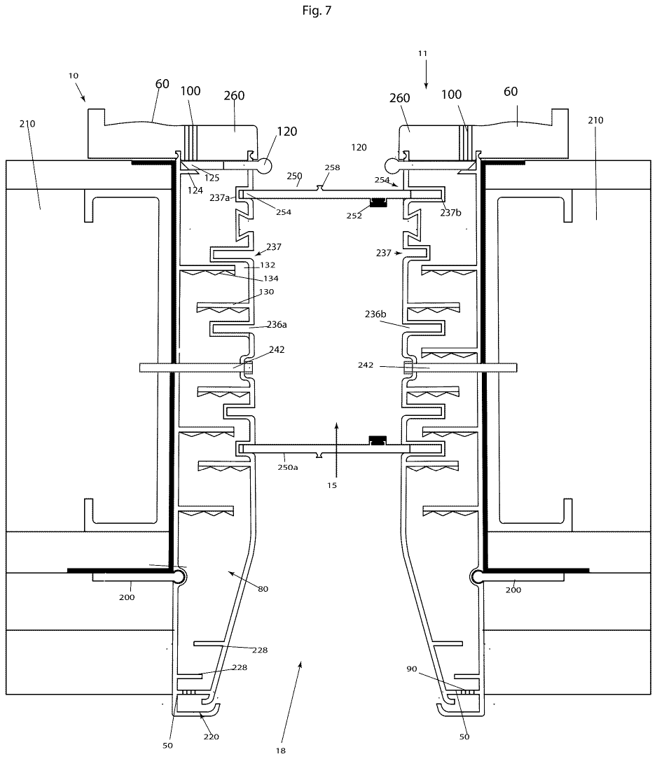

FIG. 6 shows one embodiment of the coils 140. The coils 140 are utilized in the present invention as filler for the cavity 80. While a plurality of embodiments and shapes may be utilized, one example of the coils 140 is shown in FIG. 6 substantially in shape of a spur gear having a body 142, top lands 144 and bottom lands 146. The center 148 of the body 142 is preferably empty. The coils 140 may be placed within the cavity with back face 152 against the front face 154. As such, a plurality of face protrusions 150 having spaces 152 between the protrusions are required to ensure that coils 140 are not clumped too closely together. As shown a plurality of coils 140 filling the cavity 80 is used to impede air flow (110) flowing in from the internal space and from the exterior through the interior openings 100 and exterior openings 90, respectively. While the air flow navigates between the openings 148, 146 and 152 of the coils, the two air flows mix causing the outer temperature to warm while cooling the air flow from within, or on the contrary, to cool down if the interior air is cooler than air outside the wall of a structure. This air circulation causes air flow out of the internal openings 100 into the interior space 105 has been warmed or cooled several degrees to be close to the temperature in the interior space. The coils are preferably between 3 mm and 4 cm in diameter, but may be made even larger based on application. Additionally, shown are filler coils, and it should be noted that conventional electrical coils may be provided and connected to a power source to head the environment within the cavity 80 using electric current.

FIG. 7 demonstrates how the structural system that can be used to install structural components, namely windows 15 within existing apertures 18 of the wall 210. The system requires a structural frame element 10 to be utilized with another or second structural frame element 11, with the structural frame element 10 and the second structural frame element 11 being in a parallel and spaced apart configuration with each other along either side of the aperture 18.

Each structural frame element is mounted against the wall 210 using at least one first fastening element 200 and at least one second fastener 242. There are a plurality of locking slots 236. It is preferred that the locking slots on the structural frame element 10 and the second structural frame element 11 function as a pair of locking slots as 236a and 236b. There is a plurality of pairs of locking slots 236a and 236b to accommodate windows 15 of various widths and sizes.

Shown in FIG. 7 is a holding bar 250, which is an alternative embodiment of the holding element (230). The distal ends 254 of the holding bar 250 are locked into openings 237a and 237b of the locking slots 236 which face each other and form a locking pair. The holding bar 250 preferably comprises at least one cushioning element 252 facing the structural element 15 being deployed within aperture 18. The holding bar 250 may further comprise a mounting lug 258 to accepting a decorative finish cladding panel. The structural element 15 is then locked in within the structural system incorporating structural frame elements 10 and 11 using one ore more holding bars 250 and one or more second holding bars 250a.

One or both of the structural frame elements are comprised of the top wall 20, bottom wall 30, the front wall 50 and the back wall 60. The back wall may be in the shape of a finishing molding, which may be snaped into place and be removable. The exterior openings 90 may additionally be comprised of overlapping lips 250, with the cavity 80 featuring an additional set of rib projections 228 in addition to the rib projections 130 having sound insulating coating 134 and having an opening 132.

FIG. 7 demonstrates an alternative embodiment of the removable covering 120, where the distal end 125 functions as a plunger that is secured between the back wall 60 and a protruding inner wall 124, when the removable covering 120 is forced into the slot between the back wall 60 and the protruding wall 124, it is locked into place and the air flow 110 within the cavity 80 is interrupted.

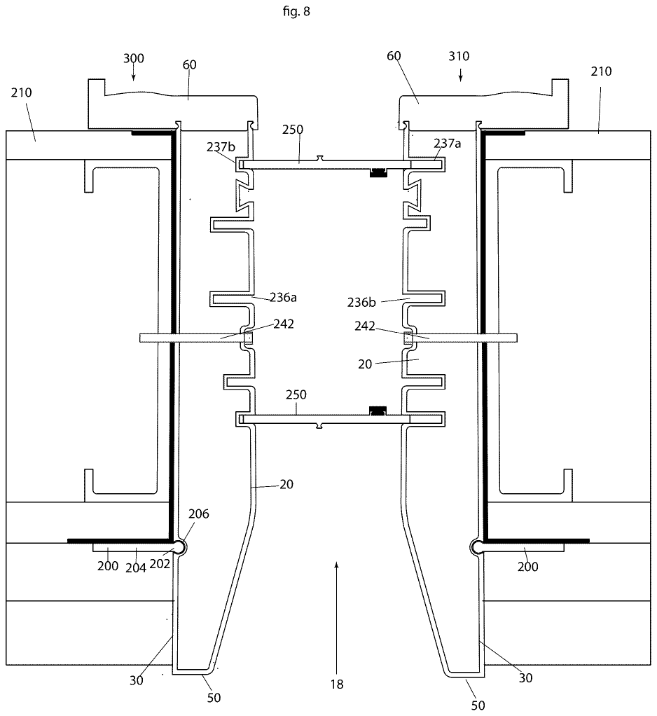

FIG. 8 demonstrates an alternative embodiment of the structural system that serves as an adapter for securing attaching windows 15 within and existing aperture 18. Shown in FIG. 8 are two structural frame elements 300 and 310 in a parallel and spaced apart orientation with respect to each other. Both structural frame elements 300 and 310 have a top wall 20, a bottom wall 30, side walls 70, a front wall 50 and a back wall 60. The bottom wall 30 is adjacent to an existing wall 210. The plurality of locking slots 236 within each of said two structural frame elements 300 and 310 forming a coaxial pair 236a and 236b. Each coaxial pair of locking slots 236a and 236b is configured to have a holding element (230) such as the holding bar 250. One or more holding elements 250 and 250a can be used to secure a structural component 15, which is further secured between the structural frame elements 300 and 310.

FIG. 8 also shows at least one first attachment fastener 200 having a holding part 202 and an insert part 204. The insert part 204 is inserted into an existing wall, while the holding part 204 is held within the socket 206 of the bottom wall 30. One or more second fastener 242 secures the support frame element 300 and 310 to the existing wall 210. Also shown in this embodiment is that the back wall 60 may form a decorative molding 260.

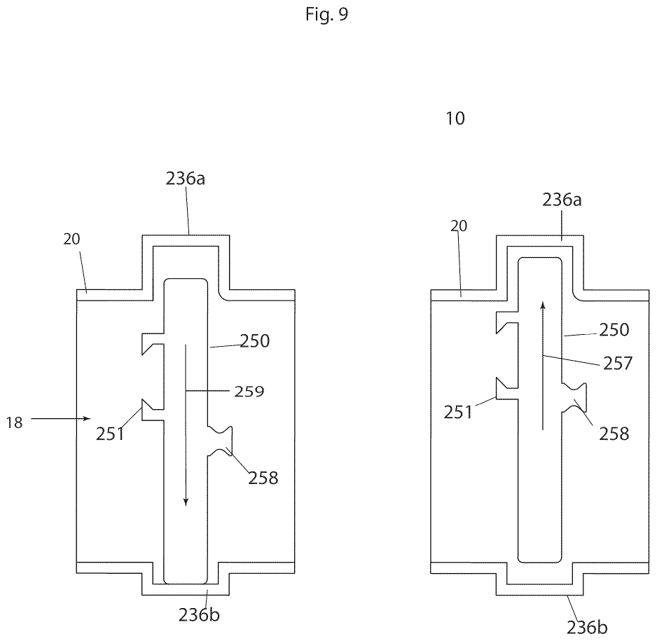

FIG. 9 demonstrates the method of deploying the holding bar 250 within the locking pair of locking slots 236 a and 236 b. The installer may hold on via 258 and move the holding bar 250 between the locking slots 236a and 236b. The holding bar 250 is wider than the aperture 18. To permit installation of the holding bar 250, one end of the bar is moved up in the direction 257 within the longer slot 236a such that the opposite end enters the shorter slot 236b. The holding bar 250 is then moved down in the direction 259 along the slot 236b.

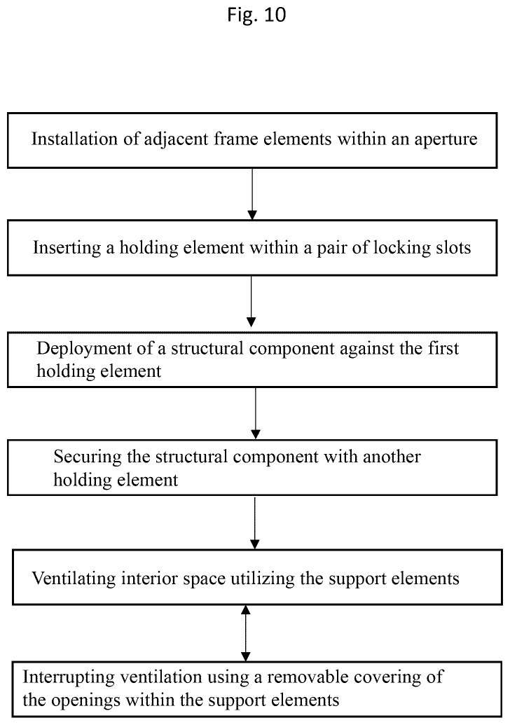

Disclosed in FIG. 10 is a method that utilizes the structural support frames 10 and 11 that are installed in a parallel and spaced apart orientation with respect to each other within a prepared wall aperture. The first coaxial pair between the structural support members is then used to hold a holding bar. A structural component, such as a window is then installed between the two structural support members and against the holding bar. The structural component is then secured by another support bar 250 within a second coaxial pair of locking slots 236a and 236b.

The same structural system may be utilized to ventilate the interior structure utilizing the steps of opening exterior openings and interior openings within the structural frame elements to establish air communication between each set of openings within the interior openings. The air communication can then be interrupted or reenabled by openings and closing the removable covering 120.

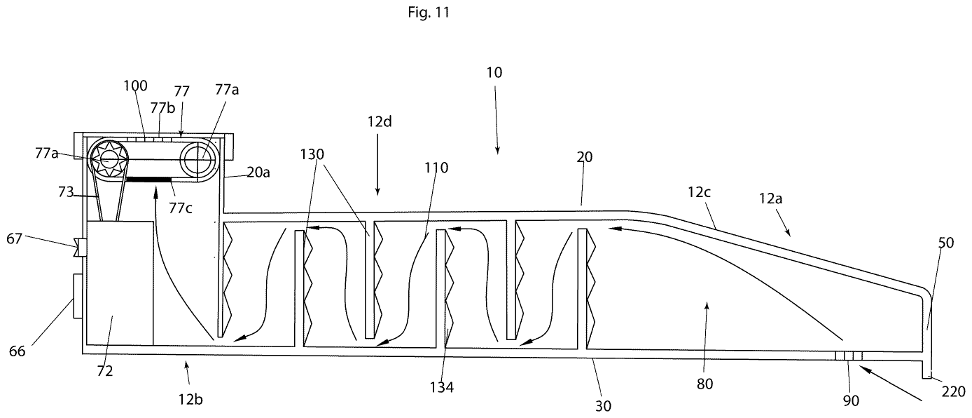

FIG. 11 describes an alternative embodiment of a structural frame element 10. Shown is the top wall 20, the bottom wall 30, the front wall 50 and the back wall 60, which form an interior cavity 80. A plurality of rib structures 130 are in adjacent and spaced apart configuration within the cavity 80, each of the rib structures 130 are oriented across the width of the cavity 80 and may contain an opening 132 or may not reach the opposing wall, creating a space 132. The rear portion of the structural frame element 12b is shown to contain a motor 72, which may activated by a manual switch 66 or a thermostat activated switch 67. The drive belt 75 induces rotation of the belt 77 which serves as the removable covering that interferes or permits the air communication 110 by opening or closing the interior openings 100.

FIG. 11 further demonstrates an alternative embodiment of the structural frame element 10. Shown is the top wall 20, the bottom wall 30 the front wall 50 and the back wall 60. The front portion 12a of the structural frame element 10 contains the sloped section 12c of the top wall 20, as well as the exterior openings 90. An overlapping lip 220 is shown being ahead of the exterior openings 90. The embodiment shown in FIG. 11 is preferably a sill or a head unit of the structural frame element, with the depth of a window or door being mounted on the level section 12d of the top wall 20. The alternative rear section 12b of the structural frame element 10 demonstrates an elevated section having a motor displaced removable covering 77. The dc motor 72 engages the removable covering 77 via a belt drive 72. The removable covering 77, which is shown in form of a ribbon wrapping around the rollers 77a is comprised of the section without an opening 77a and section with an opening 77b. The section of the removable covering 77 with openings 77b moves into place opposite the interior openings 100 to enable the air communication 110 and the section without an opening 77c moves into place to interrupt the air communication 110. The raised portion 20a serves to prevent moisture from getting behind a window or door frame that is mounted against the raised portion 20a, and the sloped section 12c causes moisture to roll off towards the exterior of a façade. Also shown is the actuator 67, a thermostat 66, rib structures 130, openings within the rib structures 130 and the noise cancelling coating 134.

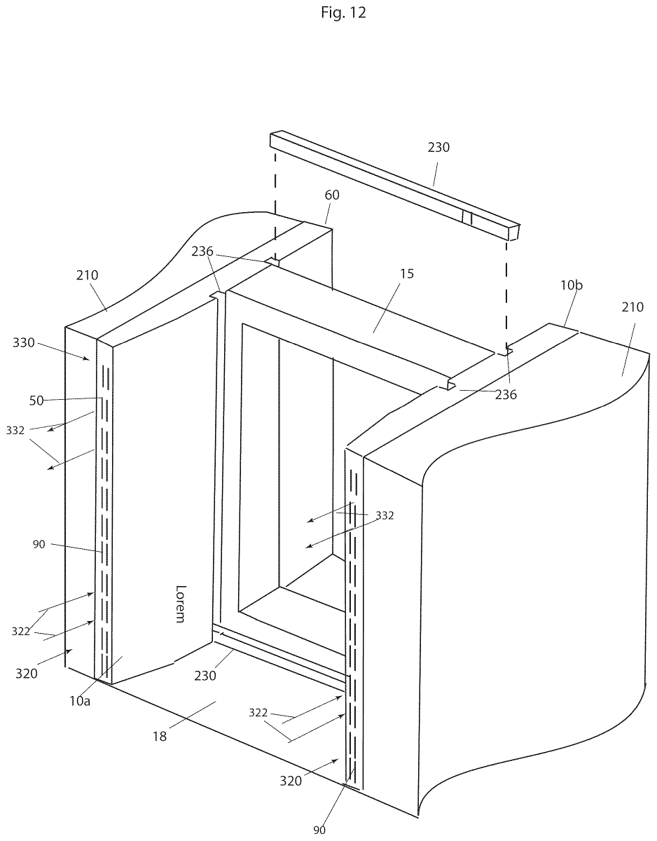

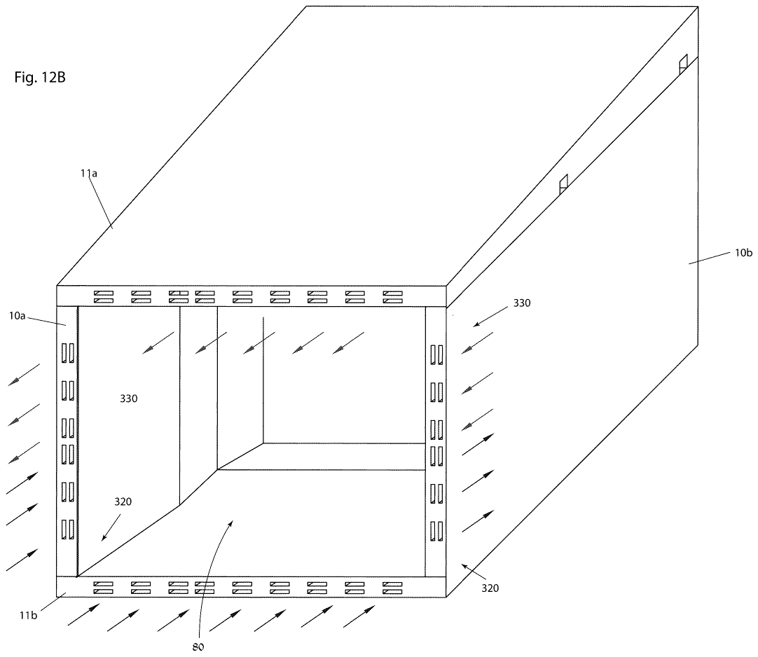

FIG. 12 is perspective contextual diagram showing window 15, the structural frame element 10a the second structural frame element 10b, the holding element 230 inserted through the locking slots 236. Another holding element (230) is utilizing the pair of locking slots (230) located behind the window 15. The structural frame element 10a and the second structural frame element 10b are mounted along the sides of the aperture 18, but may be mounted on the head, sill or all around the aperture. The height of the structural frame element 10a and the second structural frame element 10b permits the top section 330 to expel warm air 332 from the interior of the structure through the exterior openings 90, while the bottom section 320 draws in cooler air 322 through the exterior openings 90.

FIG. 12B the hot and cold air circulation shown in FIG. 12 involving an embodiment having the structural frame element 10a and the second structural frame element 10b and the upper structural frame element 11a and a lower structural frame element 11c. The top section 330 of the structural frame element 10a and the second structural frame element 10b, and the upper structural frame element 11a serve to expel warmer air 332 through exterior openings 90, while the bottom section 320 utilizes the lower section of the structural frame element 10a and the second structural frame element 10b, and the lower structural frame element 11b in draw in cooler air through openings 90. In another alternative, hot and cool air in a unit may be exchanged using just one or several of the structural elements of a single embodiment.

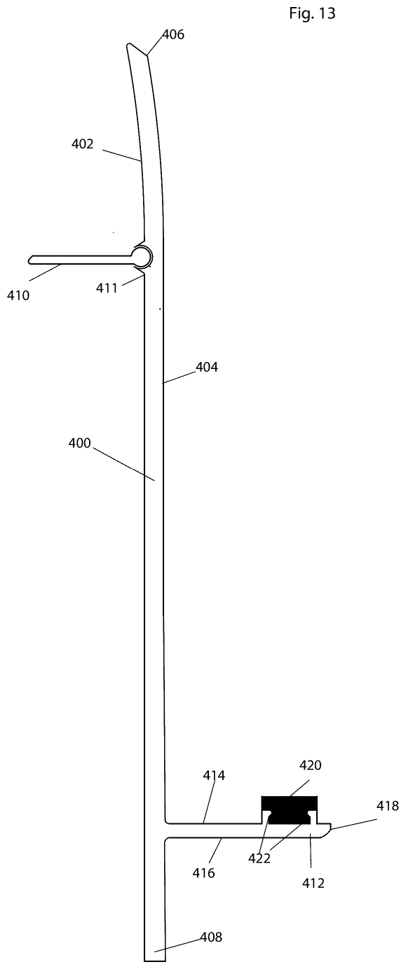

FIG. 13A demonstrates another embodiment of the structural frame member that is configured to serve as an attachment point for structural components, such as doors and windows. Shown is the holding wall 400. The holding wall 400 has a first side 402 and a second side 404, an outer end 406 and an inner end 408. FIG. 13A further demonstrates the at least one holding pin 410 coupling or extending at an angle, preferably a right angle, along the width of the first side 402 between the outer end 406 and the inner end 408. The holding pin 410 is utilized to fasten the holding wall 400 to an existing wall (210), usually between component layers, such as wood or masonry layer, and an insulation or cladding layer. The holding pin 410 is shown being held within a mounting socket 411 but may also be unitary with the holding wall 400. The holding 400 and its components are preferably made of thermally isolating materials, such as polymers, resins, fibers, rubber, wood or masonry.

At least one projecting member 412 extends laterally at an angle, preferably a right angle, from said second side 404 of the holding wall 400. The projecting member 412 has the first side 414, the second side 416, and a free end 418. The projecting member 412 preferably comprises at least one cushioning member 420 along the first side 414 or its second side 416. The cushioning member is configured to protect structural component (15) from damage during installation. The cushioning member 420 is secured to the projecting member 412 with adhesive or may be held in a socket using at least one setting element 422.

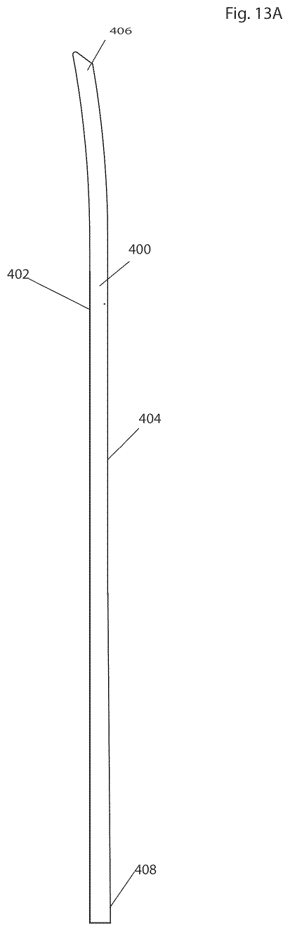

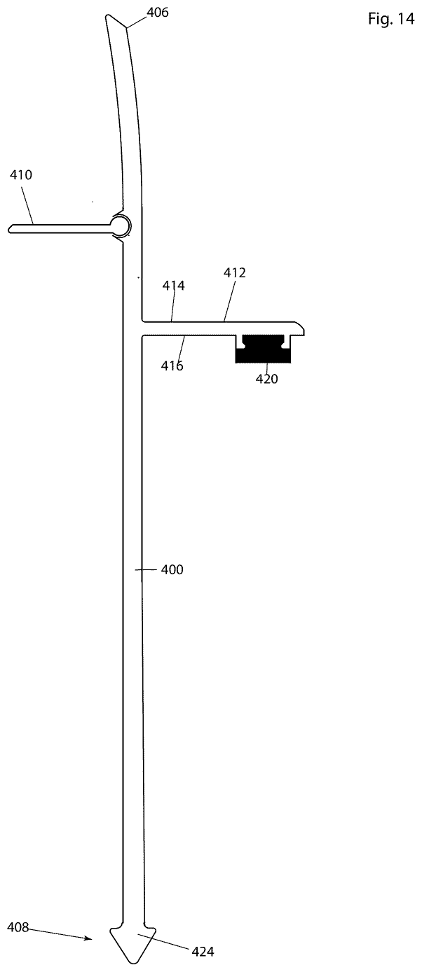

FIG. 14 demonstrates the holding wall 400 with the projecting member 412 being closer to the outer end 406, with the cushioning member 420 being attached to the second side 416. The embodiment shown in FIG. 13 may be used to install the structural component 15 from the outside of the structure, while the embodiment shown in FIG. 14 may be used to install the structural component (15) from the interior space of the structure. Additionally, the inner end 408 of the embodiment shown in FIG. 14 is in the shape of a barb 424 which is configured to fit into an appropriately shaped socket of a decorative frame member or another structural member. The barb 424 is in the shape of a triangle, but may also be a square, circle, ellipse, an elongated ellipse, a rod, a pin, a dovetail, or any other geometric shape, including a rod with snap pins or rings along its length.

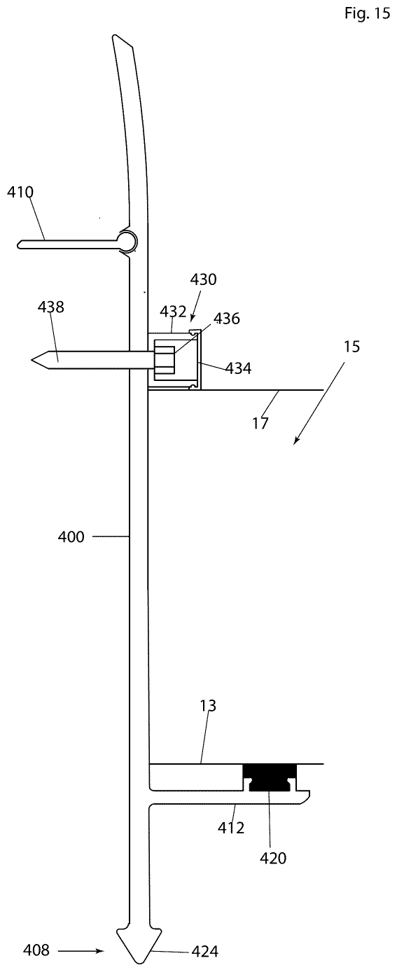

FIG. 15 demonstrates how a structural component 15 can be secured using the structural frame element comprised of the holding wall 400, the projecting member 412 and the holding pin 410. The leading edge 13 of the structural component is pushed against the cushioning member 420 during installation. The tailing or rear edge 17 is then secured using at least one removable securing member 430. The removable securing member 430 is comprised of a socket 423 which is fastened to the wall holding wall 400 with fastener 438. A decorative or finishing lid or cover 434 is then placed over the mouth of the socket 423 to conceal the fastener head 436. Preferably, and as is described in figures below, a holding wall that is parallel and spaced apart from the holding wall shown in FIG. 15 will secure the other side of the structural component 15 and such holding member will have its own projecting member and a removable securing member.

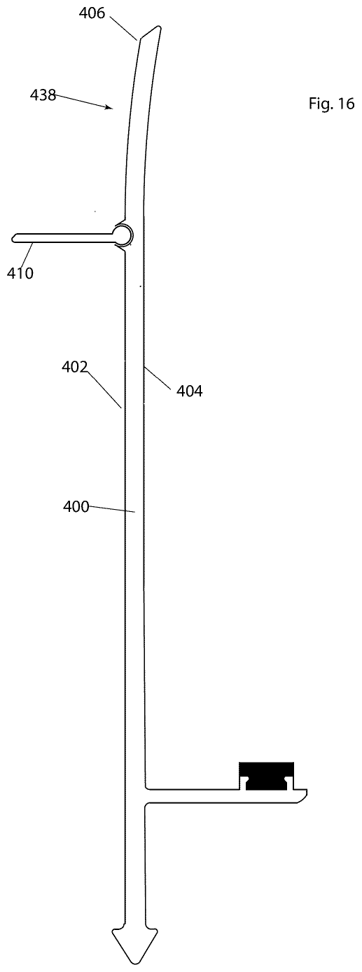

In FIG. 16 as well as in FIGS. 13-15 , the holding wall 400 is shown to have a span 438, which is a length of the holding wall 400 between the holding pin 410 and the outer end 406. The span 438 is shown curving in the direction of the second side 404. The FIGS. 13-15 the span 438 curved in the direction of the first side 402. The curvature of span 438 is intended to promote water drainage away from interior spaces. Therefore, the holding wall 400 in FIG. 16 may be showing a holding wall 400 installed at the top of an aperture (18) whereas the holding wall 400 shown in FIGS. 13-15 is installed as a sill of an aperture (18) or vice versa.

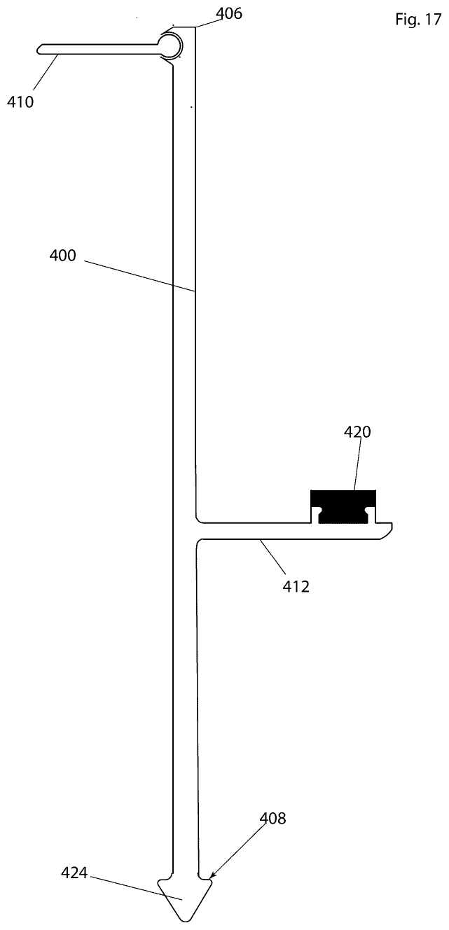

Alternatively, the outer end 406 does not have a span 438 as illustrated in FIG. 17, where the holding pin 410 issues laterally close the outer end 406. The embodiment shown in FIG. 17 accommodates a structural component (15), such as a window frame, having a lip or flange that covers the outer end 406.

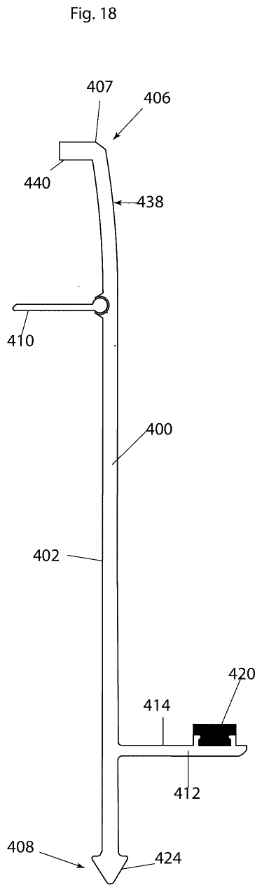

FIG. 18 demonstrates another embodiment of the structural frame member showing a holding wall 400 having a holding pin 410 issuing laterally from the first side 402. The holding pin 410 is shown at a right angle but may be more of an obtuse or an acute angle with respect to the first side. Projecting member 412 is shown having the cushioning member 420 along the first side 414. The span 438 is shown curving towards the first side 402. At the free end 407 a lateral lip 440 extends at an angle, that preferably puts the lateral lip 440 flush with a wall surface. The lateral lip 440 may also issue at a sharper or more obtuse angle than shown to accommodate the angle of the exterior surface of the wall, or the aperture into which the lateral lip 440 may be inserted.

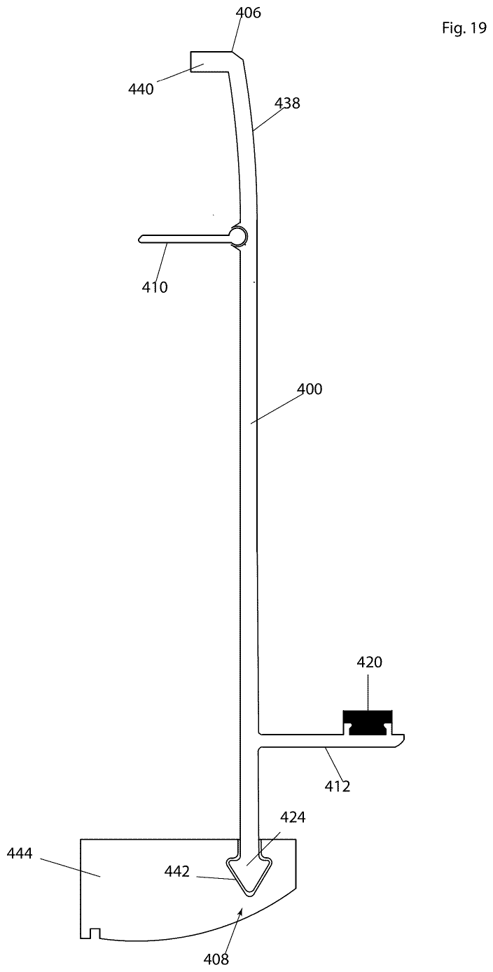

FIG. 19 demonstrates a holding wall 400, having a span 438, an outer end 406 and a lateral lip 440. The projecting member 412 is shown closer to the inner end 408 but may be closer to the outer end 406. The barb 424 on the inner end 424 is shown in a triangular shape that snaps into the socket 442 of the decorative wall member 444. The decorative wall member 444 may be a molding or an interior frame component forming a border around an aperture (18). The barb 424 is in shape of triangle with the socket 444 and barb fitting together like lock and key. The barb 424 may form a lug in any chape and may be used to couple together with additional structural members.

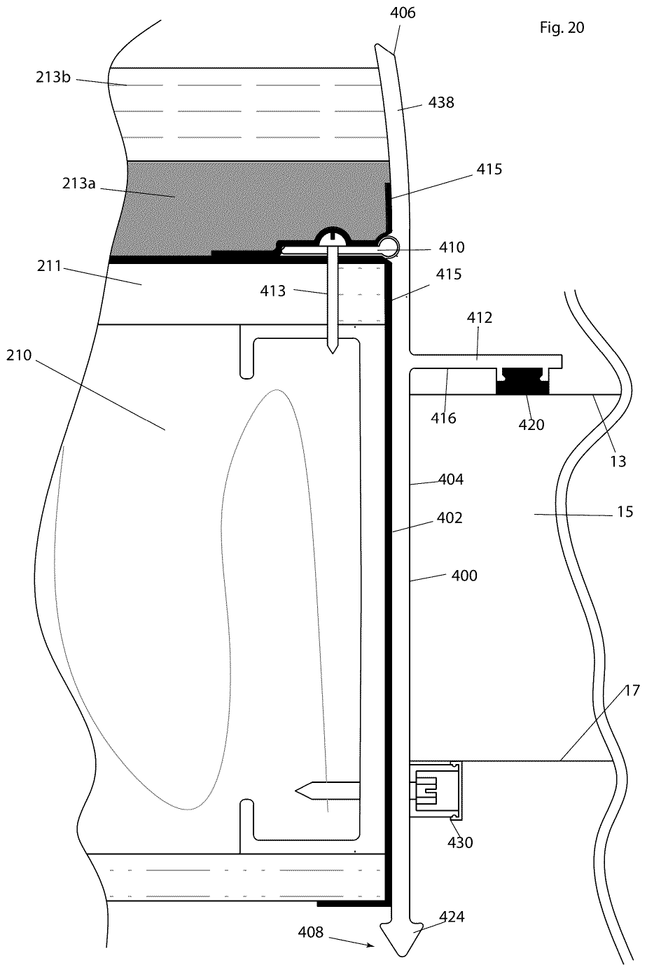

The holding wall 400 is displayed in context in FIG. 20, showing the first wall being adjacent to a waterproof membrane 415 which surrounds the wall 210. The existing wall is comprised of a exterior paneling or masonry layer 211, an insulation layer 213a and the cladding layer 213b. The outer end 406 is designed to extend just beyond the outer cladding layer to enhance water drainage of the holding wall 400. Notably, the configuration of the holding wall 400 enables secure attachment of the holding wall 400 to an existing wall 210 without perforating the waterproof membrane 415 in areas that face the exterior of the wall. Instead, the holding wall 400 is installed once waterproof membrane 415 that surrounds the existing wall 200 has been installed. The holding pin 410 is then mounted above the waterproof membrane 415, and below the insulation layer 213a. At least one fastener 413 is then driven through the holding pin 410 to secure the holding pin to the existing wall 410 and then the holding pin and the fastener is wrapped in a layer of waterproof membrane 415, with a strip of waterproof membrane extending over the strip representing the span section 438. It should be appreciated that the view of the holding wall 400 is a cross-sectional view that exposes the width of the holding wall 400 between the inner end 408 and outer end 406. Therefore, there may be a plurality of holding pins 410 below and above the holding pin shown. Alternatively, the holding pin 410 may be a ribbon or rib extending over all or some of the length of the holding wall 400.

Also shown in FIG. 20 is a structural component 15 that is installed from the interior space, with the leading edge 13 secured by the cushioning member 420 mounted on the second side 416 of the projecting member 412. The removable securing member 430 is mounted on the interior side of the structural component 15. The inner end 408 preferably extends past the existing wall 210 and is configured to secure a decorative wall member 444 onto the lug or barb 424.

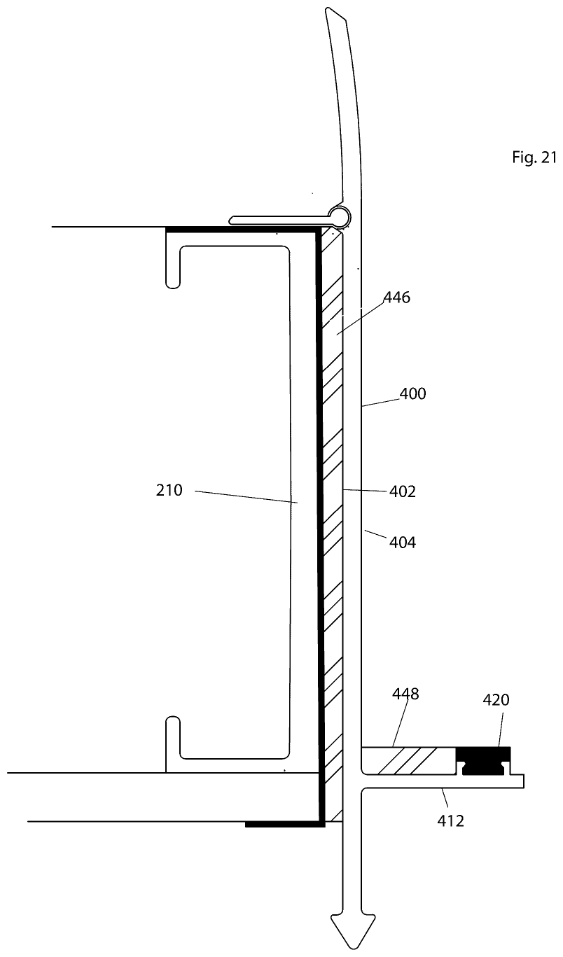

In another alternative shown in FIG. 21, a layer of insulating material 446 is placed between the first side 402 and the existing wall 210. Additional insulation 448 may be placed along the projecting member between the cushioning member 420 and the second wall 404.

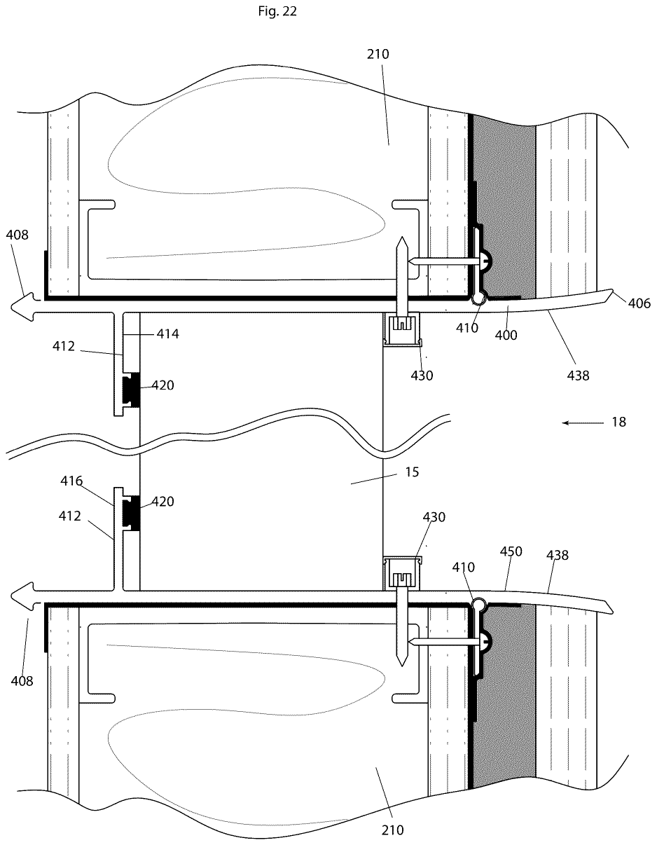

FIG. 22 demonstrates a second holding wall 450 that is in parallel and spaced apart configuration with the holding wall 400. Both the holding wall 400 and the second holding wall 450 are comprised of the inner end 408, the outer end 406, at least one holding pin 410, and at least one projecting member 412, and at least one removable securing member 430. All components of the holding wall 400 and the second holding member 450 are in a coaxial and parallel association with each other, with coaxial meaning on the same axis. In diagram shown in FIG. 22, the projecting members 412 are arranged to receive the structural component 15 being installed from the exterior of the wall 210, with the cushioning member 420 mounted on the first wall 414. Alternatively, the projecting members 412 may support installation from the interior of the structure, with the cushioning member 420 on the second wall 416. It should also be notable that the projecting member 412 may be removable or unitary with the holding wall 400 or the second holding wall 450. With a removable projecting member 412 being mounted within a slot. The projecting members 412 extend toward each other. The span section 438 is shown curving in opposite directions between the holding wall 400 and the second holding wall 450. The spans can curve away from each other, toward each other, in the same direction or not curved, all depending on aesthetics and direction of water drainage. The holding wall 400 and the second holding wall 450 may represent the head and sill or the jamb components of an aperture 18. The inner end 408 preferably comprises a barb 424 which extends into the interior space beyond the wall 210 and is configured to mount a removable securing member 430.

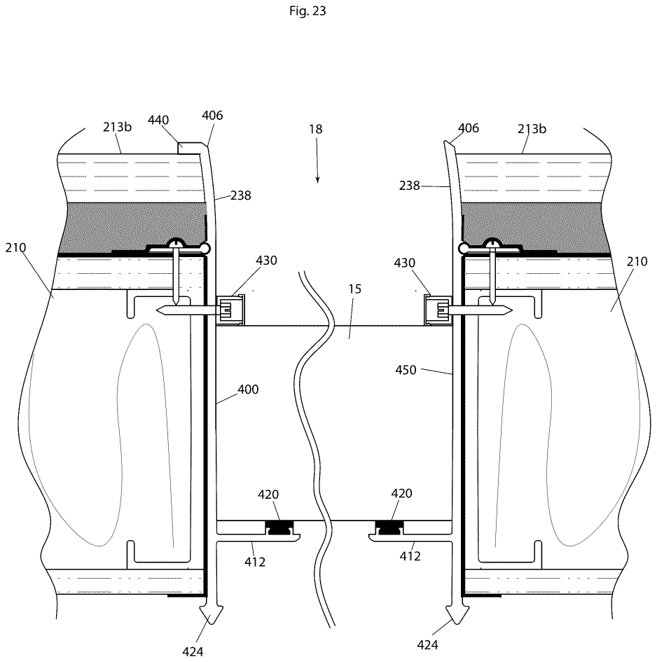

FIG. 23 demonstrates that the holding wall 400 and the second holding wall 450 may be slightly different depending on the construction requirements. The holding wall 400 is shown having a lateral lip 440 that is oriented in a parallel to the exterior surface of the cladding layer 213b. Notably the exterior surface 213b may be any type of wall surface. Additionally, the span 238 of the holding wall 400 is curved in the direction of the wall 210. The span 238 of the second holding wall 450 is shown having a plan outer end 406 with a curvature of the span 238 in the direction of the holding wall 400. As shown the holding wall 400 may serve as the sill and the second holding wall 450 may serve as the head. Also shown in FIG. 23 is a structural component 15 that is held in place within an existing aperture 18 between the holding wall 400 and the second holding wall 450. The leading edge 13, or the side of the structural component 15 that was leading when the structural component 15 was deployed is being held between projecting members 412 and the temporary holding members 430.

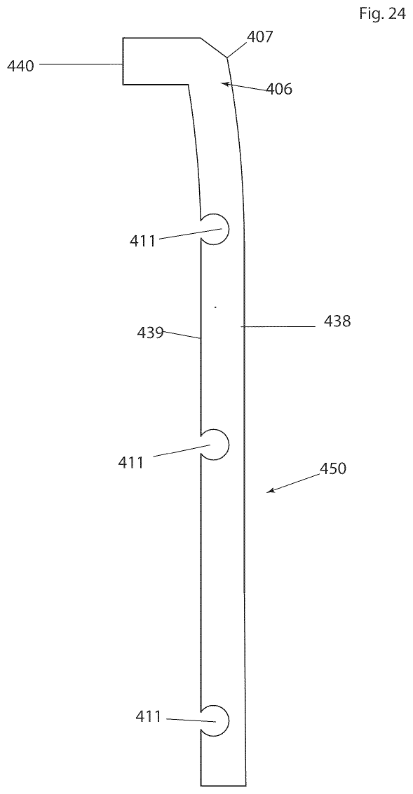

FIG. 24 is a detailed diagram of the lateral lip 440, which is part of the span 438. The lateral lip 440 issues laterally, at an angle, preferably a right angle, to the first wall 450. The first wall 450 is shown having multiple sockets 411 for mounting a holding pin 410, or multiple holding pins 410. Alternatively, the holding pin can be inserted through an opening in the first wall 450.

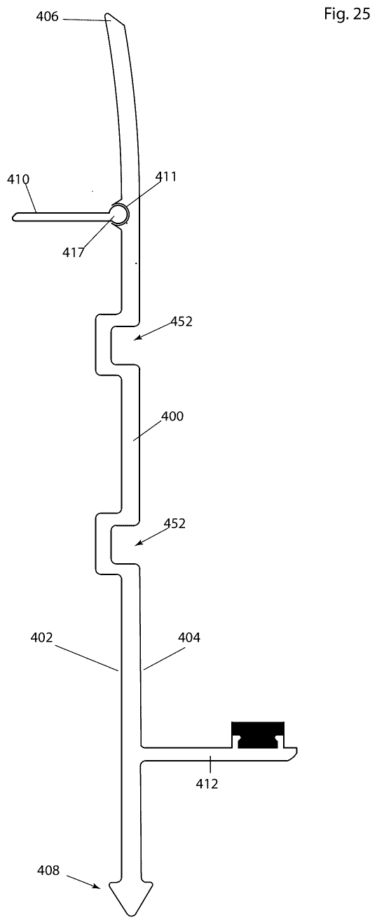

Another alternative embodiment of the holding wall 400 is shown in FIG. 25 demonstrating the holding wall 400, the outer end 406, the inner end 408, the projecting member 412, and the holding pin 410. The holding pin 410 is shown having a holding portion 417 that is coupled within the socket 411. The holding wall may contain additional sockets 452 opening on its second side 404, for additional projecting members 412 or projecting members situated at a different location. Alternatively, all projecting members 412 may be held within sockets 452. The embodiment of the holding wall 400 is especially suitable for stamping, which is cheaper and simpler than chiseling or machining curvatures and grooves. For this reason, a socket 411 or 452 opening the first side 402 or 404, respectively, have a compensating protrusion on the other side of the holding wall 400.

FIG. 25A is an additional embodiment of a stamped holding wall 400 having an outer end 406 and inner end 408 in a form of a barb, a projecting member 412, socket 411, a fastener 516, installed through a socket 518. The structural component 15 is secured between the projecting member 412 and the removable holding member 25.

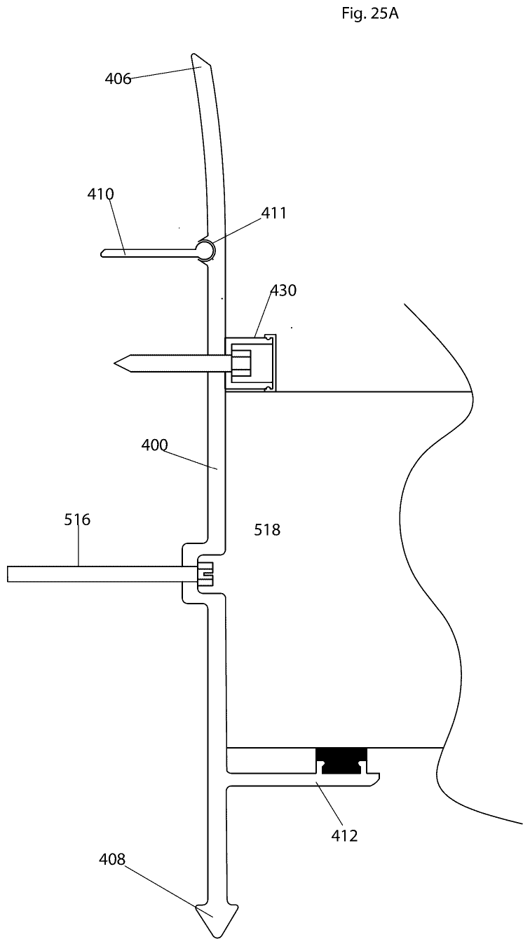

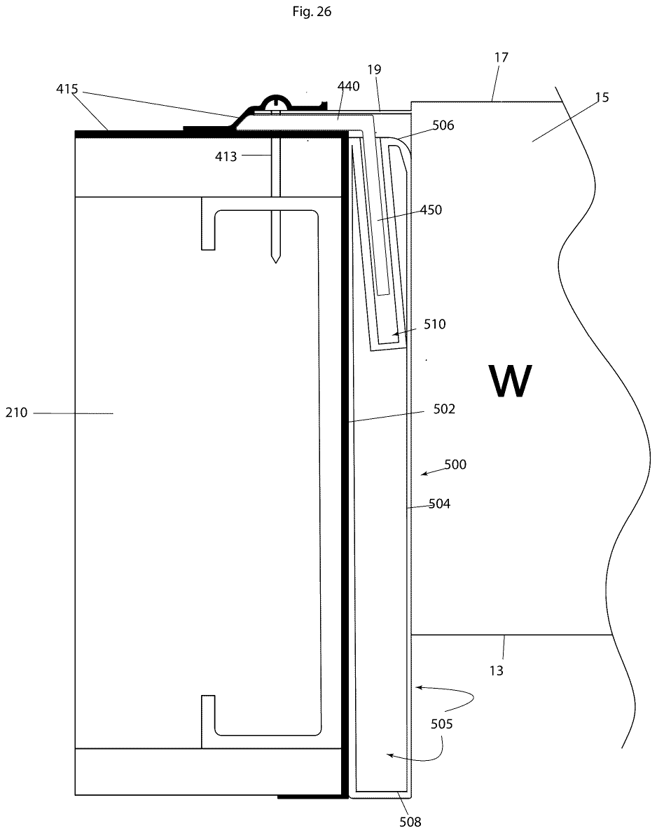

FIG. 26 demonstrates another alternative embodiment of the support system that can be utilized to secure a structural component or element 15 within existing apertures. Shown is a structural frame element 500 having a top wall 504, a bottom wall 502, side walls 505, a front wall 506 and a back wall 508. The bottom wall 502 is configured to be mounted onto an existing wall 210. The front wall 506 may preferably contain a slot 510. The distance between the front wall 506 and the back wall 508 represents the width of the structural frame element 500 with sidewalls 505 representing the length of the structural frame element 500. Slot 510 may be for the entire length of the structural frame element 500 or part of the length. Slot 510 slidingly retains the first wall 450. The free end 407 of the first wall 450 preferably comprises a lateral lip 440 that is shown secured to the weather membrane 415 using the fastener 413. Slot 510 is shown to be on a diagonal and opening in the direction of the existing wall 210. Alternatively, the slot may be vertical or slanted in the opposite direction. The flange 19 issuing laterally from the structural member 15 can then be secured with a fastener 413 together with the lateral lip 440.

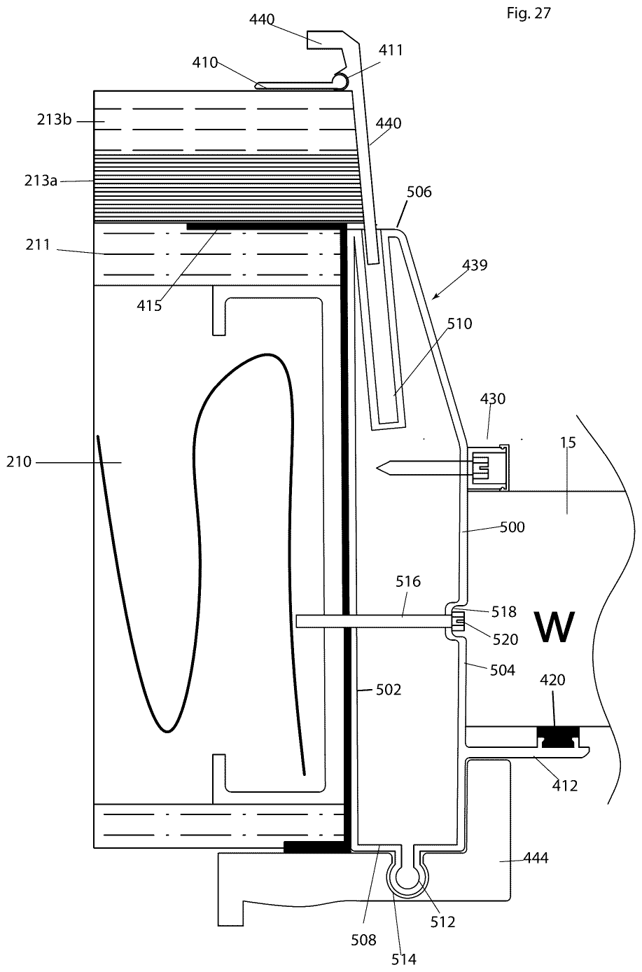

FIG. 27 demonstrates another embodiment of the structural frame member 500 having a bottom wall 502, a top wall 504 a front wall 506 and a back wall 508. The slot 510 is configured to hold the first wall 440, which can be extended to cover additional wall thickness, such as additional insulation layer 213a and cladding layer 213b. The holding pin 410 issues laterally from the first wall 440 being mounted within 411. The holding portion 417 may be round formed as a ball joint to be capable of adjusting to the parallel plane of the surface of the outer layer 213b. The lateral lip 440 is shown issuing laterally in a spaced apart association with the holding pin 410. The holding pin 410 and the lateral lip 440 are shown pointing in the same direction, alternatively, the lateral lip 440 or the holding 410 may point in opposite directions.

The structural frame member 500 is preferably installed within an existing aperture 18 along with at least one other structural frame member, which is shown in FIG. 27A as another or second structural frame member 550. The second structural frame element 550 is preferably a mirror image of the structural frame member 500 and is situated in a parallel and spaced apart association with the structural frame element. The projecting member 412 of the structural frame member 500 and the other structural frame member 550 are preferably coaxial and extending towards one another. The removable holding member 230 is similarly coaxial. The seam between the structural component 15 and the structural frame members 500 and 550 are hermetically sealed by the removable holding member 230 and the cushioning members 420 of the projecting members 412. At least one mounting barb 512 is configured to secure a decorative frame member 444, which functions as a decorative trimming finish once the structural component 15 has been installed.

The front wall 506 contains the slot 510, which preferably pitched on an angle to facilitate drainage of liquid that may penetrate the slot 510. The slot is configured to secure a first wall 450 which is capable of extending or retracting in direction 509, with the lateral lip 440 providing the finish over the cladding layer 213b. The extending first wall 440 enables flexibility on variable thicknesses of the insulation layer 213a and the cladding 213b. Additionally, the insulation layer may overlap with the front wall 506, as shown in FIG. 27B, with the fastening pin 410 and lateral lip 440 sealing the gap. The holding pin 410 is further fastened to the wall 210 with at least one fastener 409. FIG. 27A shows that at least one additional fastener 516 is concealed within the recesses 518, with the bottom wall 502 maintaining a uniform seam with the structural element 15.

The structural frame member 500 is shown having a sloping section 439 towards the forward portion of the frame member 500. The projecting member 412 secures a structural component 15 between the removable holding member 430 and cushioning member 420. The back wall 508 preferably contains a mounting barb 512 that is configured to couple to a socket 514 or a decorative frame member 444.

Also shown is an additional one of a possible plurality of fasteners 516 attaching the structural frame member 500 to a wall 210. Preferably the fasteners 516 utilizes a recess 518 to conceal the fastener head 520 so that the presence of the fastener 516 does not interfere with flush installation of the structural component 15 being secured adjacent to the structural frame member 500.

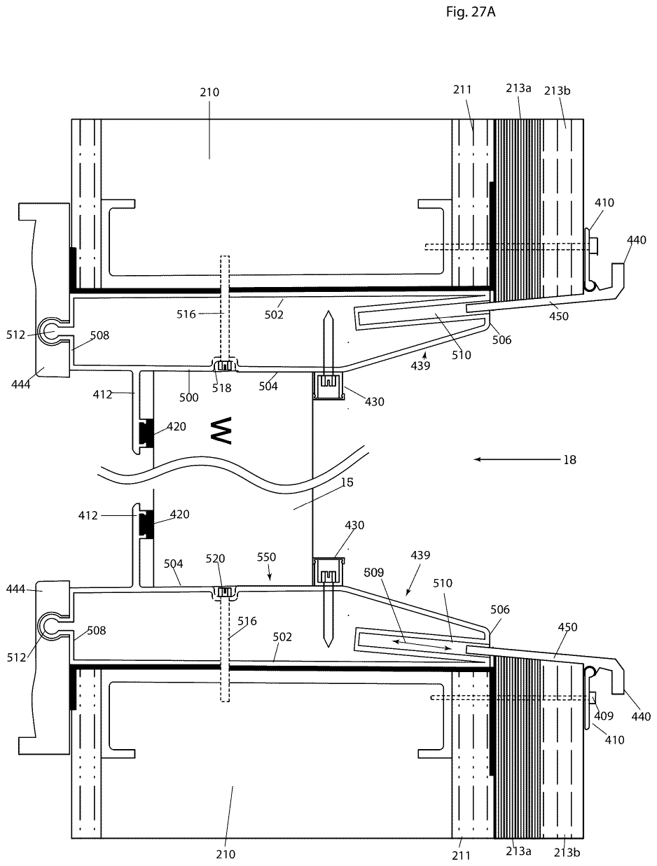

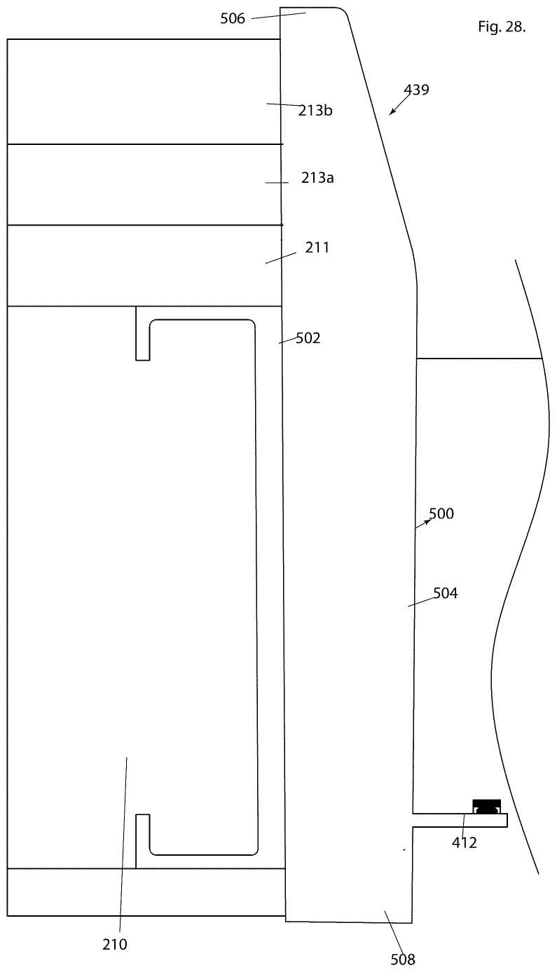

FIGS. 28-30 demonstrate various alternative embodiments of the structural frame members. The projecting member 412 may be integral with the second wall 504. The sloping portion 439 may be toward the front wall 508 or near the back wall 508.

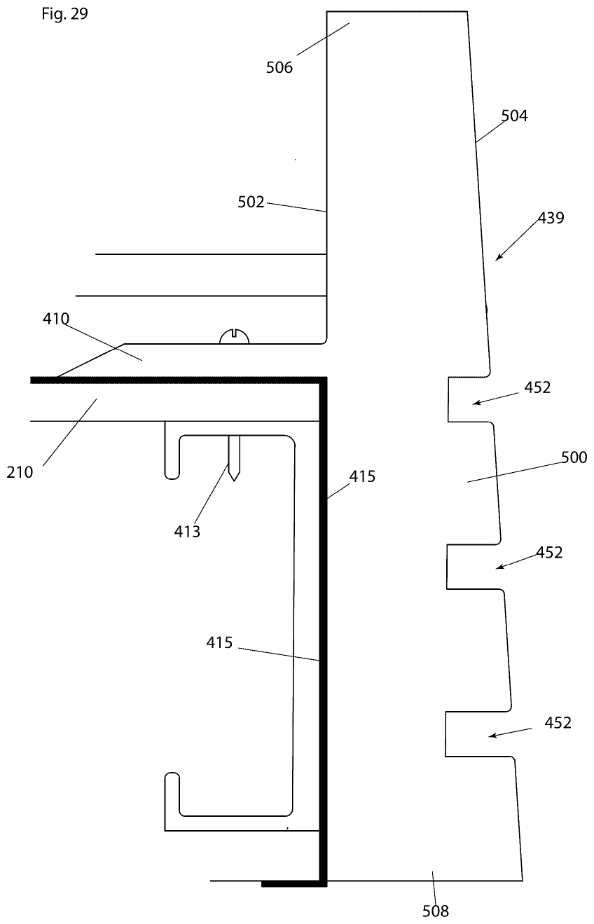

FIG. 29 demonstrates a structural frame element 500 having a sloping section 439 for the entire width of the structural frame element 500 between the front wall 506 and the back wall 508. An integral holding pin 410 secures the structural frame element 500 to the wall 210. The multiple holding slots 452 are intended for a variable placement of the projecting member 412 or the temporary holding member 430.

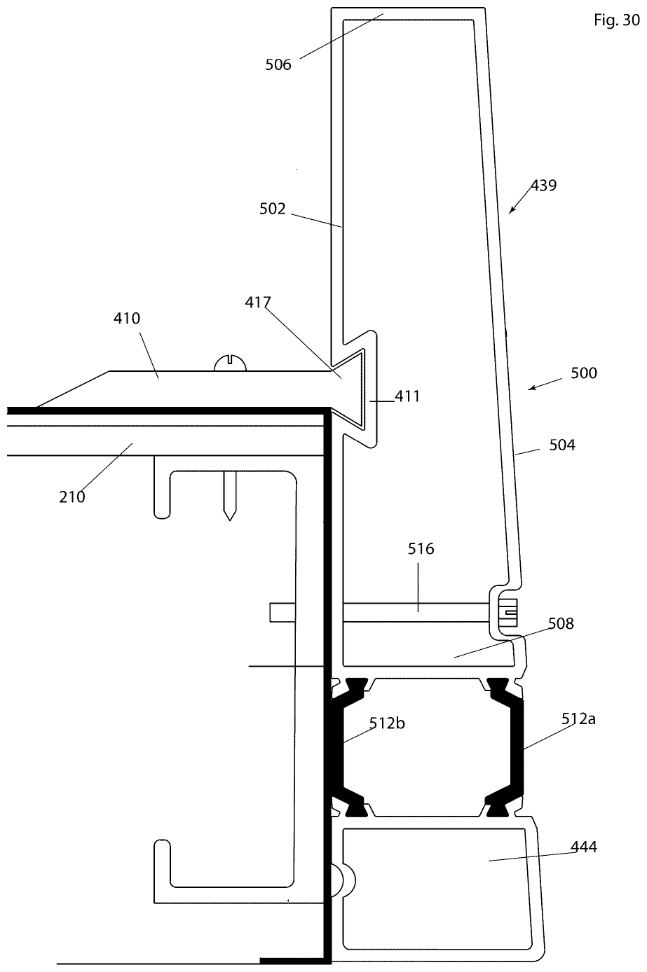

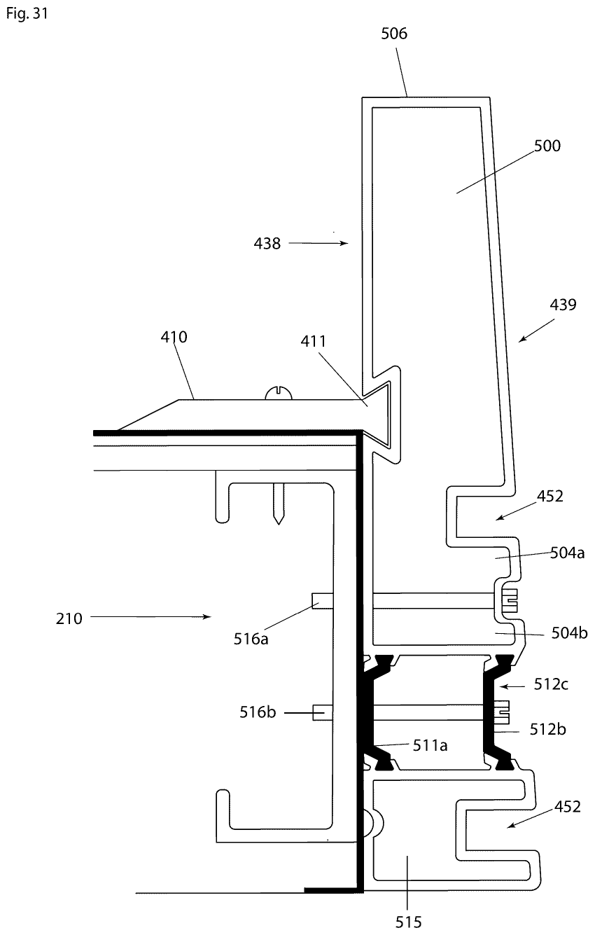

FIG. 30 demonstrates the structural frame element 500 having the front wall 506, the back wall 508, the bottom wall 502 and the top wall 504. The top wall 504 may be sloping from the front wall 506 until the back wall 508, with the back wall 508 being wider than the front wall 506. The holding pin 410 is comprised of a geometrically shaped holding portion 417, in the shape of a dovetail, within a fitting socket 411. The back wall 508 is comprised of multiple barb members 512a and 512b shown mounting an additional structural members, such as a member of a jamb or a beam . FIG. 31 demonstrates an alternative embodiment of the barb members 512a and 512b, where the barb member 512b adjacent to the structural component 15 contains the concave recess 512c that faces the structural component thus creating a recessed portion to conceal the head of the fastener 516 b. While both fasteners 516a and 516 b are shown, either one or additional fasteners may be removed or added. It is preferred that the barb members 512a and b are made of thermally isolating materials, which would impede the transfer of exterior temperature from the outer facing structural frame component 500 to the inner structural component 515. The fig further demonstrates the span 438 between the holding pin 410 and the front wall 506, with the pitch of the top wall 504 creating a back wall 508 that is wider than the front wall 506. The lower points 504a and 504b along the top wall 504 are shown as having a pitch, but may preferably be even as they face the structural member 15.

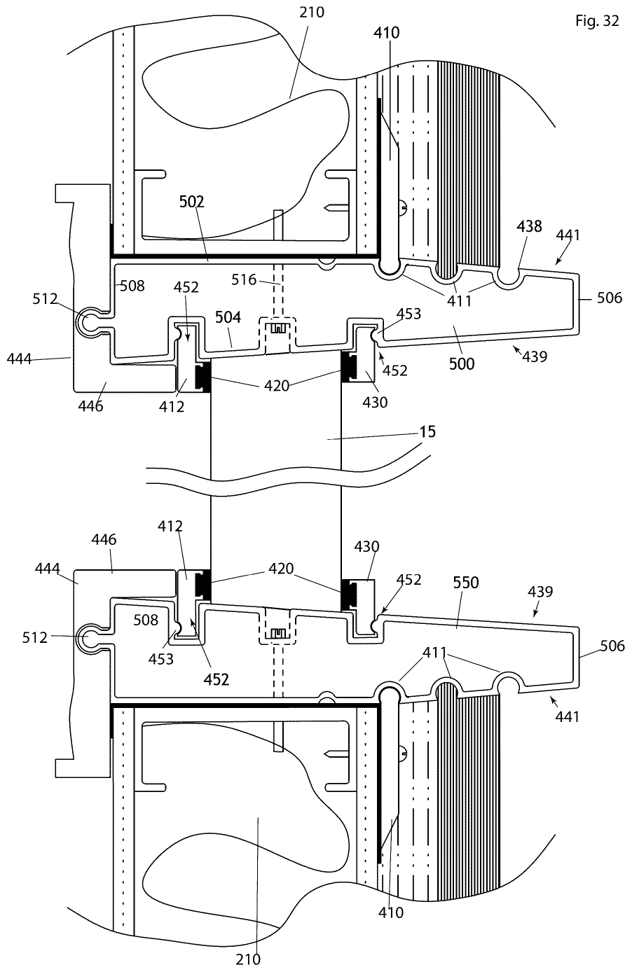

FIG. 32 demonstrates another embodiment of the structural frame component 500 having the front wall 506, the back wall 508, the bottom wall 502 and the top wall 504. The top wall 504 is sloping away from the structural component 15. Alternatively, only the front portion 439 may contain a pitch, with the section of the top wall 504 adjacent to the structural component 15 being level and parallel to the side of the structural component 15. Additionally, the span section 438 of the bottom wall 502 contains a pitched section 441, which is preferably between the existing wall 210 and the top wall 506 in the direction away from the wall 210 and toward the pitched top wall 506. Thus both the bottom wall 504 and top wall 506 contain angled sections to assist with water drainage.

Additionally shown in FIG. 32 is the alternative embodiment of the protruding member 412 and the removable holding member 430. Both the protruding member 412 and the removable holding member 430 are shown to be interchangeable or virtually identical members that are configured to secure a structural component 15 between them. The protruding member 412 and the removable holding member 430 are inserted into the holding slot 452. The holding slot 452 may additionally contain a barb 453 to lock into a groove (412b) on the protruding member 412 and the removable holding member 430. Notably, both the protruding member 412 and the removable holding member 430 both contain a cushioning element 420 that abuts the structural component 15. Thus, during installation, if the structural component 15 is being installed from the outside, the protruding member 412 is inserted first. Then the structural component 15 is then deployed into place, and then secured with the temporary securing element 430. The reverse order occurs if the structural component 15 is installed from the inside of the structure. Notably, the protruding member 412 and the removable holding member 430 appear identical and are preferably interchangeable for ease of deployment. The decorative frame element 444 mounting on the at least one mounting barb 512 may contain an angled section 446 to completely conceal the structural frame member 500 or 550 beneath the final finish.

Additionally shown in FIG. 32 the holding pin 410, or at least several holding pins 410 may be held within one of a plurality of sockets 411 along section 441 depending on the number of holding pins needed or based on the thickness of the wall 210.

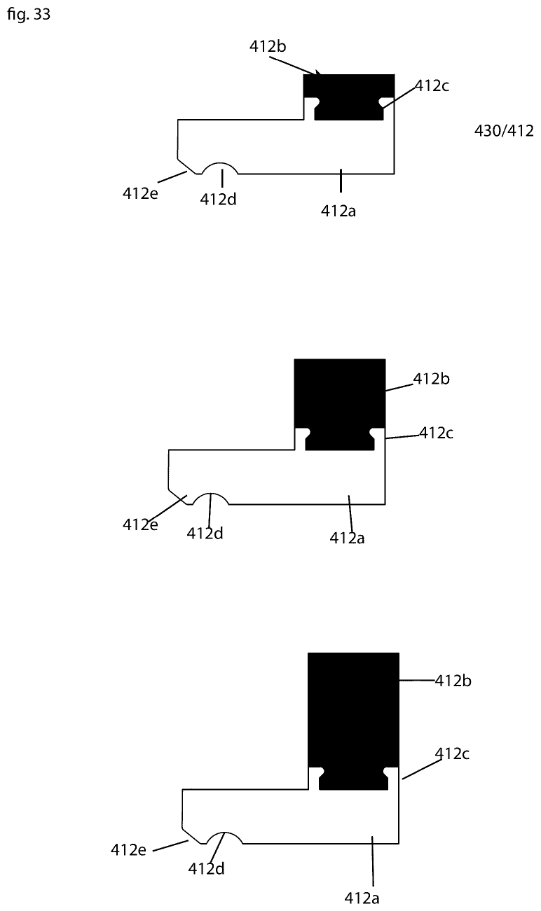

FIG. 33 demonstrates a more detailed diagram of the protruding member 412 or the removable holding member 430 having a holding portion 412a and the securing portion 412b. A setting 412c along the securing portion 412b is designed to hold the cushioning 420. The cushioning 420 may be made of hard or stiff materials as well. The cushioning 420 may be of variable thicknesses that can be interchangeable depending on the thickness of the structural component, or stated in another way, the distance between the edge (17 or 13) of the structural 15 and the holding portion 412a. The groove 412d is behind a mounting lip 412e. The holding portion 412a is locked into place when the barb 453 of the holding slot 452 enters the groove 412d.

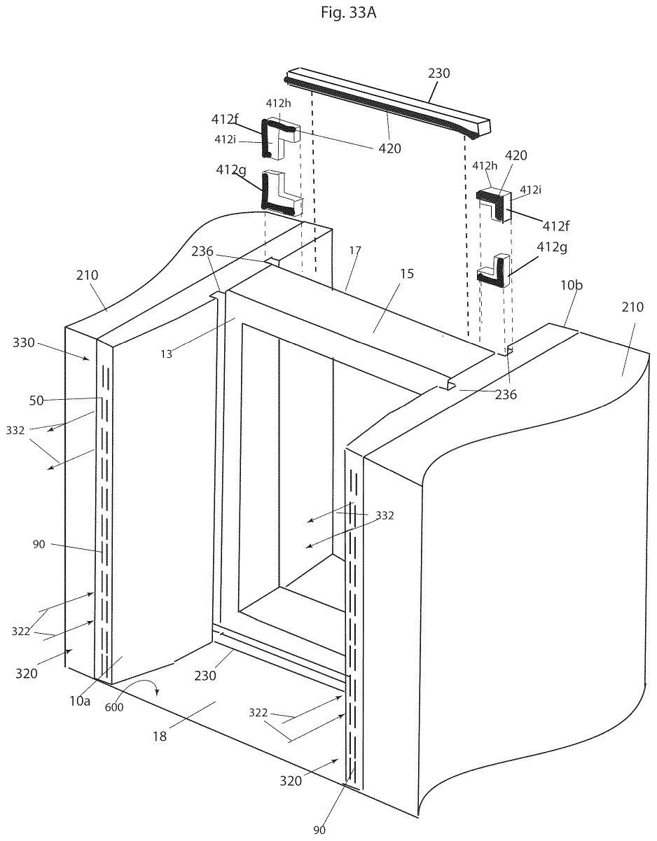

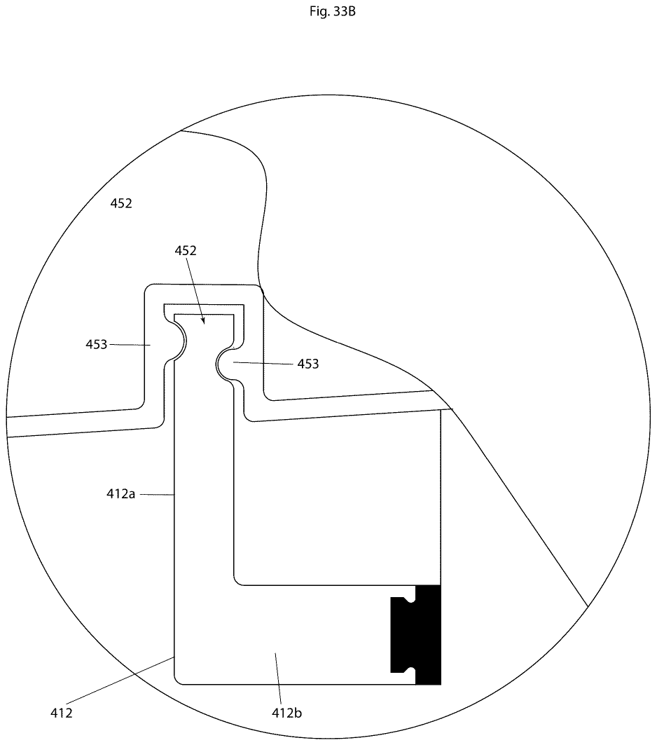

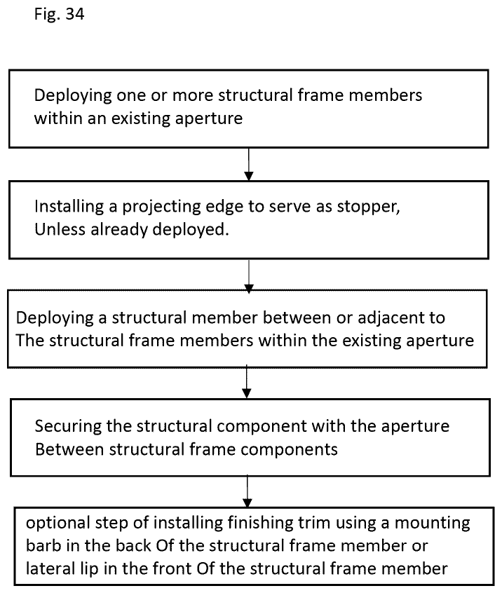

FIG. 34 details another method of practicing the disclosed structural system. Shown are the steps of deploying at least one structural component 400 or 500 within an existing aperture 18. This is followed by the step of deploying at least another of said at least one structural component 450 or 550 within an existing aperture 18. This is then followed with the step of securing the deployed structural elements with fasteners attached to the wall of the aperture. The fasteners may be the at least one holding pin 410 or fastener 516. Once the structural frame components are installed the installed would be deploying at least one projecting member 412 to serve as a stopper for a leading edge 13 of the structural component 15. Notably the projecting member 412 may be unitary with the structural frame member and already be in place, saving the step of actually deploying a projecting member. At this point the structural component 15 is inserted into the aperture 18 between the structural frame members (400, 450, 500, 550, 10a or 10b), followed by the step of securing the structural component 15 by deploying a at least one removable securing member 430 against the trailing edge 17 of the structural component 15. At this point in the installation of the structural component 15, the installer could focus on deploying the finishing trim. The installer would do so by attaching a decorative structural component 444, such as a molding using the at least one mounting barb 512 onto the back wall 508 of the structural component, or the inner end 408. Similarly, the exterior of the installation receives the lateral lip 440, which may integral with the structural frame member (400, 450, 500, 550, 10a or 10b). The lateral lip may also be attached to the structural frame member using the first wall that is sliding attached within the slot 510 within one of the embodiments or the structural frame element, or integral in other embodiments.

FIG. 33A perspective contextual diagram showing the structural member 15, which is demonstrated in FIG. 33A as a window. The at least one structural frame element 10a and another structural frame element 10b. Securing the front edge 17 of the window is the holding element 230. Shown in FIG. 33A is another embodiment of the holding elements, namely the projecting member 412. The projecting member 412 is shown as a a lower corner member 412g and an upper corner member 412 f. Each corner member 412a and 412f is installed in the corner between a structural frame member (400, 450, 500, 550, 10a or 10b) and another structural frame member (400, 450, 500, 550, 10a or 10b) that is on a perpendicular plane 600, which can also be an existing wall 210. Preferably, there is one corner member 412g or 412 f serving as corner member at each of the 4 corners of the window 15, with an additional holding element 230 fitting in between the lower corner members 412g of the structural frame members 10a and 10b, and an additional holding element 230 spanning the distance between each of the upper corner members 412f of the structural frame members 10 and 10b. Similar corner members 412g and 412 f would secure the window 15 along the front edge 13, serving as removable support members (230). Each corner member 412g or 412f is comprised of a horizontal portion 412h linked perpendicularly to a vertical portion 412i. A cushioning member 420, serving as a weather and water proofing gasket is installed along both the horizontal portion 412h and the vertical portion 412i. An additional gasket 420 is preferably deployed along the holding member 230 on the side facing the structural element 15.

FIG. 33B demonstrates a more detailed diagram of the protruding member 412 or the removable holding member 430 having a holding portion 412a and the securing portion 412b. The securing portion 412b is shown extending toward the structural element 15, which appears some distance away from the holding slot 452. The holding portion 412 may be secured using two or more barbs 453 within the holding slot 452.

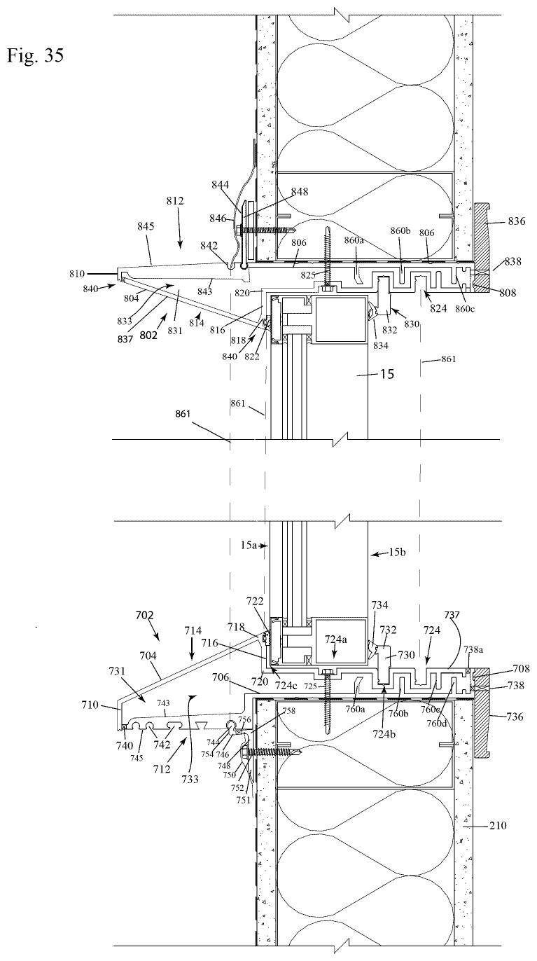

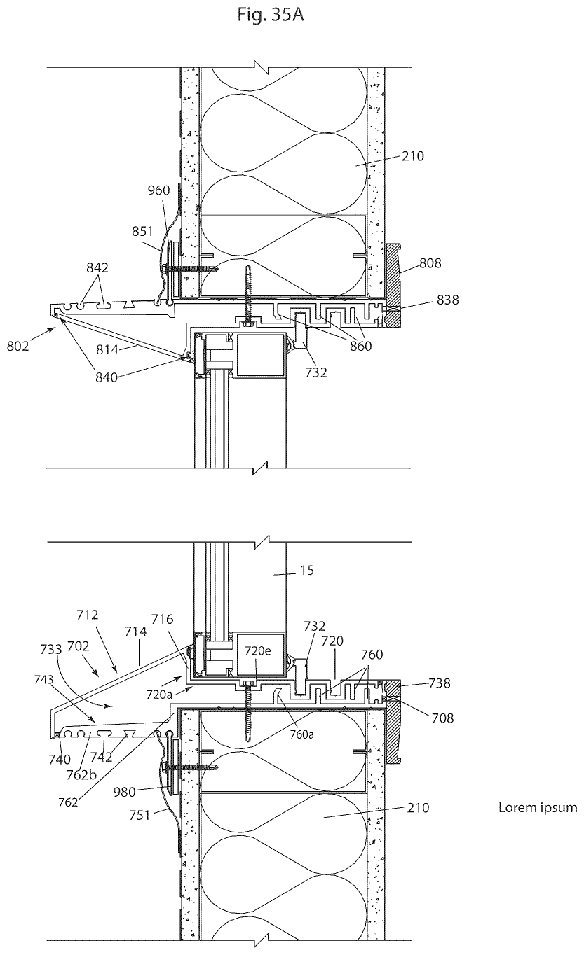

Shown in FIG. 35 is another embodiment of the disclosed securement system of a structural element 15 within an opening within an existing wall 210. Shown in FIG. 35 is a sill element 702, having a top wall 704, bottom wall 706, front wall 710 and a back wall 708 and one of the two sides 731. The top wall 704, bottom wall 706, front wall 710 and back wall 710 define the interior cavity 733.

The bottom wall 706 contains at least one retaining groove 742, located preferably toward the front section 712. The retaining grooves 742 assume a plurality of shapes, such as elliptical, circular or dovetail (trapezoidal), or any other shape. The retaining grooves 742 are configured to hold the holding portion 744 of a shroud element 848. In the embodiment shown in FIG. 35, a second type shroud 751 is shown having a holding portion 744. Extending downward from the holding portion 744 is the “A” wall 754. Extending at an angle from the free end 746 is the “B” wall 756, which extends in the direction of the existing wall 210. Extending downward from the free end 758 is the “C” wall 748. The “C” wall is then fastened to the existing wall 210 with at least one fastener or pin 752, with a weatherproof membrane 750 deployed on the outside of the “C” wall, covering the fastener 752. The shroud element 848 is intended to seal the seam between a structural frame element, such as a head element 802 or a sill element 702 and may be a sufficiently plane member, or as a second type shroud member 751, or assume a shape required by the task.

The sill element 702 preferably comprises at least one retaining part, which describes features designed to secure the structural element 15, which may be a window, door, or a wall section, such as a curtain wall. One retaining part may be comprised of a second wall 716 extending at an angle, preferably a right angle, from a free end 720 of the top wall 704. A sloped wall 714 then extends at an angle from the free end 718 of the second wall 716 towards the front wall 710. Sloped wall 714 is intended to encourage water runoff away from the structural element 15. The sloped wall may be a flat diagonal wall between free end 718 and the front wall 710 or may be concave or convex based on design or intended function. The combination of sloped wall 714 and second wall 716 creates a step 724c which secures the first edge or front edge 15a of the structural element 15.

The top wall 704 creates at least one other retaining part in the form of at least one groove 724, or grooves 724a and 724b. The grooves 724a and b are intended to secure a holding element 730, at different distances from the holding part 724c to accommodate structural elements 15 of various thicknesses. Any of the retaining grooves 724 may accommodate a pin or fastener 725. At least one inner gasket 722 and 734 cushions and seals the connection between the holding element and the structural element 15. It should be noted that while the step portion of sloped wall 714 and second wall 716 is in the front section 712 and the grooves 724 are in the rear section, these sections may be reversed in some embodiments.

Still referring to FIG. 35, the head element the parts are similar to sill element 702. Shown is the top wall 804, bottom wall 806, front wall 810 and back wall 808. The back walls 708 and 808 support attachment of an interior molding 736 or 836. The sloped wall 814 extends from the front wall 810 to the free end 818 of the second wall 816, which connects to the free end 820 of the top wall 804. The sloped wall 814 and second wall 820, form the frontal retaining part, while the groves 824 together with the holding element 832 secure the rear edge 15b of the structural element 15. Gaskets 822 and 834 provide cushioning and sealing to the retaining parts. At least one groove 824 of the head element 802 accommodates at least one pin or fasteners 825.

Also shown in FIG. 35 is one of the sides 831, with the other side being on the opposite side and visible in FIG. 35. The top wall 804, bottom wall 806, back wall 808 and front wall 810 all defining an inner cavity 833 of the head element 802.

Notably the retaining parts (816, 814, 824 830, 714, 716, 724, 730) are axially corresponding to 861 between head element 802, sill element 702, side elements (902), first side element (1002) and second side elements (1102). Axially corresponding 861 means that the retaining parts corresponds linearly across the parts-head element 802, sill element 702, side elements (902), first side element (1002) and second side elements (1102), such that holding elements 832 may be deployed across members, such as the corner holding element (420, FIG. 33A).

Still describing FIG. 35, both the head element 802 and the sill element 702, as well as the side elements 902, contain protrusions 860 (head element) and 760 (sill element). The protrusions 860 and 760 may issue at an angle from the top wall 804 or 704 or from the bottom wall 806 or 706 and are intended to interrupt the flow of sound and moisture within the interior cavity 733, 833, or (903) traveling between the front openings 840 or 740 and rear openings 838 or 738. For example, protrusion 760a is the first protrusion encountered by water traveling from the front openings 740 within the cavity 733 and is intended to keep all water captured through openings in the groove 724a or 724c towards the front section 712. The protrusions 760a, b and c, and the protrusions 860 a, b and c also act as sound barriers and as air flow interrupters, so that air from the outside is slowed and thereby reaches within range of the interior temperature.

Also shown in FIG. 35 is a rim 737 and 837 defining the side of the sill element and head element (731 and 831). It should be noted that the molding component 836 and 736 (and an analogous molding component fitting on the side elements 902), have a ventilation opening 838 and 738 that matches the ventilation opening on the back wall 808 and 708.

FIG. 35A shows the head element 802 having retaining grooves 842. The retaining grooves 842 house the shroud element 960 and the waterproof membrane 851. Shown are front openings 840 that may be located in several places along the sloped wall 814. The structural element 15 is held by the holding element 732. The protrusions 860 and 760 within the head element 802 and sill element 702 are intended to block sound and delay air flow between the front openings 840 and back openings 838 (740 and 738 of the sill element).

Still describing FIG. 35A shown is the sill element 702 having the sloped wall 737. The upper surface 743 of the bottom wall 706 is sloped in the direction of the front opening 740 to assist with channeling of water to the front openings 740. The retaining grooves 742 hold the shroud element 980 and the weatherproof membrane 751, which envelopes the shroud element and fasteners used to secure the shroud element 960, 980 (970) to prevent water penetration around the fastener openings. The third wall 762 extends downward from the bottom wall 704, with the third wall 762b comprising the area of the upper surface 743. The third and fourth walls 762 and 762b create a larger front section 712 which is configured to store a greater amount of draining liquid within the inner cavity 733. Rain water or snow would be hitting the structural element 15 or cascading down the structural element 15, and then flowing downward along the sloped wall 714. Some water may penetrate the cushioning gaskets (722), which openings 720a along the second wall 716 and 720 e of the grooves 720 b directing this flow to the interior cavity 733, to be drained to the outside through the front openings 740.

FIG. 36 is a perspective view of another embodiment of the structural element designed to be used to secure structural elements (15) within apertures of existing walls. Shown is the sill element 702, having a top wall 704, a bottom wall 706, a back wall 708, and a front wall 710. Shown in FIG. 36 are plurality of drainage holes 724d and 724e. The drainage holes 724e catch water flowing down the exterior side (15) of the structural component, and which makes it past the cushioning gaskets 722. The drainage holes 724e are located substantially near the second wall 716 and open into the interior cavity 733. The drainage holes 724e are designed to serve as drainage holes and as openings for at least one pin or fastener (725). The drainage holes 724e catch any water running past the drainage holes 724d.

The drainage holes 724e and d open into the front section 712. The front section of the bottom wall 706 begins at the free end 762a of the bottom wall 706. Extending upward, or downward, at an angle, preferably a right angle, from the bottom wall 706 is the third wall 762. Extending laterally from the fee end 762b of the third wall 762 is the fourth wall 764. The fourth wall 764 has an upper surface 743 and a bottom surface 745. The upper surface is preferably sloped towards the front openings 740, which drain water accumulating within the inner cavity 733 to the outside. The bottom surface 745 preferably has at least one retaining groove 742.

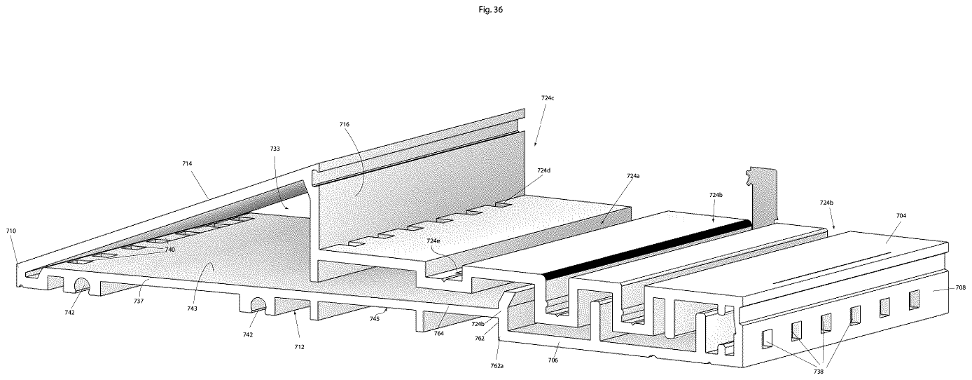

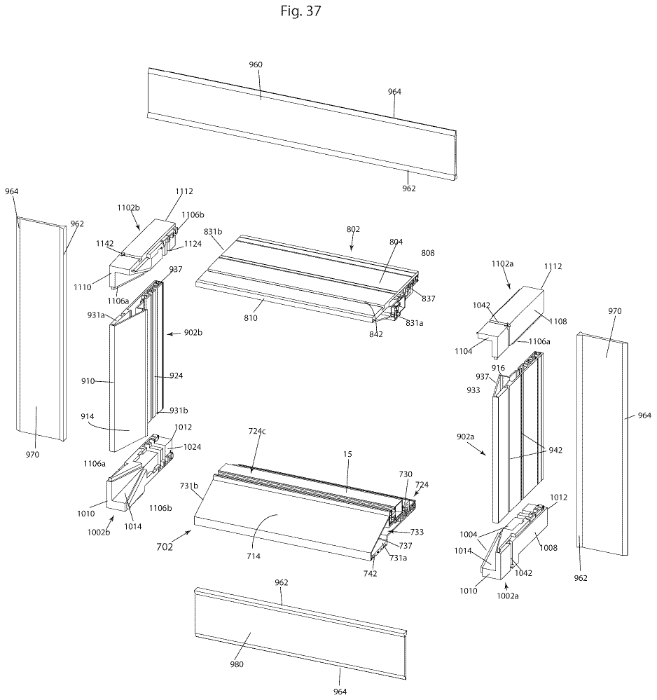

FIG. 37 is an exploded diagram of an embodiment of the disclosed securement system for securing structural elements within an opening of an existing wall. Shown is the sill element 702. At least one side element 902a or 902b is mounted at the sill element 702. With the head element 802 mounted over the side elements 902a and 902b. The attachment of side elements 902a and b to the sill element 702 and head element 802 may be direct or may be accomplished through corner elements, such as the first side elements 1002a and 1002b, and second side elements 1102a and 1102b.

The sill element 702 has two sides 731a and 731b. These sides may be open in some embodiments. The first side elements 1002a and 1002b, each have a sidewall 1008 and at least two faces 1004. Each of the at least two faces further comprise a raised surface 1006a, or 1006b. The raised surfaces 1006a and 1006b may be sculpted to correspond to the perimeter of or rim 737 of the side 731a and 731b or the side 931b of the side elements 902. Alternatively, the raised surfaces 1006a and 1006b may be sculpted in any form that would permit an entry into the airspace of the side 731a or 731b. If the raised surface 1006a is designated to be coupled with the sill element 702, then the raised surface 1006b will be coupled with one of the two side elements 902b or 902a. Or if raised surface 1006b is designated to be coupled with the sill element 702, then the raised surface 1006a will be coupled with one of the two side elements 902b or 902a.

The head element 802 has two sides 831a and 831b. These sides may be open in some embodiments. The second side elements 1102a and 1102b, each have a sidewall 1108 and at least two faces 1104. Each of the at least two faces further comprise a raised surface 1106a, or 1106b. The raised surfaces 1106a and 1106b may be sculpted to correspond to the perimeter of or rim 837 of the side 831a and 831b or the rim 937 of the side 931a of the side elements 902. Alternatively, the raised surfaces 1106a and 1106b may be sculpted in any form that would permit an entry into the airspace of the side 831a or 831b. If the raised surface 1106a is designated to be coupled with the head element 802, then the raised surface 1106b will be coupled with one of the two side elements 902b or 902a. Or if raised surface 1102b is designated to be coupled with the head element 802, then the raised surface 1106a will be coupled with one of the two side elements 902b or 902a.

The at least one retaining groove 842 on the head element 802, 1142 on the second side element 1102a and 1102b, 1042 on the first side elements 1002a and 1002b and 742 on the sill element 702 is preferably axially corresponding. Meaning that the retaining grooves along the elements of the disclosed securement system linearly correspond to each other.

The retaining groove 842 of the head element 802 and the retaining groove 1142 of the second side element 1102a and 1102b receive the holding portion 962 of the head shroud element 960. The retaining groove 942 of the two side elements 902a and 902b and the retaining groove 1042 of the first side element 1002a and 1002b receive the holding portion 962 of the side shroud elements 970. And the retaining groove 742 of the sill element 702 and the retaining groove 1042 of the first side element 1002a and 1002b receive the holding portion 962 of the bottom shroud element 980. The shroud elements 960, 970 and 980 may be interchangeable or may be shaped differently based on function, such as the second type shroud (758).

The side elements 902 a and 902 b contain grooves 924 which form retaining parts. These grooves 924 are in an axially corresponding orientation or relation to the grooves 1124 of the second head elements 1102a and 1102b, with the grooves 824 of the head element 802, with the grooves 1024 of the first side elements 1002a and 1002b and with the grooves 724 of the sill element 702. The retaining parts formed by the sloped and second walls (714 and 716, 814 and 816, and 914 and 916) are also in an axially corresponding relationship across all elements. The sill element demonstrates the securement of the bottom portion of a structural element 15 between securing part 724c (formed by the nexus of the sloped wall 714 and second wall 716) and the holding element 730. The shroud elements 960, 970 and 980 preferably contain the holding portion 962, which is inserted into and corresponds to the shape of the retaining groove 742, 842, 942, 1041 and 1142. The other edge 964 of the shroud element, 960, 970 and 980, preferably contain a gasket for a more uniform adhesion to an existing wall (210).

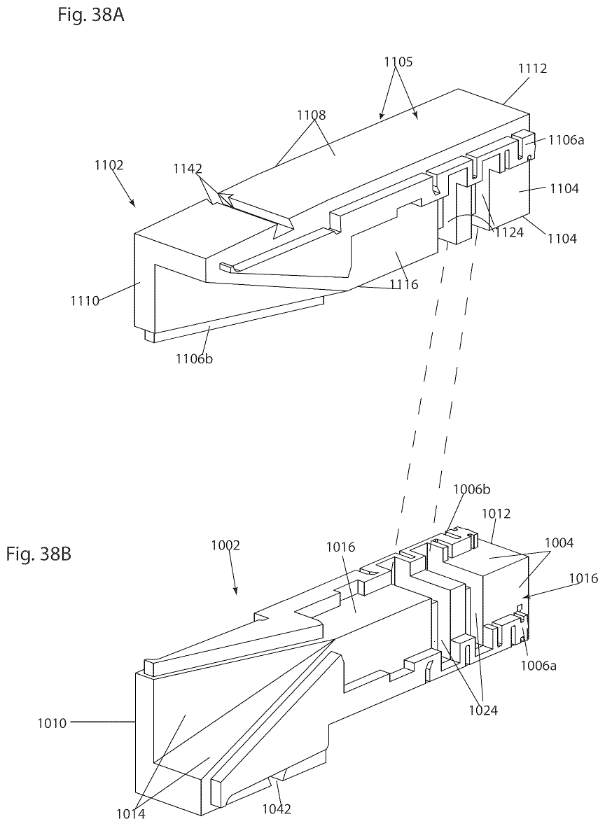

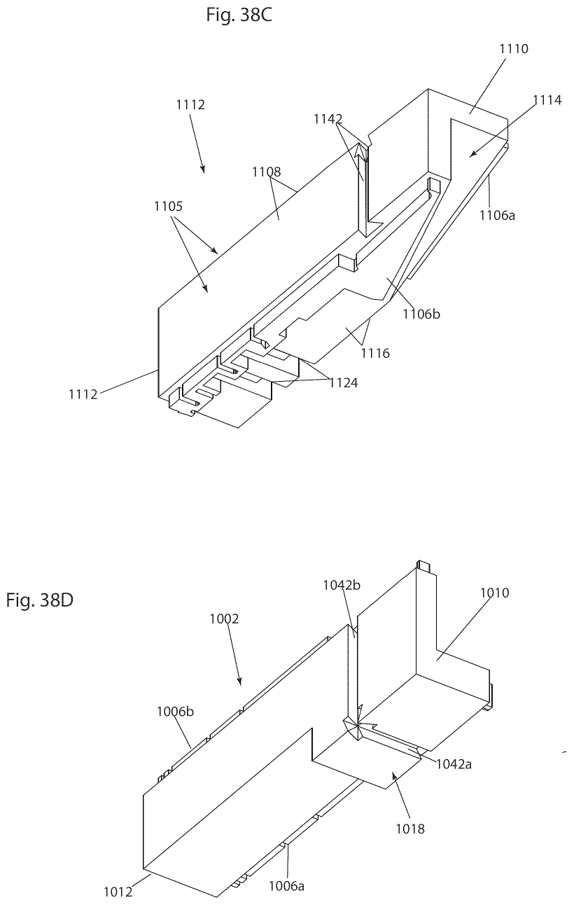

FIGS. 38A, 38B, 38C and 38d are a further closeup of the first side element 1002 and the second side element 1102. Both of the components shown preferably have a mirror image component as shown in FIG. 37 (1102a and 1002a). Shown for the first side element 1002 is the sidewall 1008, at least two faces 1004, protrusions 1006a and 1006b, at least one groove 1024, which is part of the retaining parts of the disclosed securement system, the front wall 1010 and the back wall 1012. Also shown is the recessed corner intended to create uniformity between the sloped walls (714, 814, 914) of the sill, head and side elements (702, 802, 902). Shown for the second side element 1102 is the sidewall 1108, at least two faces 1104, protrusions 1106a and 1106b, at least one groove 1124, which is part of the retaining parts of the disclosed securement system, the front wall 1110 and the back wall 1112. Also shown is the recessed corner 1114 and 1014 intended to create uniformity between the sloped walls (714, 814, 914) of the sill, head and side elements (702, 802, 902).

The grooves 1124 and 1024 are preferably in an axial alignment 861, to accommodate a holding element that is secured across the sill and side elements 702 and 902, or across head and side element 802 and 902, such as a holding element shown in FIG. 35 as components 412 g and 412 f. Each corner member 412g or 412 f is comprised of a horizontal portion 412h linked perpendicularly to a vertical portion 412i.

The protruding sections 1006b and 1106b would be secured to either side (931a and 931b) of the side element (930a or 930b). The protruding portions 1106a would be secured to either side (831a or 831b) of the head element 802 and the protruding portions 1006 would be secured to either side (731a and 731b) of sill element (702). The recessed portion 1016 and 1116 then abuts the rim (737, 837, 937), which seals the internal cavity (733, 833 or 933). The retaining groove 1142 and 1042 is shown in a dovetail socket configuration, but may be a cubical, electrical or triangular, or in any other shape.

The first and second side elements 1002 and 1102 contain at least two faces 1004 and 1104. The non-facial sides 1005 and 1105 of the sidewall 1008 and 1108 complement the corner sections of the perimeter formed by the disclosed securement system. In another embodiment, the first and second side elements 1002 and 1102 may have additional faces 1004. The retaining groove 1042 and 1142 is shown wrapping around the non-facial sides 1005 and 1105 of the first and second side elements 1002 and 1102. Notably while sill and head element 702 and 803 are shown with ability to ventilate interior spaces using front and back openings (740, 738, 840, 838), it is preferably that side elements 902 contains front and back openings that are in air communication through the interior cavity 933 of the side elements 902.

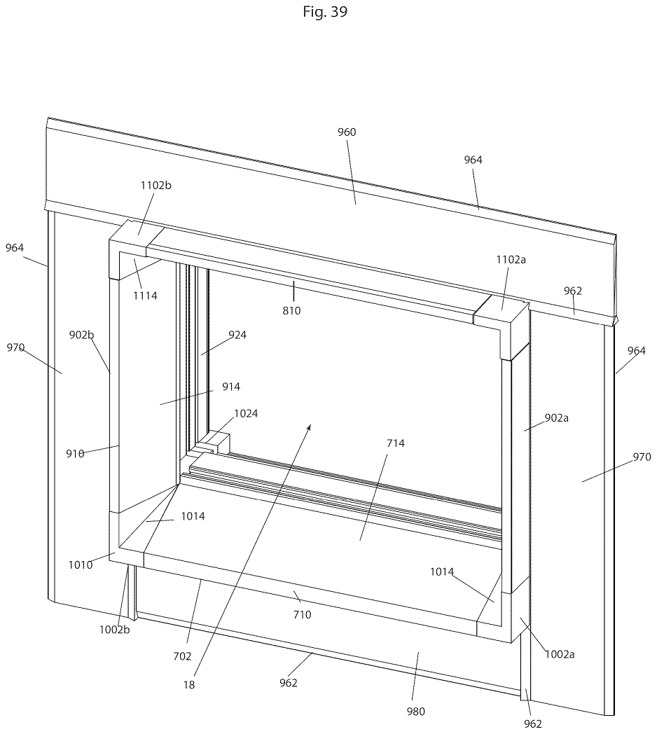

FIG. 39 shows the assembled preferred embodiment of the securement system for securing structural elements within an opening of an existing wall, comprising a sill element. Shown is the sill element 702 having two side elements 902a and 902b mounted on either side of the existing opening 18, with the head element 802 mounting above the sill element 702 and side elements 902a and 902b. The first side elements 1002a and 1002b and second side elements 1102a and 1102b are shown linking the sill, side and head elements 710, 810 and 910. The front walls 910, 1010, 1110, 710 and 810 preferably form a uniform and flush perimeter all around the securement system. The sloped surfaces 914, 714 and 814 form a uniform tapered view into the existing opening 18, while also serving as a retaining part by securing a structural element (15) in a uniform and whether proof manner all around the perimeter of the opening 18. The point of nexus between the edge 962 of the shroud 960, and the side shrouds 970, and the nexus between edge 962 of the side shrouds 970 and the bottom shroud 980 are preferably flush and do not contain any gap.

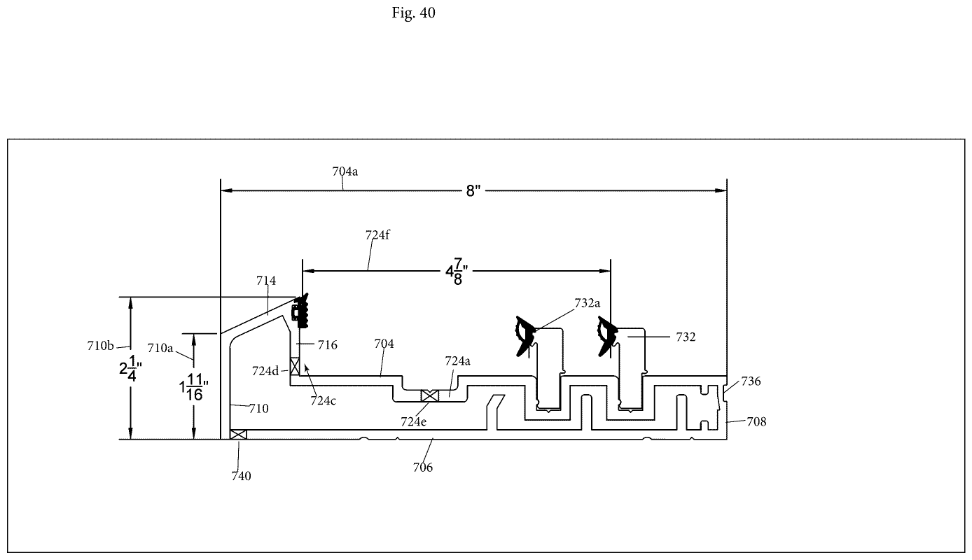

FIG. 40 demonstrates an alternative embodiment of the disclosed securement system. Disclosed is the sill element 702, although the same components are shared, and would indeed be nearly identical with the sill element 802 or side element 902. Shown is the top wall 704, bottom wall 706, back wall 708, or the front wall 710, the sloped wall 714 and the second wall 716. The front section 712 is smaller, with the front opening 740 adjacent to the front wall 710. The draining holes 724d are on the second wall 716 and the draining holes 724e. The sizes shown are approximate and are in the range. The overall length 704 a of the sill member 702 may be between 15 and 35 cm. The height 710 a of the front wall 710 may be in the range of 1.5 and 4 cm, with the overall height 702 b of the front section 712 between 2.5 and 6 cm. the width of structural elements 15 secured between the forward retaining part 724f and the rearmost holding element 732 b may be between 7 and 15 cm. All such sizes are general approximations, and other or different sizes may be possible.

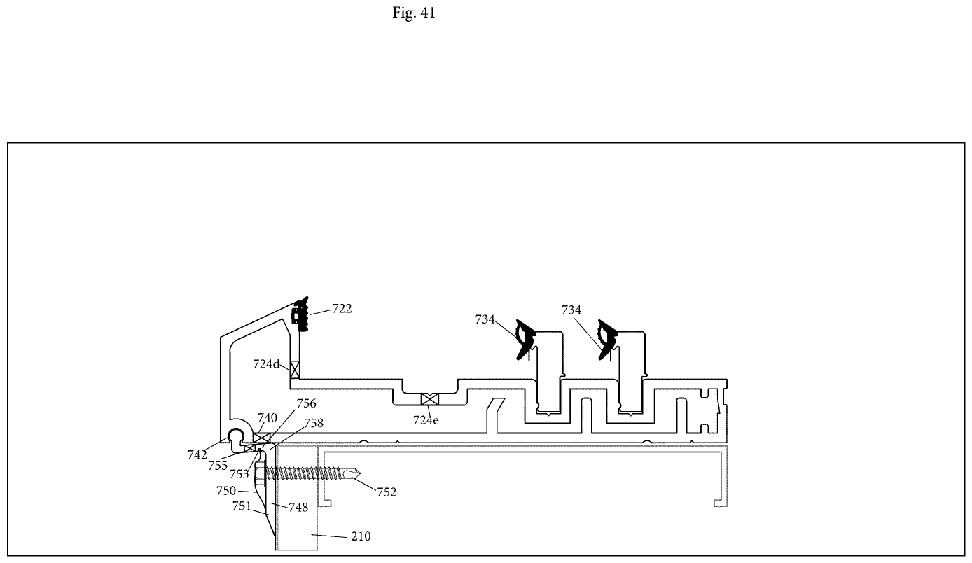

FIG. 41 demonstrates the alternative embodiment of the sill member 702. It should be noted that the sill element 702 represents similarly shaped head element 802 and side elements 902. FIG. 41 demonstrates the type two shroud 751, described in FIG. 35 above. In the embodiment shown in FIG. 41, the front opening 740 is preferably located aft of the retaining groove 742. The retaining groove is shown substantially adjacent to the front wall 710. Water draining out of the front openings 740 will then drain through the openings 755 on the “B” wall 756. The free end 758 of the “B” wall 756 is biased to substantially abut the bottom wall 706, thus preventing water from seeping in between the “C” wall 748 and the existing wall 210. Recessed groove 573 is then preferably located along the “B” wall 756 between the opening 755 and the free end 758. The recessed grove 753 houses one edge of the waterproof membrane 750, which among other things, prevents any water running down the “C” wall 748 from entering an opening used by the pin or fastener 752. The cushioned gaskets 722 and 734 appearing as a single band, may contain additional or longer bands.

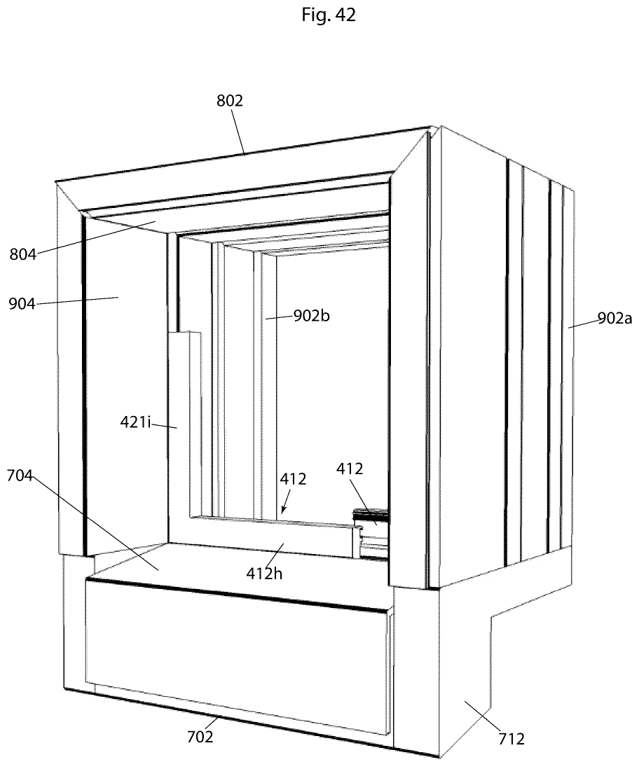

FIG. 42 demonstrates another embodiment of the securement system. Shown is the sill element 702, the at least one side element 902a and 902b being disposed on the top and side of the sill element 702 and the head element 802 being on top and side of the side elements 902a and 902b. The retaining part for both front and back edges of a structural element (15) are angled holding elements 412g and 412 h, each having a horizontal part 412j and vertical part 412i. Notably, the horizontal part 412i and vertical parts 412j may each serve as vertical or horizontal parts. Also noted that the holding element 412, while shown only partially covering the axially corresponding retaining part across the sill element 702 and side elements 902a and 902b, may completely or partially surround the perimeter of each retaining part.

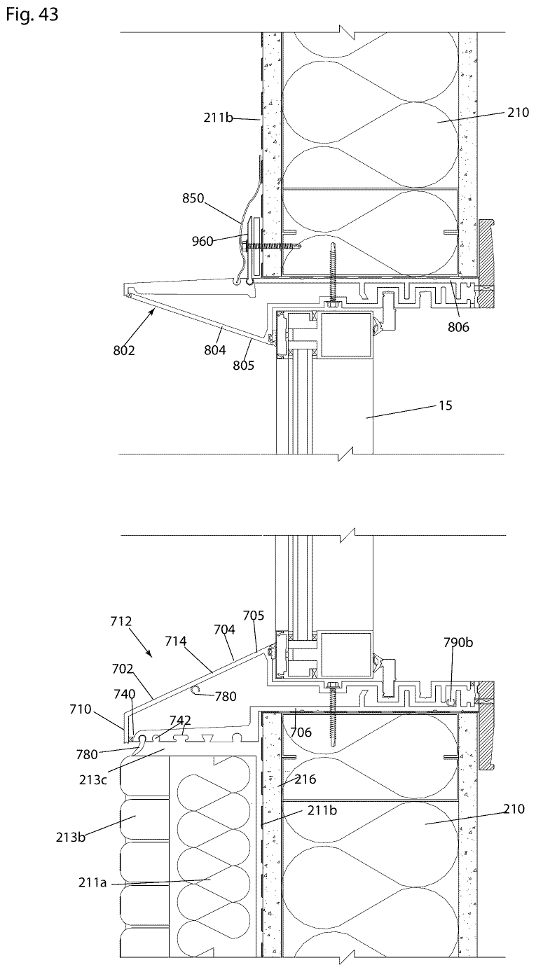

In the embodiment of the disclosed securement system shown in FIG. 43, the head element 802 comprises one retaining groove 842 along its bottom wall 806 having a shroud element 960. The sill element 702 is shown installed above a layer of exterior insulation 211a and cladding 213b. The layer 213b may also be masonry or siding. To prevent moisture from entering the gap 213c between the bottom wall 706 and the cladding layer 213b the retaining groove 732 of the sill element 702 preferably includes an insulating gasket 780. While the sill element 702 does not show a separate shroud element (980), and the head element 802 does not show a separate insulating gasket on the head element, both the shroud elements (960 or 980) can be present together with the insulating gasket 780 and augment each other's water and weather insulating qualities. Additionally, the waterproof membrane 850 and the membrane 211b of the existing wall 210 augment each other's waterproof qualities. Shown also is another embodiment of first side element shown as a flat cover (1030) affixed at sockets 290a and 290b, which are substantially to the rim 705 of the sill element and may additionally be placed anywhere along the interior cavity (733).

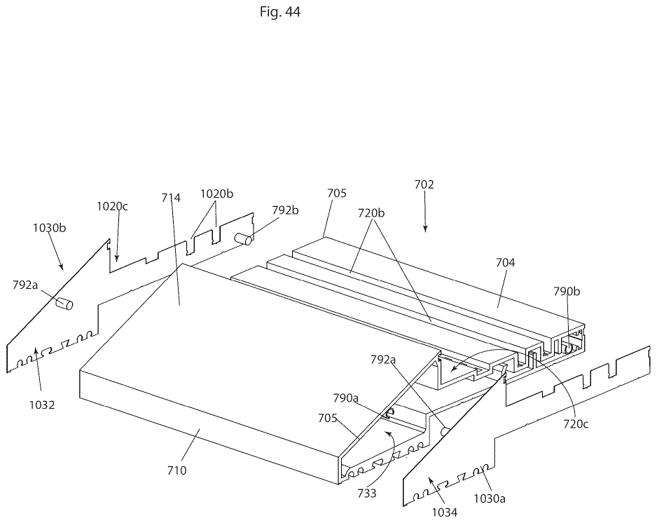

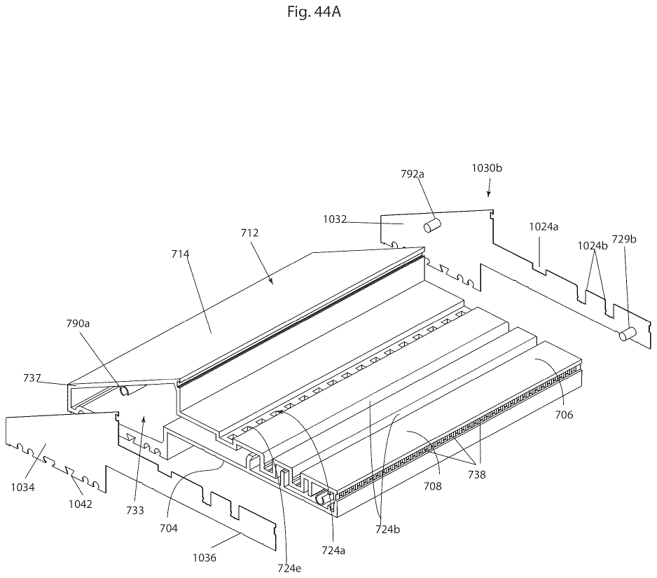

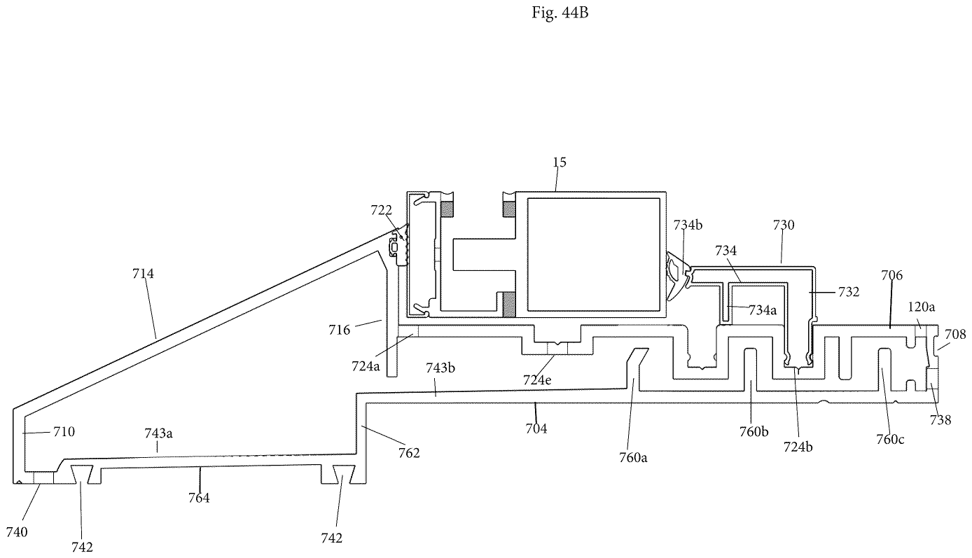

FIG. 44 further elaborates on another alternative embodiment of the securement system demonstrating the sill element 702. It should be noted that the sill element 702 and the cover first side elements 1030a and 1030b as shown may instead be described as the head element (802) and second side elements shaped as covers. The cover first side elements 1030a and “b” are intended to seal the interior cavity 733 and are shown having an exterior surface 1034 and an interior surface 1032. A peg, pin or fastener 792, which extends from the interior surface 1032, which may also enter through the exterior surface 1034, is secured within the lugs or sockets 790a and 790b. The cover first side elements 1030a and 1030b are preferably sculpted to correspond to the rim 705 of the sill element 702 with the slots 1020b and 1020c axially corresponding or matching to the grooves 720b and the front retaining part 720c.

FIG. 44A demonstrates the back perspective view of the embodiment of the sill element 702 shown in FIG. 44. Shown is the sloped wall 714 of the front section 712. Having sides 731a and b. The sides 731a and b are defined by the rim 737. The cover first slide elements 1030b and 1030a contain an edge 1036 that is preferably sculped to correspond to the rim 737, thereby completely sealing the cavity 733. Also shown in FIG. 44A are lugs 790a for connectors 792a and 792b, bottom wall 704, top wall 708, grooves 724a and 724b and openings for water drainage or to accept a pin of fastener 724e.

FIG. 44B demonstrates another embodiment of the sill element 702. Showing the sloped wall 714, the second wall 716, the top wall 704 the back wall 708, the bottom wall 706 and the front wall 710. The section of the bottom wall 704 which is forward of the protrusion 760a consists of a top surface 743b, which is sloped toward the third wall 762, the upper surface 743 of the third wall 764 is preferably sloping toward the front openings 740. At least one retaining groove 742 is set along the bottom surface 745. The holding element 730 is shown with a lengthened securement portion 734, whose holding portion is held in the after groove 724b. The securement portion 734 contains a support arm 734a and cushioned securement element 734b abutting the back edge of the securement element 15. The opposite edge of the structural element 15 is held by the cushioning elements 722. The water may be caught and drained away by the sloped surface 714 and openings 724a and 724e that lead to the outer openings 740. The back opening 738 may be selectively opened and closed through a lever inserted through opening 120a.

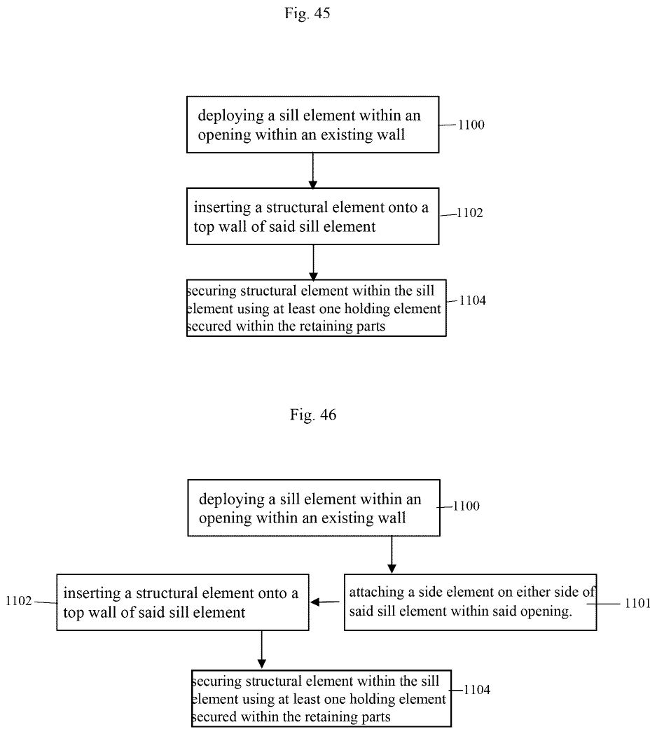

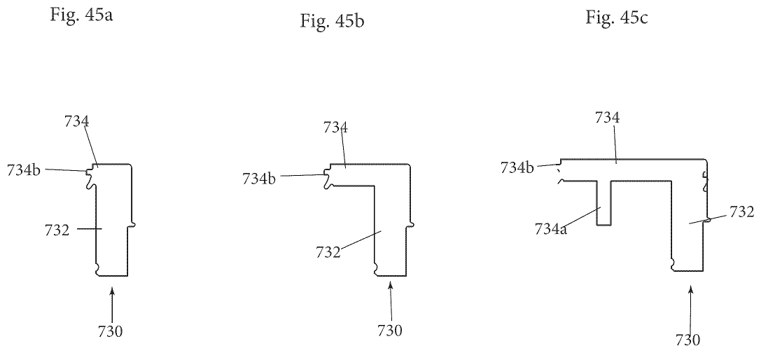

FIGS. 45a-45c demonstrate the various holding elements 730, which may also be represented by numerals 830 with respect to the head element (802) or angle elements (220) or (412). Each holding element is comprised of a holding portion 732 (832) configured to be held within a groove 724 (824). Extending laterally from said holding portion 732 is a securing portion 734 which secures the rear edge 15b of the structural element 15. The securing portion 734 (834) may be of variable length depending on the thickness of the structural element, the distance of a groove 724 (824) from the rear edge 15b or depending on both of these factors. In some instances, the length of securing portion 734 requires additional support with a supplemental leg 734a. Preferably the free end of the securing portion 734 further comprises a cushioned gasket 734b. It should be noted that although either the horizontal or vertical portions of the holding element 730 is shown, the same components would be applicable to any additional horizontal or vertical portions extending from such holding portion 732.

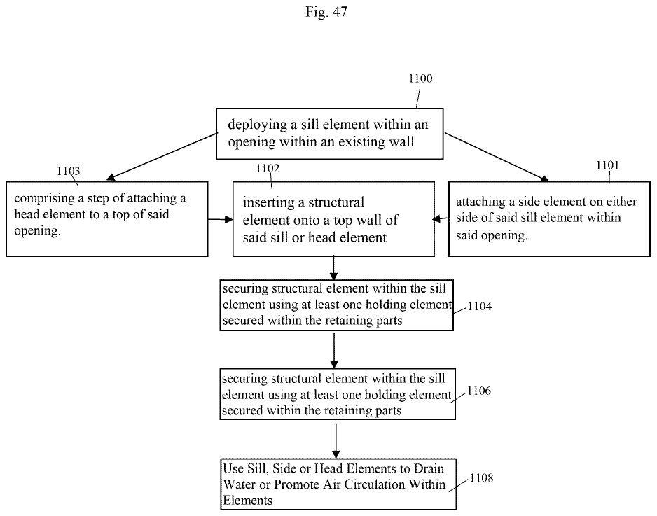

FIGS. 45-47 diagram the method of securing structural elements within an opening of an existing wall using the disclosed securement system, beginning initially with the step of comprising deploying a sill element within an opening within an existing wall 1100. The sill element 702 utilizes its retaining parts which, after inserting the structural element 15 onto the top wall 704 of the sill element 702 in step 1102, are then used to secure the structural element 15 on the sill element using at least one holding element 730 inserted into the retaining parts in step 1104. The disclosed method augmented further with a step of attaching a side element 902a and 902b on either side of the sill element 702 within the opening 18. Additionally, either on independently, or as a sequel to step 1104, the step of attaching a head element to a top of said opening 1101 can secure the structural element 15 to the head element within the opening, or between the head element 802 and the sill element. Preferably however, the step 1100 of deploying a sill element 702 is then followed by deploying side elements 902 (either directly on top of the sill element 702, or by first deploying first side elements 1002), with the head element 802 on top of the side elements 902 in step 1103. This is then followed by the step of securing the structural element 15 with holding elements 730 in step 1104. Step 1104 may occur prior to or subsequent to step 1106 of deploying shrouds around the head, side and sill elements (802, 902, 702). As a final step, which is not strictly necessary, but presents a major improvement provided by the disclosed securement system in comparison to the available art, the securement system can then, in step 1108, be used to admit a flow of water runoff and to channel this runoff through interior cavity to the exterior, or along the sill elements so that the water flow does not penetrate to the existing wall.

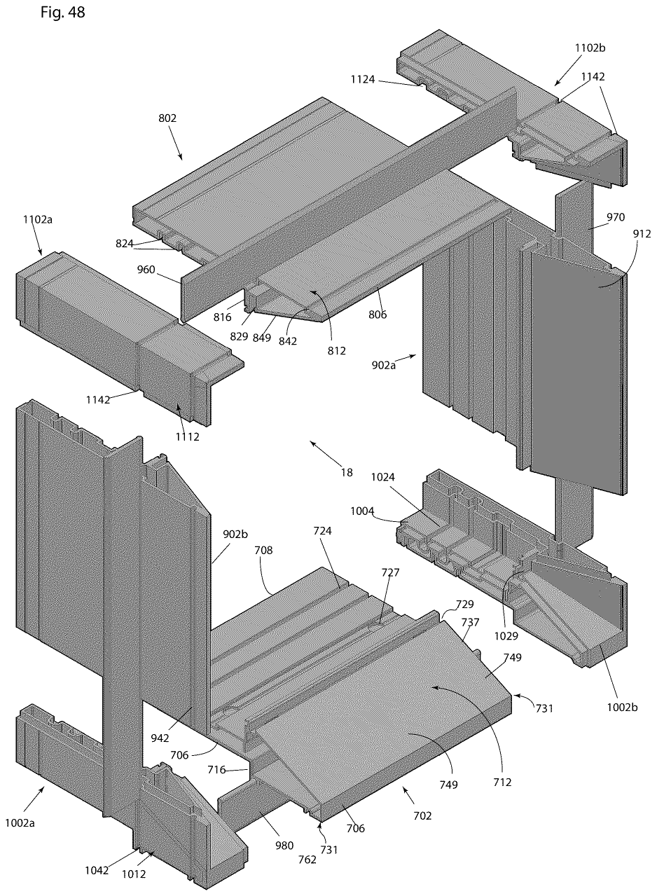

FIG. 48 is an exploded diagram of an additional embodiment of the disclosed device. Shown in FIG. 48 is one embodiment of the system for securing structural elements within an opening 18 of an existing wall (210). Visible is the sill element 702, the head element 802, the first side elements 1002a and 1002b, the side elements 902a and 902b, and second side elements 1102a and 1102b. In the embodiment shown, the faces 1004 of the first side elements 1002a and 1002b are co-axial with the top wall 704 of the sill element 702, and the top wall 904 of the side elements, creating single uniform aperture 18. The sill element 702 has two sides 731 that are parallel to each other and each is defined by a rim 737. The sill element contains the front section 712. The front section 712 begins with the retaining wall 716 extending from a free end the top wall 704, and a third wall 762 which extends from the bottom wall 706. The connecting wall 749, also referred to as sloped wall 714 in other embodiments, connects the retaining wall 716 with the front wall 702, and is intersected by an auxiliary groove 729.

Also shown in FIG. 48 is a sill element 702 having a front portion 712 and at least one retaining groove 724. One or more of the retaining grooves 714 may contain an enlarged opening 727 to allow the passage of a fastener through the top wall 704. The enlarged opening 727 doubles as at least one drainage hole.

Shown along the connecting wall 749. Connecting the front wall 702 and the retaining wall 716. The auxiliary groove 729 is disposed horizontally across the connecting wall 749. The auxiliary groove 729 of the sill element 702 is co-axial with and connects in communication with the auxiliary groove 929 of the side elements 902a and 902b at the auxiliary corner groove 1029 of the first side elements 1002a and 1002b.

The auxiliary groove 729 of the sill element 702 is co-axial with the auxiliary groove 829 of the head element 802. The auxiliary groove 829 of head element 802 is situated horizontally across the width of the connecting wall 849 of the head element. The auxiliary groove 829 connects with and is co-axial with the auxiliary grooves 929 of the side elements through the corner auxiliary grooves 1129 of the second side elements 1102a and 1102b.

The retaining groove 842 of the head element 802 is co-axial with retaining grooves 1142 of the second side element 1102a and 1102b and retain the insulating shroud 960. The side insulating shrouds 970 are mounted within the retaining slots 942 that are coaxial with retaining grooves 1142 of the second side element 1102a and 1102b. The lower insulating shroud 980 is retained within the retaining slots 742 of the sill element 702, which connect to and communicate directly with the retaining grooves 1042 of the first side elements 1002a and 1002b.

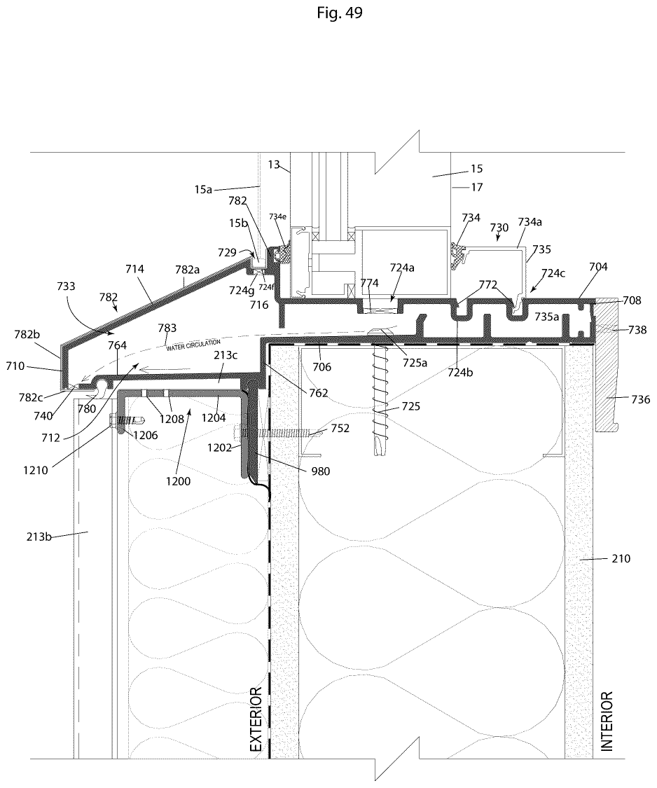

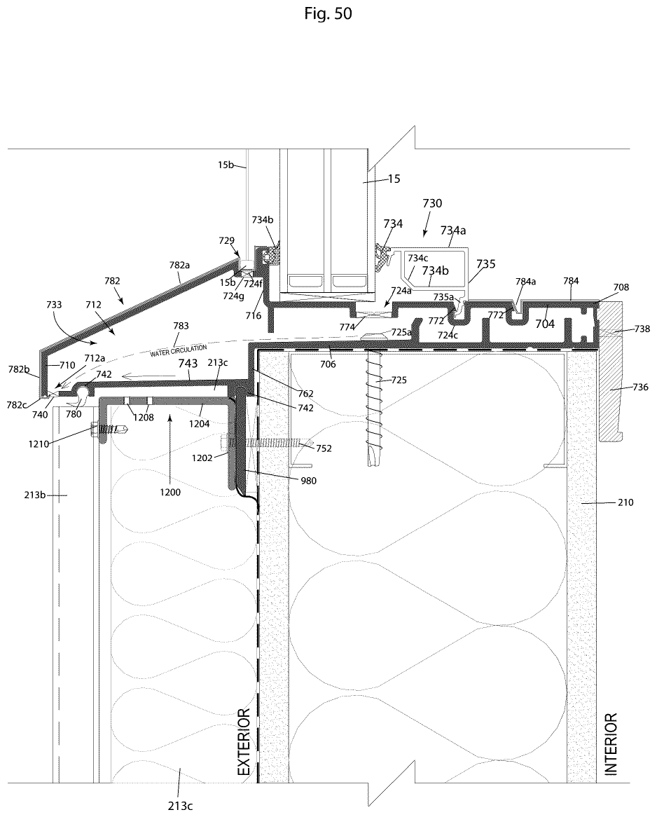

FIGS. 49 and 50 disclose another embodiment of the sill element 702. Shown are the top wall 704, the holding element 730, having a horizontal support arm 734a connecting with a vertical support arm 735. The horizontal support arm 734a and vertical support arm 735 preferably extend the entire width of the top wall 704 between sides 731 or side elements 902a and 902b. A cushioned gasket 734 abuts the back edge 17 of the structural element 15, securing the structural element 15 between the holding element 730 and the retaining wall 716. The vertical support arm 735 contains a detent arm 724c that snaps beneath the barb 772 within one of the retaining grooves 724 (724b).

In FIG. 50, a narrower structural element 15 is demonstrating, containing an alternative embodiment of the holding element 730, having a top horizontal support arm 734a and a bottom horizontal support arm 734b, which both connect substantially perpendicularly with the vertical support arm 735. The bottom horizontal support arm 734b provides additional strength since it connects to or braces the top horizontal support arm 734a and vertical support arm 735. The detent arm 724c may extend from the bottom end of the vertical support arm 735 of from the corner 734c of the bottom support arm 734b.

Still referring to FIGS. 49 and 50, at least one retaining groove 724, in this case 724a is widened, at least one location, or throughout the width of the top wall 704, and contains at least one opening 774 which allows the fastener head 725a to pass through and be tightened against the surface of the bottom wall 706, thus reducing the tension strain of on the top wall 704 when securing the sill element 702 to the existing wall 210.

The forward edge 13 of the structural element 15 is secured against the regaining wall 716 (also referred to as the second wall 716) with the gasket 734e snaped within the socket 782. On the other side of the socket 782 that is part of the retaining wall 716 is the auxiliary groove 729 holding the frame portion 15b of the auxiliary structural element 15a. It should be noted that the structural element 15 is most often a window or a door element, and the auxiliary structural element 15a is a screen element.

The auxiliary groove 729 is part of the connecting wall 714, which connects the retaining wall 716 with the front wall 710. The front wall is connected to the fourth wall 764, which together with the third wall 762 forms the front portion 712 of the bottom wall 706.

The auxiliary groove 729 preferably contains a drainage hole 724g, which allows water running down from the auxiliary support element 15a to be channeled into the cavity 733, which is defined by the top wall 704, the bottom wall 706, the back wall 708 and the front wall 710. The water is then drained along the fourth wall 764 out of the drainage opening 740 in the fourth wall 764 (bottom wall 706).

Shown in FIGS. 49 and 50 is the first exterior plate 782, having the first section 782a covering the connecting wall 714, the second section 782b coving the front wall 710 and the third section 782c covering the fourth wall 764. The first exterior plate 782 conforming to the shape of the connecting wall 714, front wall 710 and bottom wall 706 (fourth wall 764) and preferably extending for the entire width of the sill element 702. The first exterior plate coupling to the front portion 710 with a protruding section 724f snugly conforming to the contours of the auxiliary groove 729. The protruding section 724 f having openings matching the drainage holes 724g, and the third section 782 c matching openings of the drainage openings 740. Some of the purposes of the first exterior plate 782 is to provide an additional insulation, shield the components of the disclosed securement system for weather wear, and provide a desired exterior finish and color.

FIG. 50 further discloses the second exterior plate 784 covering the surface of the top wall 704 and extending the entire width of the top wall 704, as well as the length of the top wall 704 between the vertical support arm 735 and interior molting 736. The exterior plate 784 is held in place with at least one protrusion 784a which is designed to correspond to and fit snugly in the retaining grooves 784. It should be noted that the protrusion 784a of the second exterior plate 784 shown is shown to be stamped from one side to assume the protrusion on the other side of the second exterior plate 784. Alternatively, the surface of the second exterior plate 784 may be substantially plane and uniform, with the protrusion 784 being only on the side facing the retaining grooves 724. It should be noted further that one or more of the retaining grooves 724 may contain drainage holes, such as the opening 774. It is preferable that the second exterior plate 784 contains openings corresponding to said drainage holes. The first and second exterior plates 782 and 784 are similarly provided and mounted onto the head element 802 and side elements 902a and 902b.

Also shown in FIGS. 49 and 50 is the fourth wall 764 having an upper surface 743. Water circulation 783 occurs when water enters the inner cavity 733 through openings 774 or 724g, or openings within retaining grooves 724. The water is then channeled forward into the front portion 712 through a slight forward pitch of the upper surface 743 of the bottom wall 706 and the fourth wall 764. The water then collects in the dip 712a, which is the lowest point of the inner cavity 733, and is drained out through the drainage opening 740.

The bottom surface 743c contains at least one retaining groove 742. It is preferred that one retaining groove 742 is used for the flexible gasket 780, which blocks water from entering a gap 213d that may exist between the wall cladding layer 213b, and the insulation layer 213c. An insulating shroud 960 is fitted within one of the retaining grooves 742 is configured to block moisture penetration between the bottom wall 704 and the existing wall 210.

FIGS. 49 and 50 further demonstrate the structural girt 1200, having a first wall 1202. Extending from the free end 1203 is the second wall 1204. Extending from the free end 1209 is the third wall 1206. The first wall 1202 and the third wall 1209 are in a parallel and set apart orientation with each other, separated by the second wall 1204. The first wall 1202 is fastened using a plurality of fasteners such the fastener 752 to an existing wall 210, through the insulating shroud 960. The second wall 1204 is then oriented in a parallel and adjacent orientation with the fourth wall 764 (bottom wall 706). The third wall 1206 is configured to hold a wall cladding level 213b. A plurality of slots 1208 promote water and moisture circulation. It should be noted that the structural girt 1202 is preferably installed adjacently to bottom wall 806 of the head element and bottom walls 906 of the side elements 902a and 902b.

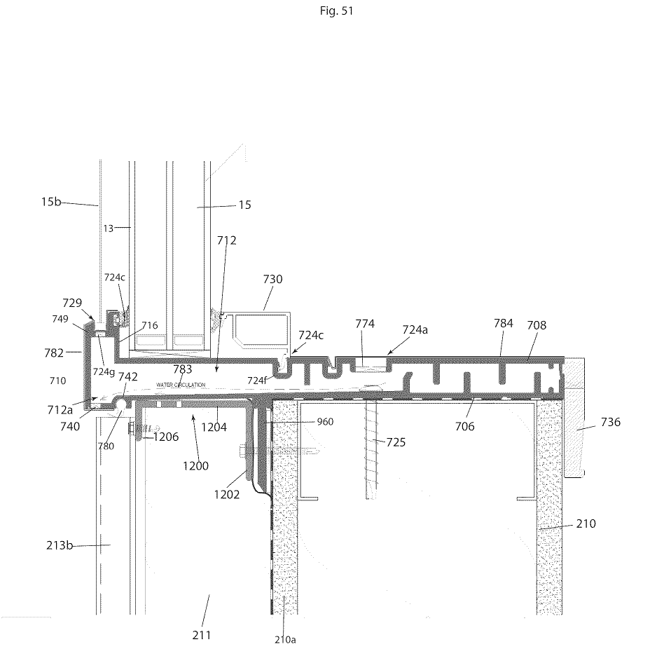

FIG. 51 demonstrates another embodiment of the securement system showing the sill element 702 Also shown is the back wall 708, the second exterior plate 784, the retaining groove 724, the fastener opening 774, the holding element 730 holding the structural element 15 securely between it and the retaining wall 716. The connecting wall 749 also doubles as the auxiliary groove 729 holding the auxiliary structural element 15 b. and preferably contains a drainage hole 724g. Additional drainage openings 724 may be present in the retaining grooves 724 of the top wall 704.

Shown in FIG. 51 is the first exterior plate 782 conforming to the outside relief formed by the top of the retaining wall 716, the connecting wall 749, the front wall 710 and the bottom wall 706, and predominantly the dip 712a, forming the frontmost section of the bottom wall 706 and having an opening 740. The top surface 743c of the bottom wall 706 is slightly pitched towards the front wall 710. The bottom wall 706 is shown to be in an adjacent and parallel orientation with the second wall 1204 of the structural girt 1202.

FIG. 51 demonstrates the cantilever feature supported by this embodiment of the securement system, since the front portion 712, which represents the area forward of the retaining groove 724f and the insulating shroud 960, and extends substantially beyond the width of the wall 210, or stated in another manner, extending beyond the exterior side 210a of the existing wall 210. The cantilever allows the front portion 712 to overhang the insulation part 211 and the exterior wall cladding 213b. The cantilever allows the structural component 15 to be installed outside of the outer edge 210a of the existing wall 210, which causes the leading edge 13 and the auxiliary structural component 15a to be substantially flush with the front wall 710. Therefore, the cantilever enabled embodiment of the securement system allows the securement system to support a uniform exterior finish of a façade without sacrificing the water drainage and noise and air circulation of the disclosed securement components.

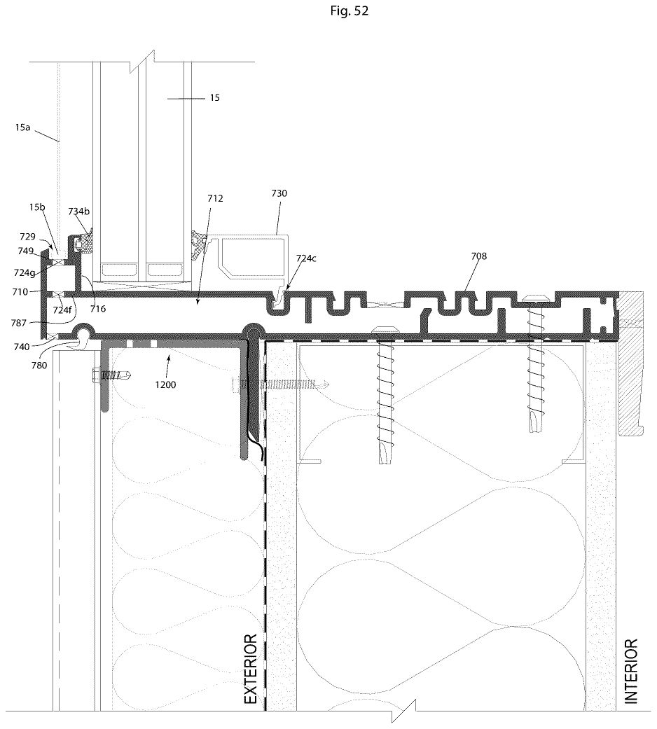

FIG. 52 is another embodiment the sill component 702 shown in FIG. 51 demonstrates an additional wall 787, which may be introduced to provide an additional rigidity for the front section 712. The additional wall 787 extends from the base of the retaining wall 716 towards the front wall 710 and in a parallel and set apart orientation with the connecting wall 749.

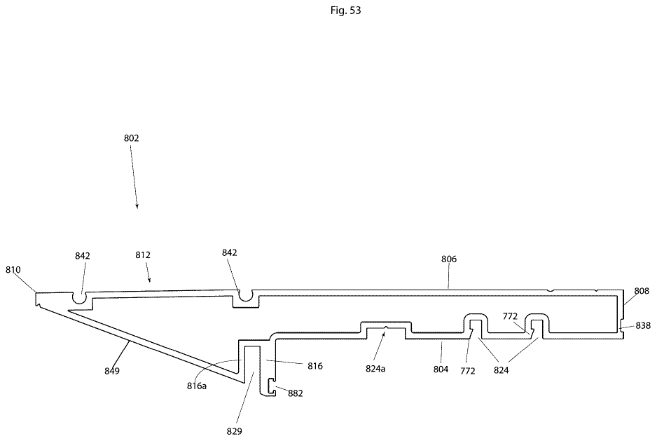

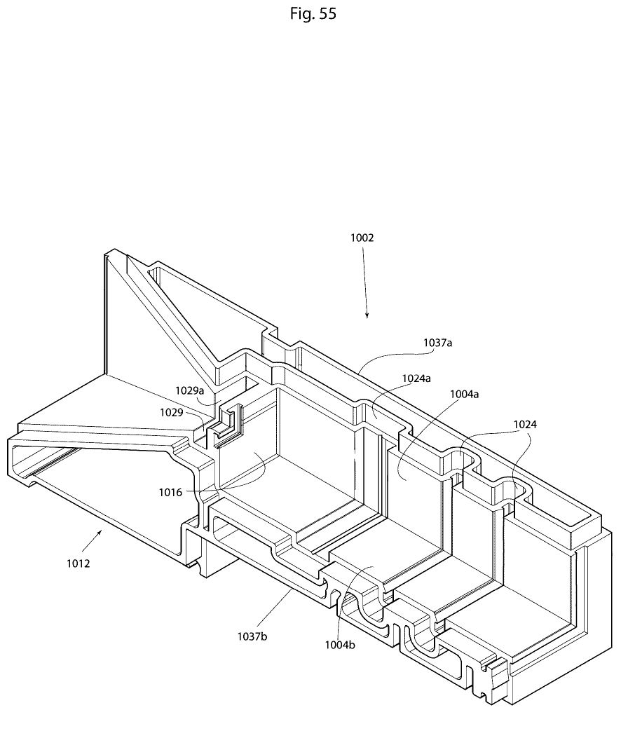

The head element in FIG. 53 demonstrates the bottom wall 806, having the retaining grooves 842, the back wall 808, which may have a vend opening 838, the top wall 804, having the retaining groves 824 and 824a, the retaining wall 816 having a socket 882 for mounting a gasket that secures a leading edge (13) of the structural element (15). The auxiliary groove 829 is preferably deeper than a coaxial auxiliary groove 729 of the sill element 702 which would have been parallelly installed to the head element 802 shown. The purpose for a deeper auxiliary groove 829 is to permit the secondary auxiliary element 15a to be easily installed and removed by sliding the secondary auxiliary element 15a upwards until the bottom edge of the secondary auxiliary element 15a clears the auxiliary groove 729 and the auxiliary groove corners 1029 (FIG. 55) and can then be installed or removed from within the aperture (18). Also shown is the connecting wall 849 (otherwise referred to elsewhere as the sloped wall 814), connecting the retaining wall 816 to the front wall 810.

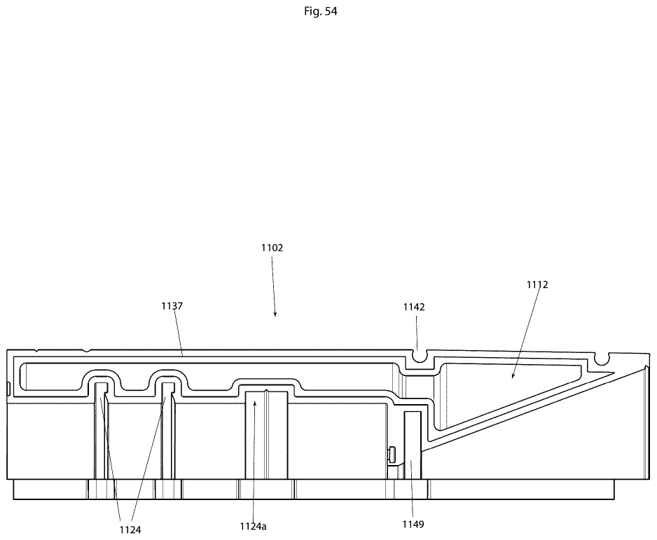

FIG. 54 demonstrates the second side element 1102. Shown is the retaining grooves 1142, 1124 and 1124a which are coaxial with side elements 902, the head element 802 and sill elements 702. The auxiliary corner groove 1149 is deeper then the auxiliary groove of the sill element 702 and the auxiliary corner groove 1049 of the first side element, to permit removal and reinstallation of the secondary auxiliary component 15a.

An alternative embodiment of the first side element 1002 is shown in FIG. 55. Shown is the rim 1037a which is inserted into the inner cavity 933 of a side element 902, and the rim 1037b which is inserted into the inner cavity 733 of the sill element 702. The face 1004b is flush with the surface of the top wall 704 and the face 1004a is flush with the with the surface of the top wall 904 of the side element 902. A corner or edge of the structural element would be retained against the retaining corner wall 1016 and locked in from behind with a holding element within one of the retaining grooves 1024a or 1024, with such holding element being the distal ends of the holding element 730 stretching across to the top wall 704. The auxiliary corner groove 1029 contains a deeper side portion 1029a such that the auxiliary structural element 15a may be moved sideways deeper into the auxiliary side portion 1029a and the corresponding auxiliary groove of the side element 902 and a coaxial auxiliary corner groove 1129 of the second side element, thus permitting the auxiliary structural element 15a to be shifted sideways until the opposite side of the auxiliary structural element 15a clears the auxiliary groove of the opposite side element 902.

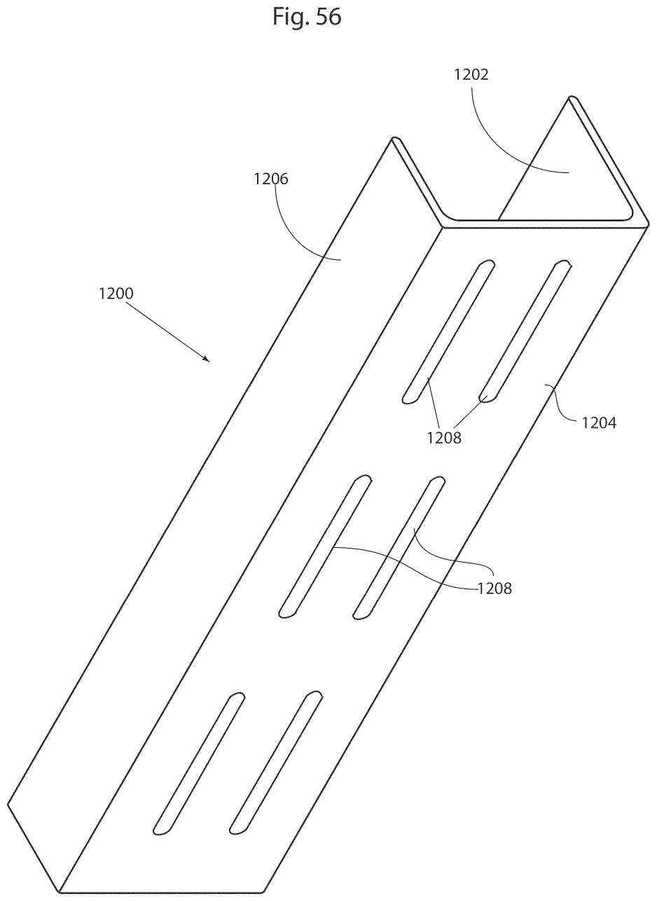

FIG. 56 demonstrates the structural girt 1200, having the first wall 1202, the second wall 1204 and the third wall 1206. The second wall 1204 preferably containing a plurality of slots 1208 that perforate the second wall 1204 and engage the free flow of air and water.

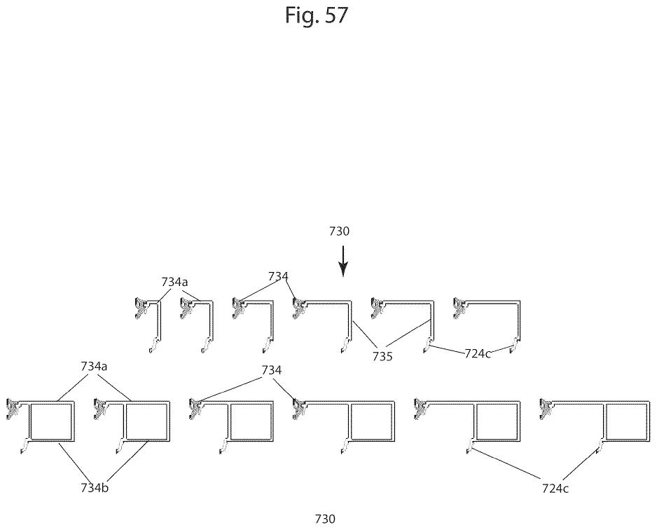

FIG. 57 demonstrates the various embodiments of the holding elements 730, which may contain the horizontal support arm 734a of various lengths, depending on the thickness of the structural element 15. A holding element 730 may contain a horizontal support arm 734a and a bracing horizontal support arm 734b for additional strength and rigidity that may be required to hold heaving structural elements 15 or be able to withstand higher windspeeds which would exert inward pressure onto the structural element 15.

The disclosed securement system provides interlocking components of sill element 702, head element 802, and side elements 902a and 902b. In some embodiments, the side elements 902a and 902b connect to the sill element 702 through the first side element 1002a and 1002b, or to the head element 802 through the second side element 1102a and 1102b, in some embodiments both the first and second side elements 1002 and 1102 are present.

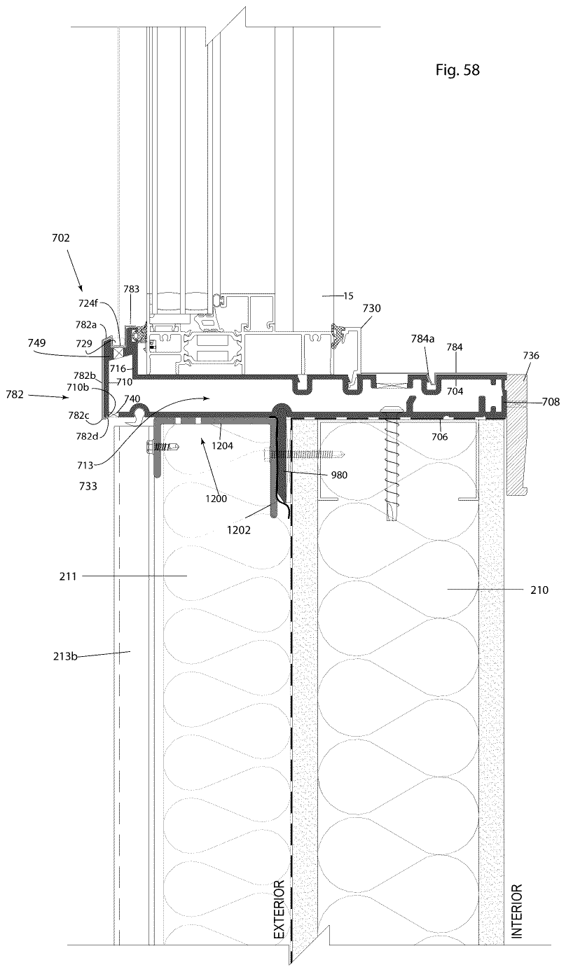

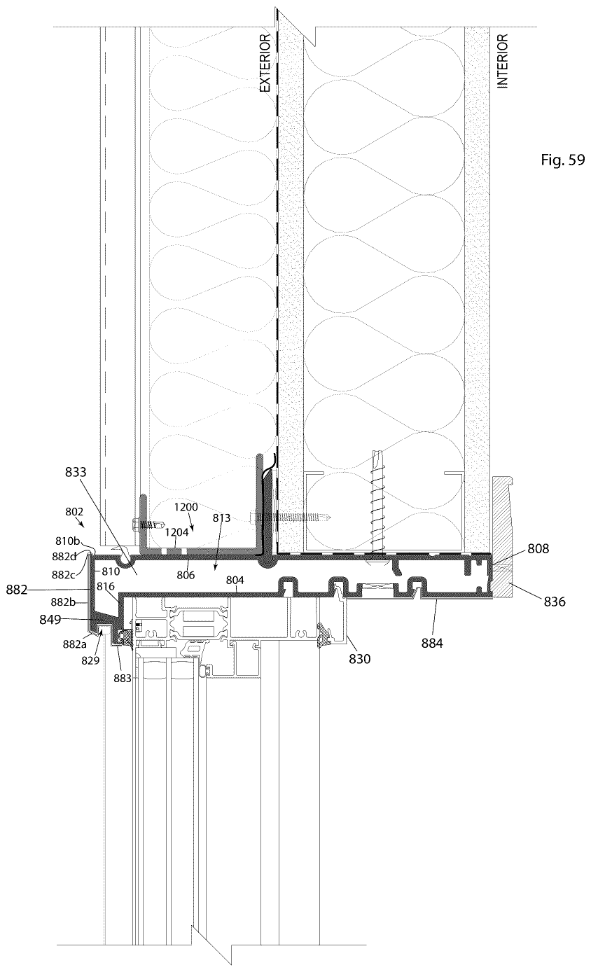

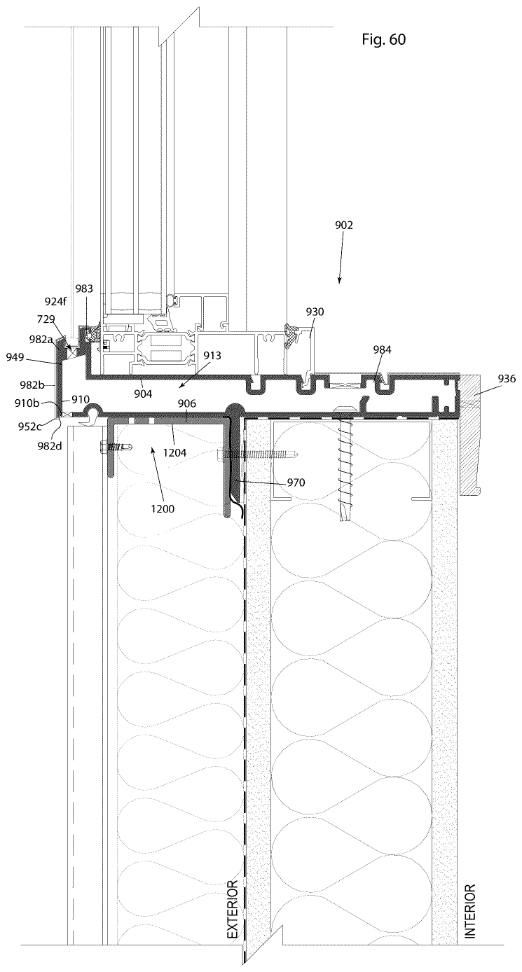

FIG. 58 demonstrates one embodiment in of the sill element 702. FIG. 59 demonstrates one embodiment of the head element 802, and FIG. 60 demonstrates one embodiment of the side element 902. While one side element 902 is shown, the second side element being parallel and directly opposite to the side element 902 that is shown would be an identical mirror image of it.

Shown in FIG. 58 is an embodiment of the sill element 702. The structural element 15, such as a window or door, is shown installed outside the width of the existing wall 210, on a vertical axis 211a that corresponds with the insulation layer 211 and exterior cladding layer 213b. The support for this forward deployment of the structural element 15 is enabled by the cantilever feature of the sill element 702. The forward section 713 cantilevers beyond the existing wall 210, or stated in another manner, the forward section 713 extends horizontally beyond the existing wall 210, in this case on what would be the exterior side of the façade of a building or a forward deployment of structural elements 15. Alternatively, the sill element 702 may cantilever beyond the existing wall 210 on the interior side of the existing wall 210, for example, to provide support for recessed installations of the structural element 15. The first wall 1202 and the second wall 1204 of the girt element 1200, provide the additional structural bracing for the cantilever front section 713 by supporting the bottom wall 706.

Shown additionally in FIG. 58 is the first exterior plate 782 and a second exterior plate 784. The first exterior plate 782 comprises the end section 785 covering the top most point of the retaining wall 716, the first section 782a covering the connecting wall 749, including the auxiliary groove 729, the retaining groove or protruding section 724f, the second section 782b, covering the front wall 710 and the third section 782c, covering the bottom wall 806.

In the embodiment shown in FIG. 58 the first exterior plate 782 is held in place by at least two points of coupling, namely, the protruding section 724f being snugly held within the auxiliary groove 729, and the lip 782d, which snaps into a catch groove 710b of the bottom wall 706. The catch groove 710b may be forward or past the drainage opening 740. The second exterior panel 784 is deployed along the top of the top wall 704 between the holding element 730 and the interior molding 736 that is attached to the back wall 708. FIG. 59 demonstrates the embodiment of the head element 802. Shown is the top wall 804, bottom wall 806, back wall 808 and front wall 810, defining a cavity 833. The cantilever front section 813 is parallel to the cantilever section 713 of the sill element 702 shown in FIG. 58. The first exterior plate 882 contains the end section 883, the first section 882a corresponding to the connecting wall 849, including the auxiliary groove 829, the second section 882b covering the front wall 810, and the third section 882c covering the bottom wall 806. The first exterior plate is held in place by the protruding groove 824f snugly held within the auxiliary groove 829 and with the lip 882d held by the catch groove 810b. The second exterior panel 884 covers the top wall 804 between the holding element 830 and the interior molding 836 and held in place by the protruding groove 884a.

FIG. 60 demonstrates one of the side elements 902, having the bottom wall 906, top wall 904, front wall 910 and back wall 908 defining an inner cavity 933. The cantilever front section 913 being coaxial with the cantilever front sections 713 and 813 of the sill element 702 and head element 802. The first exterior plate 982 has the end section 983 covering the top of the retaining wall 916, the first section 982a covers the connecting wall 949 and is held in place by the protruding section 924f. The second section 982b covers the front wall 910 and the bottom wall is covered by the third section 982c, which is held in place with a lip 982d that is held in pace behind the catch lip 910b. The second exterior panel 984 covers the top wall 984 between the holding element 930 and the interior molding 930. It should be noted that the first exterior panels 782 of the sill element, the first exterior panel 882 of the head element 803 and the first exterior panel 982 of the side elements 902 are coaxial and together present to an onlooker one continuous panel around the entire securement system. Similarly, the second exterior panel 784 of the sill element 702, the second exterior panel 884 of the head element 802 and the second exterior panel 984 of the side elements 902 are coaxial and together present to an onlooker one continuous panel around the entire securement system.

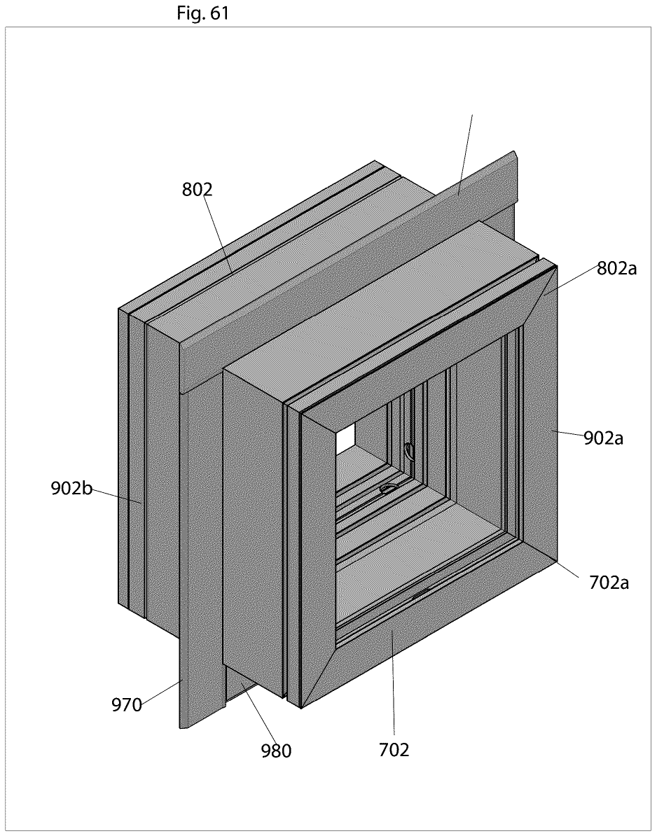

The fully assembled embodiment of the securement system is shown in FIG. 61, Showing the head element 802, side elements 902a and 902b and sill element 702. The components are connected to each other via a 45° angle cuts 702 a and 802 a. Both the side elements 902a and 902b have fastener and drainage openings 927. Additionally, since all interior cavities, 733, 833, and 933 are in connected, water collecting within the interior cavities of head element 802 or side elements 902a or 902b is drained out of the securement system through the sill element 702.

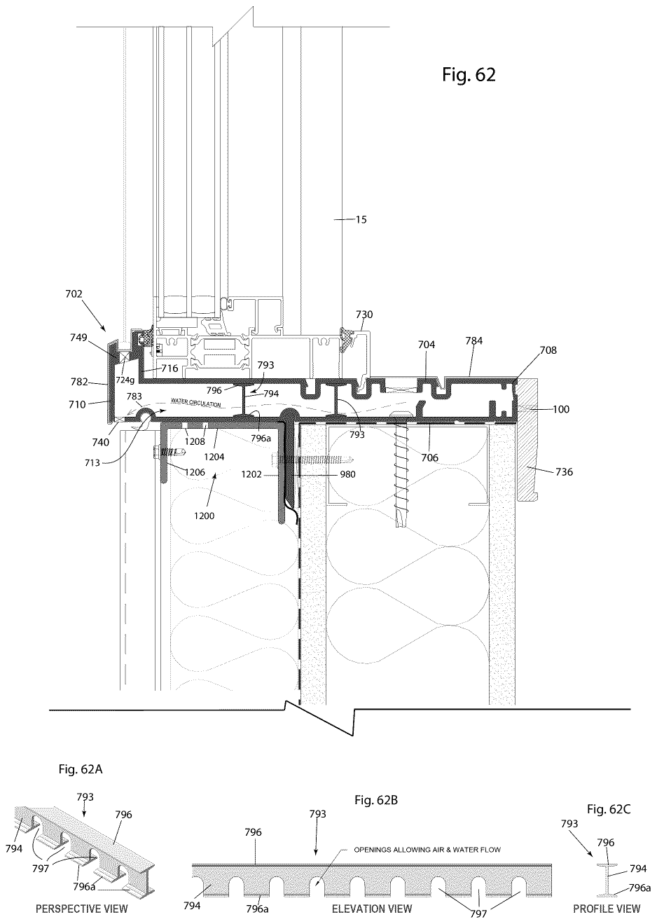

An embodiment of the sill element 702 may contain internal bracing within the inner cavity 733 as shown in FIG. 62. Shown are slotted H components 793 having a first horizontal wall 796a. Extending at an angle, preferably a right angle, from the first horizontal wall 796a is the vertical wall 794. Terminating the vertical wall 794 is the second horizontal wall 796. There may be one or a plurality of the slotted H components 793.

Shown in FIG. 62 is a front wall 782, connecting wall 749, retaining wall 716, the top wall 704, the back wall, 792, the bottom wall 706 and the front wall 710. The front wall 710, the connecting wall 749 and the retaining wall 716 are covered by the first external panel 782. The second external panel 784 covers the top wall 704 between the holding element 739 and the interior molding 736. The first external panel 782 and the second external panel 784 may be made of aluminum, or a thermally isolating material. The slotted H components 793 provides support for the top wall 704, which supports structural component 15. The slotted H component 793 supports the gap between the top wall 704 and the bottom wall 706 of the cantilever front section 713. The second wall 1204 of the structural girt component 1200 provides bracing for the bottom wall 706 of the cantilever front section 713. The first wall 1202 of the structural girt component 1200 is mounted on a wall 210 through the thermal shroud element 980. The second wall 1204 preferably contains slots 1208 to channel any moisture penetrating between the bottom wall 706 and the second wall 1204 away from the wall 210. The structural girt component 1200 forms the disclosed slotted U component.

Water may penetrate the inner cavity 733 through the retaining grooves 724, and the drainage hold 724g. The water flow 783 is shown originating beneath a retaining groove 724, flowing through gaps in the vertical wall 794 of the slotted H component 793 and flows out of the drainage opening 740. The interior component shows an opening 100 which is in an air communication with the internal cavity 733 through the back wall 708.

FIGS. 62A, 62B and 62C demonstrates the various views of the embodiment of the slotted H component 793. The first horizontal wall 796a is interrupted at intervals by plurality of slots 797 through the vertical wall 794. The vertical wall 794 is interrupted by the second horizontal wall 796.

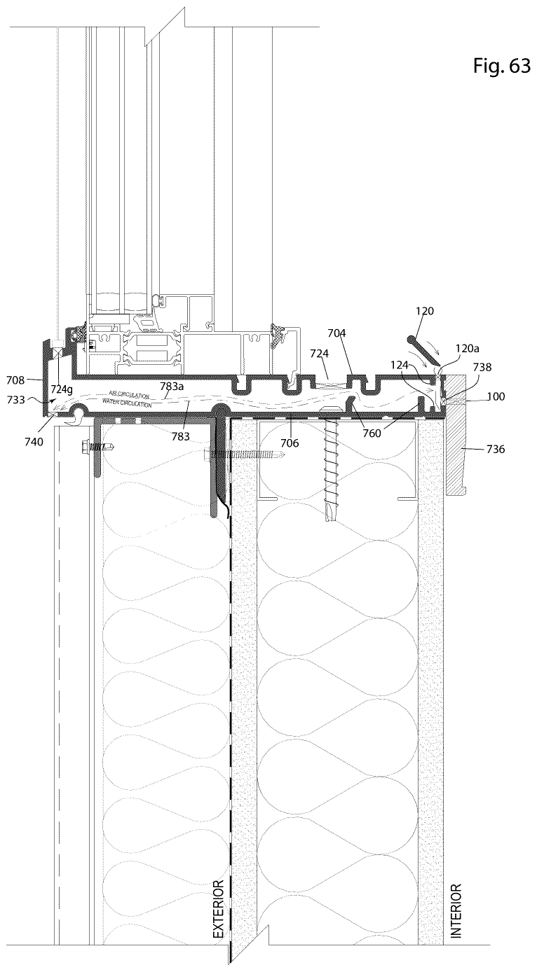

FIG. 63 demonstrates the flow of air 783a and water 783. The internal cavity 733 is in air communication with the exterior of a wall and is able to ventilate the inner spaces of a building through the inner openings 738 of the back wall 708, which open into the interior space through the openings 100 of the interior molding 736. The openings 100 and the inner openings 738 are in an air communication with each other.

The flow of air 783a between the drainage holds 740 and inner openings 738 may be interrupted by the lever 120 which may be inserted through the opening 120a in the top wall 704. The lever 120 may slide within a track created by the back wall 708 and the protruding inner walls 124. The protruding elements 760 are intended to block sound and slow the flow of air within the inner cavity 733, so that the air flowing in through the drainage openings 740 can intermix with the air flowing out of drainage openings 738 and thereby come closer to the temperature of air inside the structure.

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

1. A securement system for securing structural elements within an opening of an existing wall, comprising: a sill element, said sill element comprising a top wall, a bottom wall, a back wall, and a front wall; wherein said top, bottom, back and front walls defining an inner cavity; wherein said sill element having two sides that are parallel to each other; wherein each of said two sides defined by a rim; wherein said top wall configured to support a structural element; wherein said top wall having at least one retaining part configured to secure said structural element; said top wall further comprising a front section; said front section comprising a retaining wall extending from a free end of said top wall; a connecting wall, said connecting wall extending from a free end of said retaining wall, said connecting wall connecting with said front wall; wherein said retaining wall forming one of said at least one retaining parts, and wherein another of said at least one retaining parts is at least one groove, wherein said at least one groove configured to couple with a holding element.

2. The securement system of claim 1, wherein said top wall comprising at least one drainage hole, said drainage hole opening into said inner cavity; and wherein said inner cavity configured to channel liquid toward at least one drainage opening in said bottom wall.

3. The securement system of claim 2, wherein said connecting wall further comprising an auxiliary groove between said retaining wall and said front wall.

4. The securement system of claim 3 wherein said auxiliary groove configured to house a frame element of an auxiliary component of said structural element.

5. The securement system of claim 3, further comprising a first exterior plate, said first exterior plate conforming to relief of said front portion.

6. The securement system of claim 5, wherein said first exterior plate configured to be secured within said auxiliary groove.

7. The securement system of claim 3. further comprising a second exterior plate, said second exterior plate conforming to exterior relief of said top wall.

8. The securement system of claim 7, wherein said second exterior plate configured to be secured within said at least one groove.

9. The securement system of claim 3, wherein said bottom wall further comprises at least one retaining groove for an insulating shroud or an insulating gasket.

10. The securement system of claim 7, wherein said bottom wall further comprises at least one retaining groove for an insulating shroud or an insulating gasket.

11. The securement system of claim 10, further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall.

12. The securement system of claim 11, wherein said second wall of said structural girt further comprising a plurality of slots, said plurality of slots configured to permit passage of air or water.

13. The securement system of claim 11, wherein said front portion extends horizontally beyond a width of said existing wall creating a cantilever section; wherein said cantilever section is configured to support a structural element.

14. The securement system of claim 2, further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall.

15. The securement system of claims 14, wherein said front portion extends horizontally beyond a width of said existing wall creating a cantilever section; wherein said cantilever section is configured to support a structural element.

16. The securement system of claim 2, wherein said inner cavity further comprises a slotted H component, said slotted H component having a first horizontal wall, extending at an angle from said first horizontal wall is a vertical wall, capping said vertical wall is a second horizontal wall; wherein said slotted H component configured to brace said top wall against said bottom wall; and wherein said vertical wall configured to let air or water to flow therethrough.

17. The securement system of claim 15, wherein said inner cavity further comprises a slotted H component, said slotted H component having a first horizontal wall, extending at an angle from said first horizontal wall is a vertical wall, capping said vertical wall is a second horizontal wall; wherein said slotted H component configured to brace said top wall against said bottom wall; and wherein said vertical wall configured to let air or water to flow therethrough.

18. The securement system of claim 16, further comprising a lever; wherein said lever operates to open or close exchange of air between said drainage opening and interior opening in said back wall.

19. A securement system for securing structural elements within an opening of an existing wall, comprising: a head element, said head element comprising a top wall, a bottom wall, a back wall, and a front wall; wherein said head element having two sides that are parallel to each other; wherein said top wall having at least one retaining part configured to secure said structural element; said top wall further comprising a front section; said front section comprising a retaining wall extending from a free end of said top wall; a connecting wall, said connecting wall extending from a free end of said retaining wall, said connecting wall connecting with said front wall; wherein said retaining wall forming one of said at least one retaining parts, and wherein another of said at least one retaining parts is at least one groove, wherein said at least one groove configured to couple with a holding element.

20. The securement system of claim 19, wherein said top, bottom, back and front walls defining an inner cavity.

21. The securement system of claim 19, wherein said connecting wall further comprising an auxiliary groove between said retaining wall and said front wall; wherein said auxiliary groove configured to house a frame element of an auxiliary component of said structural element.

22. The securement system of claim 20, further comprising a first exterior plate, said first exterior plate conforming to relief of said front portion.

23. The securement system of claim 22, wherein said first exterior plate configured to be secured within said auxiliary groove.

24. The securement system of claim 20. further comprising a second exterior plate, said second exterior plate conforming to exterior relief of said top wall.

25. The securement system of claim 24, wherein said second exterior plate configured to be secured within said at least one groove.

26. The securement system of claim 20, wherein said bottom wall further comprises at least one retaining groove for an insulating shroud or an insulating gasket.

27. The securement system of claim 19, further comprising a first exterior plate and a second exterior plate, said first exterior plate conforming to relief of said front portion; and
wherein said second exterior plate conforming to exterior relief of said top wall.

28. The securement system of claim 19, further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall of said head element.

29. The securement system of claims 28, wherein said front portion extends horizontally beyond a width of said existing wall creating a cantilever section; wherein said cantilever section is configured to support a structural element.

30. A securement system for securing structural elements within an opening of an existing wall, comprising: a sill element and a head element, said sill and head elements comprising a top wall, a bottom wall, a back wall, and a front wall; wherein said top, bottom, back and front walls of said sill element defining an inner cavity; wherein said sill and said head elements having two sides that are parallel to each other; wherein each of said two sides defined by a rim; wherein said top wall of said sill and said head element configured to support a structural element; wherein said top wall of said sill and said head element having at least one retaining part configured to secure said structural element; said top wall of said head and said sill elements further comprising a front section; said front section comprising a retaining wall extending from a free end of said top wall; a connecting wall, said connecting wall extending from a free end of said retaining wall, said connecting wall connecting with said front wall; wherein said retaining wall of said sill and said head elements forming one of said at least one retaining parts, and wherein another of said at least one retaining parts is at least one groove, wherein said at least one groove configured to couple with a holding element; and wherein said head and said sill elements are in a parallel and set apart configuration with each other separated by an aperture configured to receive said structural element.

31. The securement system of claim 30, wherein said top wall of said sill element comprising at least one drainage hole, said at least one drainage hole opening into said inner cavity; and wherein said inner cavity configured to channel liquid toward at least one drainage opening in said bottom wall of said sill element.

32. The securement system of claims 31, wherein said connecting wall of said sill and said head elements further comprising an auxiliary groove between said retaining wall and said front wall; wherein said auxiliary groove of said sill element being coaxial with said head element; and wherein said retaining wall and said at least one groove of said sill element being coaxial to said retaining wall and said at least one groove of said head element.

33. The securement system of claim 32, wherein said at least one drainage hole may be in said connecting wall, said auxiliary groove, on or adjacent to said retaining wall, or said at least one groove of said top wall of said sill element.

34. The securement system of claim 32, wherein said auxiliary groove of said head element and said sill element configured to retain a frame element of an auxiliary component of said structural element; and wherein said auxiliary groove of said head and said sill element configured to secure a first exterior plate.

35. The securement system of claim 32, wherein said head element or said sill element further comprises an exterior panel said exterior panel forming a first exterior panel configured to cover said front portion of said head element or said sill element, or a second exterior panel configured to cover a top wall of said head element or said sill element.

36. The securement system of claim 30, further comprising at least one side element; wherein each of said at least one side elements mounting on each side of said head element and said sill element and extending from said sill element to said head element.

37. The securement system of claim 36; wherein each of said side element having a bottom wall a top wall, a front wall and a back wall; said top wall of said side elements having at least one retaining part; and wherein said at least one retaining part of said side elements axially corresponding to said at least one retaining part of said sill element and said head element; said top wall of said side elements further comprising a front section; said front section of said side elements comprising a retaining wall extending from a free end of said top wall of said side elements; a connecting wall extending from a free end of said retaining wall of said side elements, said connecting wall of said side elements connecting with said front wall of said side elements; wherein in each of said side elements said retaining wall forming one of said at least one retaining parts, and wherein another of said at least one retaining parts in each of said side elements is formed by at least one groove, wherein said at least one groove of each of said side elements configured to couple with a holding element; and wherein said each of said least one retaining parts of each of said side elements corresponds axially to said one of said at least one retaining parts of said head elements and said sill element.

38. The securement system of claim 37, wherein the connecting wall of each of said side elements contains an auxiliary groove; wherein said auxiliary groove is co-axial to the auxiliary groove of said head element and said sill element; wherein said auxiliary groove is configured to retain a frame element of an auxiliary member of said structural member; and wherein said auxiliary groove of said side elements configured to retain a first exterior plate; wherein said first exterior plate of each of said side elements configured to cover an outside surface of said connecting wall, said front wall and said bottom wall; and wherein any of said at least one groove of each of said side elements is configured to retain a second exterior plate covering a top surface of each of said side elements.

39. The securement system of claim 38, further comprising a first side element for each side of said sill element; said first side element having a sidewall, a front wall and a back wall; wherein said sidewall having at least two faces; each of said at least two faces having a protruding surface; wherein said protruding surface of one of said at least two faces of any of said first side elements configured to be inserted into one of said two sides of said sill element; and wherein said protruding surface of the other one of said at least two faces configured to be inserted into one of said two sides of one of said side elements.

40. The securement system of claim 39, further comprising a second side element; each said second side element having a sidewall, a front wall and a back wall; wherein said sidewall of each of said second side element having at least two faces; each of said at least two faces of each said second side element having a protruding surface; wherein said protruding surface of one of said at least two faces of each said second side element configured to be inserted into any one of said two sides of said head element; wherein said sidewall of any of said second side element sealing said one of said two sides of said head element along a rim of said one of said two sides of said head element; and wherein said protruding surface of the other one of said at least two faces of any of said second side element configured to be inserted into said one of said two sides of any of one of said side element not occupied by any of said first side elements.

41. The securement system of claim 40, wherein said first side elements and said second side elements having a corner auxiliary groove, said corner auxiliary groove linking said auxiliary grove of said head or said sill element coupled with said side element.

42. The securement system of claim 43, wherein said sidewall of each of said first side element and second side elements and said bottom wall of said sill, said head, and said side elements having a co-axial retaining groove configured to retain a shroud or gasket insulating member.

43. The securement system of claim 30, further comprising a further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall of said sill, head or side element.

44. The securement system of claim 36, further comprising a further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall of said sill, head or side element.

45. The securement system of claim 38, further comprising a further comprising a structural girt, said structural girt having a first wall; a second wall extending from an upper surface of said first wall; and a third wall extending from a free end of said second wall; wherein said first wall and said third wall are in a parallel and set apart orientation; wherein said first wall is configured to be attached to an existing wall or said insulating shroud and wherein said second wall is configured to be in a parallel and set apart orientation to said bottom wall of said sill, head or side element.

46. The securement system of claims 45, wherein said front portion of said extends horizontally beyond a width of said existing wall creating a cantilever section; wherein said cantilever section is configured to support a structural element.

47. The securement system of claim 46, wherein said inner cavity of said sill element further comprises a slotted H component, said slotted H component having a first horizontal wall, extending at an angle from said first horizontal wall is a vertical wall, capping said vertical wall is a second horizontal wall; wherein said slotted H component configured to brace said top wall of said sill element against said bottom wall of said sill element; and wherein said vertical wall configured to let air or water to flow therethrough.

48. The securement system of claim 47, further comprising a lever; wherein said lever operates to open or close exchange of air between said drainage opening of said sill element and interior opening in said back wall of said sill element.
